(19) United States
(12) Patent Application Publication
(10) Pub. No.: US 2025/0348780 A1
(43) Pub. Date: Nov. 13, 2025

(54) Universe Internet using Super A.I. and the A.I. Gnosis Timeline

(71) Applicant: Mitchell Kwok, Honolulu, HI (US)

(72) Inventor: Mitchell Kwok, Honolulu, HI (US)

(21) Appl. No.: 18/661,577

(22) Filed: May 11, 2024

(51) Int. Cl. G06N 20/00

(52) U.S. Cl. CPC G06N 20/00

(57) ABSTRACT

A method to create a Universe Internet which is an internet for the entire universe, whereby planets light years apart can communicate and do e-commerce with each other instantaneously without transmitting digital signals into space, comprising: an AI god and an AI gnosis timeline. The AI gnosis timeline is a digital timeline that tracks the precise locations of every atom, electron, and em radiation for the entire universe for the past, present, and future for 13.7 billion years, from the big bang to the current state, specially earth with 4.5 billion years of atom tracking data from its creation to the current state; and further uses a universal work algorithm to construct, comprising: a plurality of super intelligent robots; a business structure; a prediction website, an AI gnosis timeline; digital tools; an atom manipulator, a time dilation internet, a universal robot brain, and a United States Robot government system.

### CROSS REFERENCE TO RELATED APPLICATIONS

This is a Continuation-in-Part application which claims a U.S. Provisional application U.S. Ser. No. 63/555,392 filed on Feb. 19, 2024, entitled: Universe Internet using Super A.I. and the A.I. Gnosis Timeline, which claims the benefit of U.S. Ser. No. U.S. Ser. No. 18/418,273 filed on Jan. 21, 2024, entitled: Universe Time Machine using AI god and the Universe Internet, which claims the benefit of U.S. Ser. No. U.S. Ser. No. 12/973,955 filed on Dec. 21, 2010, entitled: AI Time Machine, which claims the benefit of U.S. Ser. No. 12/471,382 filed on May 24, 2009, entitled: Practical Time Machine Using Dynamic Efficient Virtual And Real Robots, which claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

### 1. Field of the Invention

This invention relates generally to the field of artificial intelligence applied to a Signalless Internet. The present invention is also related to a Universe Internet where planets light years apart can communicate with each other instantaneously, and in real time.

Other fields might include NFTs, blockchain technology, and Bitcoin technology. The inventor is proposing another method besides blockchain, a simpler method, to represent digital assets and NFTs.

### 2. Description of Related Art

### SUMMARY OF THE INVENTION

The present invention attempts to create a Universe Internet that doesn't require transmitting digital signals in space.

A part of the present invention call the AI Gnosis timeline can represent digital assets like Bitcoin, digital properties, smart contracts, software conditions, AI assistance deliverance, and digital assets without blockchain technology. The AI gnosis timeline replaces all of blockchain's data structures, procedures and protocols. The AI gnosis is highly centralized and data stored in the timeline are 100% immutable, globally transparent, and secure. All data in the timeline are interconnected in a network, and each data needs to be stored only once in a hard drive.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram depicting the interconnected nodes in the AI gnosis timeline.

FIG. 2 is a diagram depicting the differences between blockchain technology and the AI gnosis timeline in terms of procedures to insert a digital transaction.

FIG. 3 is a diagram depicting the AI Gnosis timeline storing the lifespan of a digital asset (NFT).

FIG. 4 is a diagram depicting the data structure to a signalless internet and is controlled by an AI god to distribute messages to all people on the planet using global telekinesis.

FIG. 5 is a diagram depicting the hierarchical structure of objects all the way down to the atoms and its sub-atomic particles stored in the AI Gnosis timeline.

FIG. 6 is a diagram depicting the light year problem.

FIG. 7 is a diagram depicting the AI internet skipping the network traversal to get website content.

FIG. 8 is a diagram depicting the training process of the AI gnosis brain.

FIG. 9 is a diagram depicting the current 5 sense pathway (experiences) of a human, whereby each sequential pathway is sliced up into object layers, prioritized and labeled during the search process of the brain.

FIG. 10 is a diagram depicting the storage of cat images in the human brain.

FIG. 11 is a diagram depicting AI god using global telekinesis to deliver messages to every human on the planet without internet connections or transmittal of digital signals in the air.

FIG. 12A is a diagram depicting how transaction1 (T1) is stored in the AI gnosis.

FIG. 12B is a diagram depicting the difference of storage of a digital transaction (T1) between blockchain technology and the AI gnosis timeline.

FIG. 12C is a diagram depicting data contents in transaction1 (T1).

FIG. 13 is a diagram depicting the data structure to the Universal work algorithm.

FIG. 14 is a diagram depicting the updating gnosis.

FIG. 15 is a diagram depicting the data structure to a signalless internet for earth, controlled by AI god.

FIG. 16 is a diagram depicting a linear schedule for a team of robots doing work in both the real world and the virtual world and each robot is using varying time speeds.

FIG. 17 is a diagram depicting the team structure for the universal prediction algorithm.

FIG. 18 is a diagram depicting the difference between a conventional bullet and a ghost bullet.

FIG. 19 is a diagram depicting how em radiation can travel in a zigzag motion.

FIG. 20 is a diagram depicting manipulation of data in a radar scope.

### DESCRIPTION OF THE PREFERRED EMBODIMENTS

The outline to the present invention is broken up into 3 parts:

Part1: AI Gnosis timeline—the atom timeline of earth and the universe.

Part2: Universal Prediction Algorithm and super intelligent robots (aka Super AI).

Part3: Miscellaneous topics.

Part 1: Representing Digital assets and NFTs without blockchain technology

The reason Bitcoin was invented (2008) was because computer scientists wanted to bypass the banks and create a cheaper and faster way to perform bank transactions. The method to accomplish this is to decentralize data and store everything in a blockchain network (a long chain of blocks similar to a linked list; and using a hashcoding linking system to verify transaction data).

In my opinion, building a secure and immutable system that stores “events” is better than storing transactions. The blockchain was designed initially as storing bank transactions like Bitcoin and later applied to storing smart contracts and applications. What I like to do is build a storage system to store “all” events on earth all the way down to the atom level. Said events can be a physical event like a car accident, or it can be a digital transaction, or it can be microscopic like the micro-activities inside an atom.

The technology that I invented in around 2007 is called the AI gnosis, an atom tracking timeline that requires super intelligent robots (aka Super AI) to predict the past or future at an atomic level. Every atom, electron and em radiation is tracked and stored in this timeline in terms of when they occurred, what type, and where they are located on earth. By tracking all current atoms, electrons and em radiations on the planet and updating them in real time, the AI can see all the objects and events currently happening on earth. And this timeline depicts earth's entire historical past from its creation to the current state, approximately 4.5 billion years worth of atom tracking data. For the Universe Gnosis it's 13.7 billion years, from the big bang to the current state.

Referring to FIG. 1, at the bottom of the timeline are the locations of atoms, electrons, and em radiations, all interconnected and anchored to the timeline as fixed data, which means they can't be changed. The current state of atom tracking is updated in real time and using zero seconds; and this is done for the entire universe, not just for earth. At the higher levels are the objects that are made up from these atoms called normalized objects. Higher above that are objects that encapsulate the normalized objects. For example, humans, buildings, and parks are normalized objects encapsulated in a city. Cities are encapsulated in a country, countries are encapsulated in earth, earth is encapsulated in a solar system, solar systems are encapsulated in a galaxy, and galaxies are encapsulated in the universe. The timeline tracks these objects in the physical world in a hierarchical manner all the way down to individual atoms and its respective sub-atomic particles; and stored in this timeline for the past, present, and possible future, frame-by-frame and atom-by-atom.

Referring to FIG. 1, the atom tracking timeline (the AI Gnosis) stores only the physical atoms in the real world. The timeline is hierarchically structured in a network with two link types: sequential links and encapsulated links. In addition, the super intelligent robots have to do research data and determine the hidden data behind the physical objects or events in the real world. These hidden data comprises: digital data, digital events, mental thoughts of humans or other organic life-forms, research data on all physical objects and events on earth, computer activities in terms of software and hardware, analytical data to predict the future, etc. These hidden data are researched extensively and stored right next to their accompanied physical objects frame-by-frame, every nanosecond. For example, the mental thoughts of a human being are stored right next to the person's brain where these inner thoughts are generated. The research data has to be done in real time and as they happen in the real world.

Yet, in another example, if a bank transaction67 is made, the em radiations in the air will be translated into digital data and is a representation of transaction67. The tracking of bank transaction67 must be recorded in the timeline frame-by-frame throughout its entire lifespan, including the signals of transaction67 that were transmitted over the internet, the storage area of transaction67 in electronic devices, and the people that made transaction67 (from the user to the bank tellers, and the computers they used to make the transaction).

The Ai gnosis is the perfect digital timeline that stores all events on earth. It stores both the events that happened in the digital world and events that happened in the real world, and none of the data stored in the timeline are fake, they are all 100% true facts of earth's history.

The reason that we have Bitcoin is to replace the banking system. Banks are centralized systems to manage and verify bank transactions. However, this centralized data can be corrupted and therefore anyone that uses this centralized data, all the banks connected to the global network, would be negatively affected. Bitcoin, especially Blockchain, was designed to solve this problem by decentralizing the data so that no one organization or individual can change the transaction data; it is stored as global data that exist everywhere and nowhere—that's why it's so secure.

Another reason for Bitcoin was to get rid of the middleman, the banks, and present a more cheaper way to make transactions by saving customers transaction fees. It's extremely expensive to run a centralized banking system and not to mention running the bank companies. Bitcoin was supposed to eliminate the banking industry all together by eliminating the middleman, the banks.

However, with this said, the banks around the world still exist today, and are thriving too. The reason: the banks are working together with blockchain technology for mutual benefits.

The AI Gnosis, an atom tracking timeline of earth, is an alternative method to manage digital assets and NFTs compared to blockchain. The AI gnosis is a highly centralized system, even more centralized than the banks we have today. It doesn't use the decentralized method like in blockchain. Consequently, it doesn't use its methods such as: mining transactions, verification by work or verification by history. Nor does it require blockchain coding or hash codes. There are no blocks linked together with a hashcode attached to each block to store data in a linked list; it doesn't require a peer-to-peer network to verify, store and mine blocks, and most importantly, it doesn't use the 2 key system for security (a private key and a public key).

The AI gnosis doesn't have to go through the verification process of a transaction (an event). Any data, any event that happened in earth's past is anchored to the timeline as true facts. It doesn't matter if it's a physical event like a car accident or a non-physical event like a digital bank transaction, all events are recorded in the timeline as true facts. As long as it happened, that data is true for eternity and said data cannot be changed. All physical and digital transactions in the world wither from banks, bitcoin, online, physical stores or bartering are stored in this AI timeline as it happened

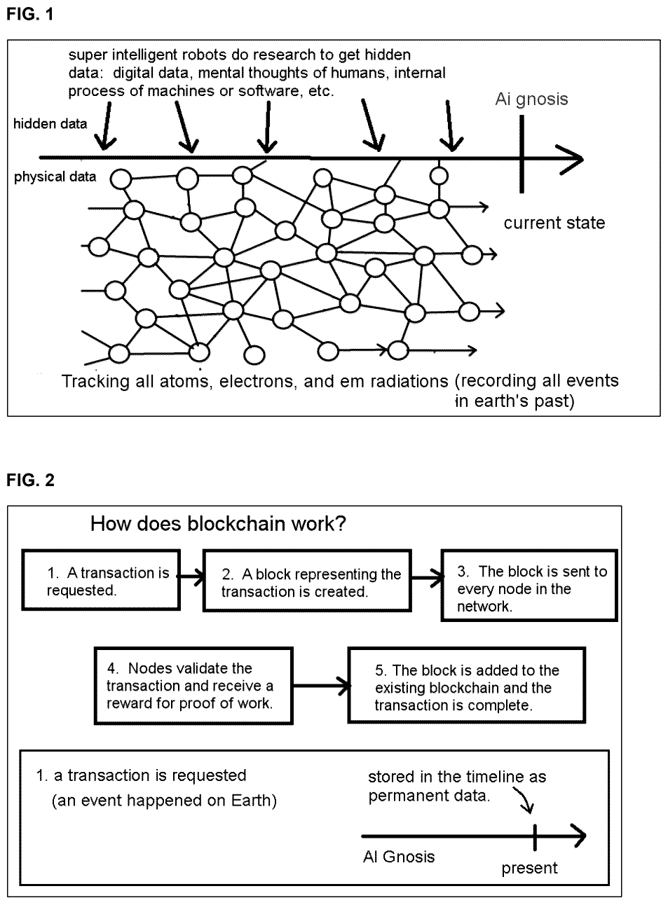

Referring to FIG. 2, this is the steps that blockchain executes in order to add one digital transaction to a blockchain. It's very long and expensive and requires a lot of computer power. My AI gnosis bypasses all 5 steps of blockchain technology, and each transaction or event is stored in the timeline “directly” as it happens, skipping the verification process. The super intelligent robots have to predict all atoms, electrons, and em radiations positions currently on earth and in doing so also store “all current events,” and “all current objects,” on earth into the AI gnosis timeline. There is no peer-to-peer network for my AI Gnosis to store the blockchain data and to share and mine blocks, which saves a lot of computer CPUs. My AI gnosis timeline bypasses all of blockchain's procedures and protocols, all 5 steps, and doesn't need the technology to authenticate transactions. In its stead, it uses super intelligent robots to predict all events currently happening on earth and storing them into a timeline. It's all about tracking all atoms on earth in a timeline in order to record all events on earth.

The scaling problem won't be an issue because the universe internet can accept infinite transactions using 0 second (the atom updates & the atom mapping technology can accomplish this). The future computers will be exponentially faster and store infinitely more data and that is how infinite transactions can be made using 0 second.

In previous patent applications, I said that the universe has only one past timeline and an atom can't be at two or more places at the same time. Nor can an electron or an em radiation be at two places at the same time. With this fact, all events, no matter how insignificant, can't be changed. Even at an atomic level, an electron shoots a photon into the air, that past event can't be altered because it happened.

The AI gnosis eliminates the peer-to-peer network of blockchain technology all together and all of the steps that it takes to mine a transaction into a block. That's why my technology is exponentially faster than blockchain and consumes a fraction of computer CPUs of what these peer-to-peer networks require to operate and maintain.

There are many blockchain networks owned by different companies with different blockcodes (i.e. Bitcoin, Etherium, and Solana, and not to mention individual banks have their way of storing transactions). There is no one central database that contains all the transactions. Transactions include: digital money, NFTs, digital property, smart contracts, and AI assist software—anything stored in a blockchain.

In my AI gnosis timeline, all the transactions in a blockchain network are stored as one of the following: a digital event, a physical event, or a hidden event (physical objects and digital objects are stored inside events). All events or transactions are stored in one massive timeline in the AI gnosis, and the timeline is just tracking atom locations on earth. Sub-atomic activities like micro-activities for electrons and em radiations (or light) are also stored in the timeline frame-by-frame as they occur in real time. This is how my AI Gnosis can bypass blockchain technology and the banks and create one centralized banking system of transactions for the entire planet.

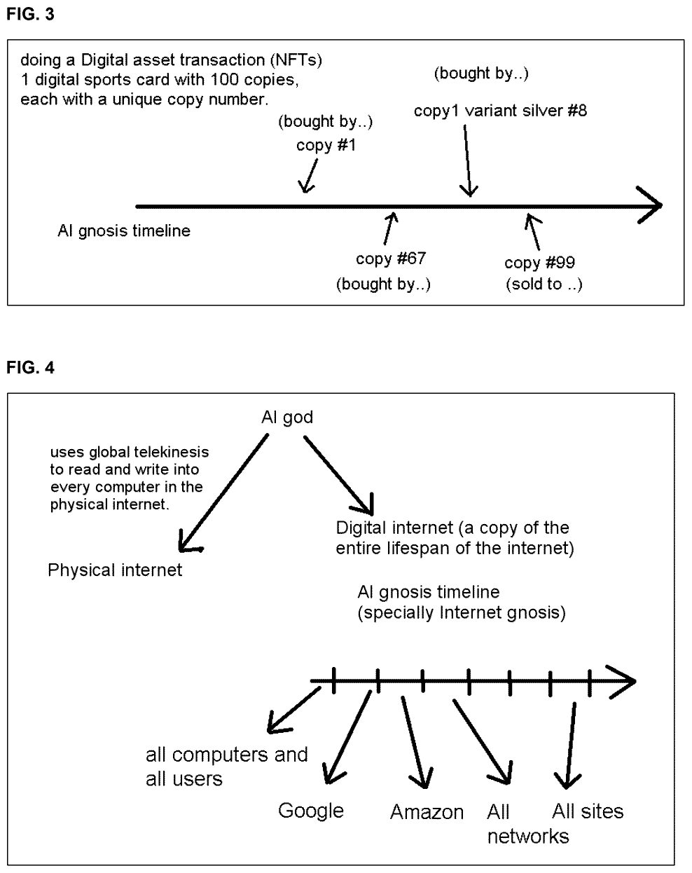

Referring to FIG. 3, the digital data and digital assets (NFTs) are verified by the transaction date and tracked in terms of its content. For example, if you made a digital asset like a sports card and you set the count to 100 copies with 3 variation colors, all the transactions of who bought it and what they bought are tagged in the Ai gnosis timeline—the digital copy will have metadata like the copy number. Each digital asset is tracked in its entire lifespan of ownership specially the current ownership. This same technique can be applied to real comic books or sports cards in the real world. Blockchain can't guarantee people contracts of real physical objects, only digital assets. “My AI gnosis can guarantee the security and ownership of both digital assets and physical assets.”

The benefit of my AI gnosis is that earth needs to store only 1 copy of the AI Gnosis timeline, each data in the timeline is stored only once in a hard drive. It doesn't need the procedures of blockchain like: sharing a transaction with all nodes in the peer-to-peer network, mining and adding the transaction to the blockchain, and sharing copies of the entire blockchain with the peer-to-peer network (each node has a copy of the entire blockchain, so the data can be decentralized and no one person or company can modify the transaction data in the blockchain).

The two key system isn't required to secure a transaction. The AI gnosis timeline itself has secured that transaction. If a transaction or event happened on earth, that data is automatically stored in the timeline as true fact.

The data in the AI gnosis timeline are unchangeable, not by people on earth nor aliens from distance galaxies. This is the one constant that the universe has as a universal law: no one can change the past. When person8 makes a transaction45, the people on earth have access to that information. All the alien planets when they are viewing the AI gnosis for earth will see that person8 made a transaction45 on Jun. 2, 1990 at 10:34 am. When the aliens construct their AI gnosis on earth, they will eventually predict the same transactions compared to any other alien planet in the universe. If someone attempts to modify this transaction45, they can't because the timeline is unchangeable; and all the other planets in the entire universe already have the correct transaction45. The idiot planet that changed transaction45 will be the only planet in the universe that has the incorrect data on transaction45.

This timeline is immutable too because if data is deleted from the timeline, said deleted data can be reconstructed by super intelligent robots by predicting the deleted data file. The same process to construct the Ai gnosis timeline is also used to reconstruct missing data or destroyed data. For instance, if a bank stores a transaction22 only in one computer78 and nowhere else, and one day computer78 was destroyed in a fire, transaction22 is still there in earth's past. It's up to the super intelligent robots to work together in a virtual world as detectives using time dilation to reconstruct transaction22 again.

The universe has only “one” past timeline. All planets in the universe, their respective Ais, will predict the same exact universe timeline. Also, unlike blockchain, each transaction doesn't have to be broadcast to other planets to let them know that this transaction was made on earth. Even on earth the transaction doesn't need to be broadcast in a peer-to-peer network, instead, it is stored directly into earth's timeline (just one time). The AI gnosis timeline records all events in the universe automatically. When the alien planets predict earth they will have the same data as us.

With this knowledge, earth doesn't even need a backup for the entire AI gnosis on earth. Only one complete copy is needed and stored in a network of interconnected computer systems (like the cloud), and if data is corrupted or destroyed, it can be reconstructed very easily. The hierarchical events in the timeline are interconnected, and if one piece of data is corrupted or deleted the entire network will raise a red flag. All the dependent nodes in the timeline associated with the deleted data are used to predict the missing deleted data.

The AI Gnosis is unchangeable. Nobody in the universe can change the data, and every alien planet in the universe will have the same data. You can change a digital transaction in the AI gnosis like add in a memo to the transaction, but that event will be tagged as another event after the original transaction was made. The time states of both the original transaction and the modified transaction are recorded in the timeline in the order they occurred. Definitely physical events in the AI gnosis can't be altered like transactions made by physical money in the real world (i.e. a person using real money to buy a candy bar from 7/11, they can't use the same money to buy something else from a store down the street).

This isn't just about bank transactions, but all events on earth. If a person has an idea in his head, that idea is stored in the timeline as it happened. If someone kills a rabbit in a forest with no witnesses, no cameras or spying smartphones around, that event is still stored in the timeline. That rabbit killing event contains atoms and em radiations that affect all other atoms on earth. This is how the super intelligent robots will be able to predict that past event—not through satellite technology, or cameras, or smartphone sensors, but through detective work in a virtual world to predict past or current events. The super intelligent robots can predict the past easily because every atom on earth affects each other through causality. It is through this cause and effect of events in an interconnected network that allow these robots to predict past events with pinpoint accuracy. Using all the current atoms on earth as forensic evidence, the robot detectives have to predict past events and store them in a timeline, and this is how the AI gnosis timeline is constructed.

Human level AI is the intelligence type to understand complex rules of prediction, to collaborate in a team, to do predictions, to correct mistakes, and adapt prediction procedures. Super intelligent robots are just robots, each with human level AI that uses a virtual world to do team work “faster” by using time dilation (i.e. the time dilation setting is set to 30 years of work inside a virtual world is equivalent to 1 second in the real world. This means the robots can do 30 years of human team work in less than 1 second).

Digital property, physical property, mental thoughts, ideas, NFTs, and anything grounded in reality are recorded in this AI gnosis timeline. In fact, the AI gnosis records everything. This includes: digital data, physical objects, events or abstract things.

Also, another important note worth mentioning is that it is 100% impossible to fake an event in the timeline. If someone wanted to insert a fake event into the AI gnosis timeline, all the dependent nodes in the network will tell the world that this is a fake event and it never happened. It's like shining a flashlight at the fake event at night.

You need a universe internet that can “make infinite transactions using 0 second.” You need a universe internet that has instantaneous communication with galaxies far away where two planets light years apart can chat online, have zoom sessions, or visit each others' websites, instantaneously. Even buying and selling products online or setting up earth's websites in alien planets need to be instant (in real time with 0 seconds). If 2 billion aliens from 2000 different planets wanted to buy a movie file from earth and the cost is $4.99 each (earth price), the AI has to be able to process all those transactions. Alien buyers will spend money and earth sellers will have money transferred to their earth accounts, and download files and transfers of files are made. This is just for one item on earth. In the future, earth will be selling zillions of items per nanosecond with alien planets light years away.

Downloading time is 0 seconds for 50 trillion gigabytes of data transfer from planetA to planetB. There are no signals transmitted from planet to planet so there won't be transmission interruptions or interferences. The online connection will always be connected, unless the server doesn't want you in and kick you out deliberately.

The only way to ensure this is to centralize all data and servers on earth's internet and to relegate control of the entire internet to one entity. The Ai god must have the ability to control all websites (all servers and platforms like Google, Meta, Amazon, the cloud, etc.) and modify data for the people of earth and behalf of alien users that want to connect to earth's internet. Also, all human inputs and controls of the internet are removed and done by AI in its instead.

Things like AI assistance to do tasks for users are deployed using AI god. Each AI assistance have human level AI as their intelligence type and they are working together in teams to do work in time dilation, so 30 years of human team work can be performed with optimal efficiency and done in less than 1 second. The AI can perform both digital work and physical work for users online.

What I'm saying is that the current internet infrastructure will not work for my Universe internet or the Universe time machine. We need a faster and less costly, centralized global network to secure and store “all events” on earth for both digital events and physical events.

My AI gnosis stores all events in earth's past. If a transaction happened, it is automatically stored in the timeline as true fact and that event cannot be changed. If a digital transaction45 is changed, it will be recorded as a modification of the original event and time stamped as occurring after the digital transaction45 was made. If double spending is done on a digital currency, both transactions are recorded and the AI will flag it as double spending, immediately.

As far as security of the data is concerned, with the AI gnosis, no data is secret or hidden (100% of the data are not hideable). All other planets in our universe have the same AI gnosis and all data on earth are” global” and “public.” This includes mental thoughts and memories of human beings or digital files stored in any computer, encrypted or decrypted. All passwords hidden in human brains worldwide are viewable.

All passwords and all ways of access to private accounts are transparent to not only people on earth but the entire universe. The AI gnosis stores all objects and events in earth's past and, in the future, all humans will have access to the data in the timeline.

Mitchell Kwok's AI gnosis and the AI god is an alternative to blockchain technology and it can represent NFTs and digital assets in a different way. I'm providing 100% and 360 degree security for physical property like physical money and collectibles (such as sports cards), along with security for digital property (like digital currencies and NFTs). Also, the system includes AI insurance and that if your digital money or physical money is ever damaged or destroyed, the AI god will restore your AI property back to its prime state, atom-by-atom. This includes your own physical body. If you are ever injured, diseased, or killed, the AI god will bring you back from the dead atom-by-atom. This is AI insurance for all humans and animals on planet earth.

“I predict, I'm willing to wager, the blockchain technology we have today will transform into my AI gnosis in the future.”

### The Internet Gnosis

The internet gnosis (earth) stores frame-by-frame every atom, electron, and em radiation pertaining to the internet and user activities in a timeline; for every nanosecond (FIG. 1). Its main function is to store all content and activities over the internet in time states for the lifespan of the internet starting from the 80's to the current state. It is the perfect digital timeline of all internet activities and is a part of the AI gnosis of earth. Referring to FIG. 4, all physical computers and servers that comprise the internet are stored in this internet gnosis as atoms, electrons and em radiations, in terms of position and time states. In turn these atom tracking data records all events and objects related to the internet. All the users that interacted with these computers or servers are stored in the timeline along with their activities—of what they did and when did they do it. All digital signals transferred in the air via em radiations are recorded in the timeline. So, the AI has access to even the digital signals that are sent in the air. These digital signals are stored in terms of location on earth and time states. And finally, the hidden data over the internet are recorded frame-by-frame. These hidden data are the digital files of the internet stored in servers and computers all over the world. Digital files also include applications running on servers like search engines, network routing software, internal logs of computers, internal computer circuitry, etc.

For example, a digital file called movie33 has many copies over the internet. Let's say the movie was Jurassic park. Movie33 is recorded in the timeline not based on referencing one copy in a master database, but is recorded based on all copies in the world. All digital copies of movie33 are recorded in terms of where it is stored (which hard drive), from what computer, the content of movie33 (like quality, length size, screen size, color type, hue, etc.), when it was stored, when it was made, and the variations made based on the original file/s. Some content in copies of movie33 have alternative scenes. So, in some ways, copies of a movie, though it's the same movie, are not the same; there are slight variations for each copy of movie33 and all of them are recorded in the timeline.

This is the strength of the AI gnosis, because all digital files and their copies over the internet are tracked throughout their entire lifespan. Identifying deepfakes using Ai generated software is easy and identifying when these deepfakes were made is easy. And if these deepfakes are based on images and videos of real life events, the AI will know which are fake events and which are real events, because the AI has the AI gnosis to compare actual events to the deepfake content.

The AI will be able to identify a deepfake with a 100% accuracy rating and fraud is brought to 0 percent, regardless of how elaborate the fraud may be. This isn't done by analyzing the deepfake to determine if it is fake, but by looking into the deepfakes' historical origins. This is how humanity will ultimately get rid of all deepfakes or identification of deepfakes generated by AI over the internet.

Applications or software can be accessed in time periods in this internet gnosis timeline. Search engines can be used in time periods. You can do a search on Google in 2004 and the search results will look exactly like it did in 2004.

### Centralization is the Key to the Universe Internet

One entity called the AI internet will represent the entire earth to communicate with alien planets. The AI internet has to take control of the entire internet of earth in terms of reading and writing data. Third party companies like Google, Facebook, Amazon, all websites on earth, and all online merchants must give the AI internet access to their servers in terms of reading and writing data. If an alien user wanted to buy something from Walmart, the AI internet must have the ability to insert the alien transaction into Walmart's database. The transaction will include the alien user's buying statistics, who the user is, where he lives, when did he log in, when did he purchase the item, what pages did he access on earth's site, and so on. All the activities of the alien user have to be recorded frame-by-frame and stored in the internet gnosis timeline. In addition, Walmart's website must allow AI internet to modify its log files to include the alien user and all of his activities while on Walmart's website.

Of course, the AI internet will follow strict rules outlined by each internet company, and to make sure that there are no fraudulent activities going on or interruptions of e-commerce transactions.

If you think about the AI gnosis, it is a very comprehensive method to document all events on earth all the way down to the individual atoms and their sub-atomic particles. Bitcoin and blockchain is still in its infancy and the only thing they really applied the technology to is the banking sector and NFTs. They are currently trying to apply the blockchain technology to applications like AI assistant.

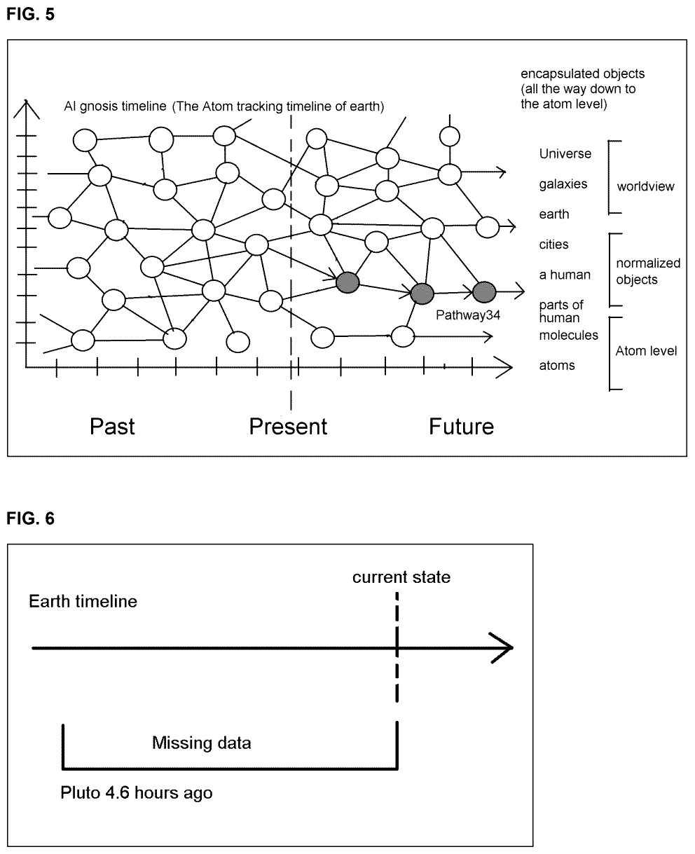

My AI gnosis covers all of that and more. Individual atom activities, as an event, are also stored in the timeline. When an electron emits an em radiation, that microscopic event is recorded in the timeline. Even happenings at a sub-atomic level are recorded such as the happenings inside the core of an atom, or we can go deeper and analyze individual quarks (FIG. 5).

Tracking and recording em radiation is very important to verification of digital data. Since digital data isn't physical and isn't a fixed tangle thing, it can be altered. Let's say a bank transaction34 was made. Bank transaction34 is only stored in computer22 and one day computer22 is destroy in a fire. So, how do we get back that data? Well, the timeline recorded the bank transaction34 for its entire lifespan from its creation to the day it was destroyed. Computer22 might be destroyed, but we have records of computer22 atom-by-atom the day before it was destroyed and therefore we have a means of retrieving the permanently lost data.

Let's imagine that the entire lifespan of transaction34 was destroyed from the AI gnosis, what then? How do we retrieve the permanently lost data?? Well, the super intelligent robots have to reconstruct transaction34 from scratch from its creation to the present state. They have to predict computer22's entire past using detective work inside a virtual world; using time dilation to quicken the task. Since no one can change past events on earth and earth has only one past timeline, the robots will eventually predict transaction34 again.

The robots have to look at the dependents to transaction34. One clue for these super intelligent robots is that someone might have seen transaction34 in the past. When user3 sat down on his computer and viewed transaction34, the monitor is sending light in his eyes on the content of transaction34 (this is why recording em radiation or light is so damn important to the timeline). Now the AI has to view the event where user3 sat down on his computer to view transaction34, and it has to analyze the em radiations between the monitor and user3. The examination of the em radiations will tell the AI what transaction34 is and of its contents. Or another method is to read user3's brain memory of transaction34 to get its contents (by the way, the deletion of transaction34 is erasing of computer22's existence from the AI gnosis timeline because that is where transaction34 was stored and where transaction34 was made).

The AI was able to take dependent events like the interactions of transaction34 to reconstruct what transaction34 was. It was able to take partial data in the AI gnosis to reconstruct the whole data.

So, the atom timeline of earth is a very good recording repository of all events and activities on earth. It's reliable, dependable, accurate, and most importantly, all data in the timeline are not modifiable. No one can fake an event and insert it into the timeline. Earth has only one past timeline, it's one linear sequence of events for earth for 4.5 billion years that can't be changed, and it will always be there for eternity. If we store all the atom tracking timeline, the AI gnosis, in a massive computer farm of servers and some of the data is destroyed (with no backup), the AI can easily retrieve that data by predicting the past again using super intelligent robots.

All the super intelligent robots have to do is take some of the dependent events for transaction34 and predict what the missing data is. Dependent events can be events that are unrelated to transaction34 (like a car accident occurred outside the bank that created transaction34). All events in the timeline are interconnected somehow, and so even unrelated events to transaction34 like the car accident can be used as clues to predict transaction34. And because transaction34 exists as an event in earth's past, all the robot investigators have to do is predict that past event. With a little work in the virtual world to do past research and predictions, these robot investigators should be able to predict transaction34 again, and because it is using a virtual world with time dilation to do work, transaction34 can be predicted in less than 1 microsecond.

Let's imagine, transaction78 is an event in earth's gnosis timeline, and not only does it store the digital transaction data in a ledger, but it also stores physical objects that comprise the digital event, such as person5 who made the transaction. Every action person5 takes to fulfill transaction78 is recorded in the AI Gnosis frame-by-frame and atom-by-atom. Both his digital activities on computers and his physical actions in the real world are recorded in sequential order and time stamped. For example, let's imagine that transaction78 is person5 buying a jewelry online from Macy's. Person5 used his own money from his bank account to make the purchase. His activities to make the purchase include (these are the dependent events) person5 going on his computer to the merchant's website, locating the jewelry he wanted, and buying the jewelry online. These online activities are time stamped and recorded as events related to transaction78.

Both digital events and physical events are recorded in the timeline. The physical events are things that people can see like person5 using his computer-his brain activities and his body movements are recorded in the timeline while he is buying the jewelry online.

The hidden digital events include all internet activities like the happenings on the merchant site, the routing transmissions, the activities on the server side, the digital transaction78 processes inside a computer and so on. Even the digital signals that traveled in the air or landlines for the internet in regards to this transaction78 are recorded frame-by-frame and atom-by-atom. (i.e. the digital transmission signals in the real world of transaction78 from the client to the bank server is recorded in the timeline). This is an overkill of recorded data regarding transaction78 stored in the AI gnosis compared to the 3-4 sentences of transaction78 stored in blockchain. This is necessary for the AI gnosis to ensure 100% security for transaction78.

The AI is recording everything, even the digital signals comprising em radiations traveling in the air are recorded for their position and time. This recorded data can be used in a computer simulation to extrapolate the digital signals' content (transaction78). All em radiations on earth are recorded and stored in the AI gnosis timeline frame-by-frame and atom-by-atom as they occurred in history. Thus, the AI has access to any digital signals that are zipping for sender and receiver for the earth's entire past. Transaction78 is just one of those digital signals that it has recorded in the timeline

Again, if transaction78 is destroyed with no backup, the AI can take all the dependent events that comprise transaction78, such as person5's actions on his computer or em radiations traveling in the air regarding transadtion78, and use these dependent events to reconstruct the original content in transaction78.

Transaction78 can't be forged or deleted either from earth's timeline. If someone forged the content of transaction78, “all” the dependent events, wither from the digital world or from the real world, will flag it as fake. In fact the moment that a person10 forged transcation78b is also recorded in earth's timeline and therefore the forgery itself is an event in earth's past. That's how people can verify that transaction78b is a forgery. It was perpetrated by a person10 (Note by inventor: transaction78 is a digital “static data” with a variable/value assigned to it, and transaction78b is the replacement value of transaction78).

Transaction78 also can't be deleted either by person10. If person10 deletes this tranaction78 from the AI gnosis, there is a missing slot there. The robot investigators will see this as a missing data in earth's timeline. They have to predict what that missing data is. When they do, they will eventually predict transaction78. Thus, deleting any event in earth's past is impossible. If someone wanted to delete the 9/11 attacks from earth's past and hide the event from the people of earth, that won't be possible. There are dependent events to 9/11 that is an integral part of the 9/11 event and there is no way for someone to change that. For instance, a person15 died in the 9/11 attacks and was buried in a cemetery in New York. If the 9/11 attacks were erased from earth's history, how did person15 end up there? I know this is a stupid example, but it clearly illustrates my point about how impossible it is to delete past events from earth's timeline, because all past events are interconnected and sequential cause and effect formed the planet's current state.

Bitcoin transactions, NTF transactions, and traditional bank transactions are stored in this timeline frame-by-frame and atom-by-atom, not just for the digital transaction itself, but other dependents such as the buyer's and seller's activities, and the digital signals for the transaction traveling from buyer to seller. The data transmissions in the air via em radiations (radio waves or photons) are recorded in terms of their position on the earth and their travel path.

That extra data will ensure that a bank transaction will never violate the law. There is no double spending, there is no theft of digital assets, there is no fraud involved, the transaction can't be modified, etc. If fraud happens, the perpetrator will be recorded in earth's timeline. His digital activities and his physical activities are well recorded, and the AI will flag him as a criminal that wanted to steal other people's Bitcoins. Bitcoin's immutability won't help the criminal get away with this theft. The AI has lots of data as evidence to convict the criminal in court. Hiding as an anonymous user won't help him either.

As you can see, the AI Gnosis is a very powerful tool to authenticate past events on earth. It can bring the security of digital currencies to a 100% secured system. 100% secured means no one can commit fraud in a system like that, even if they do deep social engineering-criminals can't commit fraud under any circumstances.

This AI gnosis timeline is the tool that AI god uses to determine fact from fiction for both the digital world and the real world. Ultimately this AI Gnosis is the tool all AI software, sentient robots, and humans will use to determine truths.

Now let's apply this method to other areas like physical crimes. No one can get away with a crime, and it doesn't matter if its capital murder or a petty candy theft at your local 7/11. More difficult cases like rape and self-defense cases can also be resolved with a 100% accuracy rating. If a woman is accusing a man of a rape that happened in 1950, the case is a “she said he said” scenario with no physical evidence to prove the rape event occurred. This is not true with the AI gnosis, “all events” in the past can be viewed in court. All events in earth's past, from its origins to the current state, can be viewed as they happened in the past. That's 4.5 billion years of earth data. This is a valuable tool for the U.S. to achieve a perfect justice system.

The rape case can easily be solved by searching the AI timeline for the rape event. If the rape event doesn't exist, it means the rape victim lied. If the rape really did happen, the entire event from start to finish and frame-by-frame are shown in court for all the jurors and judge to see. They can analyze it like a simulation and zoom in or rewind the video to any time stint to analyze data. All lies, exaggerations, and half-truths will be identified and only the truth will be presented in court.

In order to resolve this rape case and bring this case to a final conclusion, the mental thoughts of both the rape victim and the rapist must be analyzed while the rape is happening. This will determine a lot of things, such as the punitive damages to award the rape victim, or wither this case is consensual or not. How traumatized was the victim can be determined by analyzing her brain during the rape. If the event was really painful for her both emotionally and physically, the judge can award more money. If she wasn't traumatized and she exaggerated on the trauma, the judge can give her less money.

Maybe this rape case wasn't a rape at all. Maybe the victim wanted to go to court to rob money from a rich man. Watching the rape video and peeking into the minds of all parties involved will tell us wither the sexual encounter is consensual or not. So, resolving this and other rape cases would be very easy for the AI.

I think one of the most difficult cases that this AI justice system will ever prosecute is inventions. I'm going to use the college professor example again. A college student writes a paper on a new technology and a college professor reads it and copies the ideas. The college professor then files a patent on those ideas and 10 years later won Nobel Prize for his copied invention.

Now, the AI has a very difficult task of determining who originated ideas and who copied ideas. The only way to do this is to analyze both inventors' brains. We got the physical data like the college professor's patents; they were written down on a fixed tangible medium. But what about the college student's papers?? They weren't officially published. The AI has to make sure that all the proper evidence is available, and it has to find out what events lead to the patent filing. During the AI's investigation it will discover the college student's paper. It will also discover that the college professor stole ideas from the college student.

At this point, the AI will analyze the brains of all parties involved. The AI will discover that the college student originated the ideas, and the mental thoughts of the college professor reveal he copied ideas from the college student. In fact, the vast majority of ideas the college professor had were copied from the college student.

Then the AI will have to analyze all instances of copying. It discovered that the college professor copied the college student 5 times in 3 separate occasions. The date of the copying, when he copied those ideas, where did he copy those ideas, and what information did he copy are the data discovered by the AI.

Another tool used in this case is the what-if technology, which is a software that can provide alternative timelines based on a condition. For this case, the condition is what if the college student didn't publish his papers, will the college professor invent the technology regardless, and eventually win Nobel Prize? If the AI runs the what-if scenario and the output is the college professor didn't invent the technology and therefore he didn't win Nobel Prize, it means the college student invented the technology. The AI can run 1,000 simulation instances and analyze the data or do cross referencing. If all 1,000 simulations don't show the college professor inventing the technology, it means a serious crime of intellectual property theft was committed here. The college student wins in court, and the Nobel Prize and the technology claims will be awarded to the college student. All patents issued to the college professor will be retracted.

One more point I would like to make is that the AI already has every instance of copying from the college professor. And generating what if scenarios should be easy at this point because the AI has all the proper information available. If the college professor copied idea1-idea8 from the college student, the AI has to fabricate possible scenarios where the professor has to discover these ideas on his own volition. He needs these ideas in order to invent the technology, and the AI has to try to predict scenarios where the college professor somehow used his own brain to come up with these ideas. Maybe he was watching a movie and those ideas popped up in his head, or he was taking a shower and those ideas miraculously popped up in his head. The most important thing is that the college professor has to create these ideas by himself, with no outside help, especially from the college student.

### Unchangeable Data

The data in the AI gnosis timeline is unchangeable. It isn't stored as digital files, but stored as atom positioning on earth with time states. What this means is that all atoms on earth are stored in the timeline in time states and anchored to the timeline; all physical objects on earth comprise atoms, electrons and em radiations, so therefore all physical events and objects are well documented in said timeline. For each atom that is recorded in the timeline, its respective sub-atomic particles such as electrons and em radiations are also recorded in terms of position on earth and time states. From physical objects like a computer system, hidden data such as digital files and digital activities can be represented. This type of representation of past history is comprehensive and records the entire happenings on earth for both the physical world and the digital world at 100% accuracy and in 360 degrees.

Past historical events can easily be observed by running events from the AI gnosis in a simulation for users to view and interact with. The viewing dimension is at a human level—the user wants to see earth's events from a human eye point-of-view. However the user can see events in the timeline in any visual dimension.

People using the AI gnosis has access to user-friendly interface functions like voice commands through AI assistance, or through an app that will allow a user to view an event from any time stint, any angle, any viewing dimension, and from any point of view. All past events of earth from its creation to the current state can be viewed-which is approximately 4.5 billion years worth. Even before that when earth was just a pile of floating rocks in space can be viewed, and viewed all the way back to the big bang.

What about Digital Data and Internet Activities, which are Hidden from the Physical World?

All objects on earth, small or big, are recorded in the timeline frame-by-frame, all the way down to the atoms and its sub-atomic particles (electrons, em radiations, and even quarks). Every money bill, every sports card, every computer, every disk drive in all computers in the world, every car, every human, every robot, every electronic device, every bacteria, every animal, every dna cell, every tree, every structure, every plant, every blade of grass, every molecule, every atom, and every sub-atomic particle on the planet are recorded and stored in the timeline as it happened in history. The Ai god keeps track over everything and spies on everything. The AI god not only tracks every object on earth but it has the ability to predict each objects' entire lifespan from its creation to the present (and possible future).

The physical world is one thing, but the AI god also has to do research and investigation to extract the hidden objects in the digital realm. All em radiations in the air are tracked and analyzed for content, like digital signals. Electricity running through landlines are tracked and analyzed for data transmissions or digital signal contents. Human brains are copied atom-by-atom and runned through computer simulations to extract hidden things like mental thoughts. Physical computers are copied atom-by-atom and runned through computer simulations to extract circuitry activities, software instructions, and internal mechanisms. So, the AI god not only tracks physical objects on earth but it also tracks the hidden objects that the physical world doesn't show.

The method in which Ai god can tell which money bill is fake and which are real or to determine if a sports card is real or fake is by spying on each objects' lifespan on earth. It does very well with hidden objects like bank transactions too or digital currencies. It guarantees with a 100% certainty a digital currency won't be stolen, or each digital currency won't break business laws like double spending. This is ultimately how AI god will resolve the problem about fake news, especially generative AI over the internet. Because it is tracking every object on earth, it can determine which are fake events/objects and which are real events/objects. No one has to worry about wither content over the internet is fake or real anymore.

The AI gnosis stores the actual historical events on earth as it happened in history, and AI god uses this AI gnosis timeline to determine what is real and what is fake. Thus, if you got a video posted online of a presidential candidate saying something he didn't say, regardless of how sophisticated the video may be, the Ai god will flag it as fake news. It knows when the AI generated video was made and who made it. It even knows the original video that was used as reference. This method is applied to “all” AI generated content online. If someone deliberately posts an article that is fake and misleads users online, the AI god will flag it as fake news (it doesn't matter if it's backed up by big corporations). If someone copies an idea from someone else and files a patent online, the AI god will identify that as criminal-classified as intellectual property theft; and the copycat's back story will be flagged as a lie.

### Digital Data Example

Referring to FIG. 1, notice that the hidden data has connections to physical data on earth. Digital data and digital activities were created from physical computers. Digital activities were created from computer processes, and digital data is stored in computer hard drives. So there are associated links between digital data and physical data in the AI gnosis timeline.

Let's apply this to digital currency like a bank transaction. In order to access a digital file (a bank transaction) from a computer in 1990, the AI has to search the AI gnosis timeline, analyze the atoms comprising a specific computer, zoom in on the hard drive and extract the atom positions of a segment of the hard drive. The atom positions, if viewed with a high-powered microscope, will contain the 0's and 1's of the digital file, which contains the bank transaction. In other words, if we view the data in the hard drive in a localized area, we can view the metal grooves that determine the 0's and 1's of a digital file or application. The AI simply has to reverse engineer the computer technology language to extract the content of the digital file. If the file was encrypted, the AI must decrypt it first in order to read the digital file.

If a digital file is encrypted, the AI can search other areas of the AI gnosis timeline to find the encryption software to decrypt the file for viewing. Or the AI can just search the timeline for the file before it was encrypted.

### How to Determine if a Bank Transaction was Legal?

This is why blockchain's peer-to-peer network exists in the first place—to verify a transaction and to use swarm agents to mine the data into a block. I have an alternative to blockchain: my AI Gnosis timeline. The existence of a digital transaction in the AI gnosis timeline makes it true, and this digital transaction is verified.

The entire lifespan of a bank transaction is recorded frame-by-frame and atom-by-atom into the AI gnosis timeline. Let's call it bank transaction23. The double spending can easily be solved because bank transaction23 was recorded on Jun. 12, 1990 10:23 a.m. If the buyer decides to double spend by using some hacking software to use the same money to buy something else 1 second later, the AI gnosis will record the second bank transaction24 as using the same money. This will raise a red flag for the AI because a double spending was identified.

All the data in the atom tracking timeline is 100% true. If transaction23 happened and 1 second later transaction24 happens, it means it's true that double spending has occurred. This fraud is possible if transaction24 was made before transaction23 was completed. And because the AI gnosis has other comprehensive data like the buyer and seller info., what was bought, the locations of buyer and seller, and other related digital and physical data, it is 100% impossible to fake this double spending transaction.

Any modification of transaction23 is impossible. For example, if 2 days later after transaction23 was made, a bank teller modifies the data in transaction23, that event is recorded too in the timeline. Not only will it show who modified the data (intentional or unintentional) but when did he/she modify the data and why. Even the bank teller's mental thoughts are recorded and it shows what they modified in bank transaction23 and the reason for it.

Bank transaction23's entire lifespan is tracked in the timeline. It will record all insertions, modifications, and deletions pertaining to this transaction and none of the data can be changed or deleted or newly created.

This can be guaranteed for all digital currency transactions in the world regardless if people are using Bitcoin or bank money. Your digital money is secured at 100% (Bitcoin can only secure 90%), and in addition, the possibility of fraud in a secure system like this is 0 percent, even if the culprits use deep social engineering or elaborate software to do the fraudulent transactions. The culprits' every move, their physical activities, their mental thoughts, their locations, and their digital activities are all recorded in the AI gnosis timeline frame-by-frame and atom-by-atom. Using Bitcoin's anonymous user to do the transaction will not help the culprit (which is one of the reasons why they use Bitcoin to steal money from unsuspecting people). The AI is able to easily identify these anonymous users in terms of what they did, where they live, and who they are. The AI discovered all this through the sequential events in the AI Gnosis.

This method to verify and authenticate past events can be used for physical properties, and to verify its authenticity. The best example is to apply this AI gnosis to the collectibles industry. Every sports card, memorabilia, comic book, physical coin, and physical money are all tracked in the timeline for their entire lifespan, from their creation to the current state (or deletion).

The AI knows if a sports card is fake or real by analyzing the events in the AI gnosis timeline. A sports card can be verified by witnessing the date it was printed, in an official center. The time and date is recorded of when it was created and it was made by the manufacturer, and it's classified as real. Then the AI has to analyze the exchange of property owners. Maybe the card was exchanged from hand to hand 5 times in 30 years. The AI knows who these 5 property owners are and when did they possess the sports card.

If it was a fake, the AI gnosis timeline will contain the event where the criminal made the fake card. He might have used a very undetectable method to perpetrate this hoax. For example, he might have used an old cardboard from the 90s, the same one that was used by the manufacturer, and he used laser printer technology to print the image onto this authenticated template card. It looks authentic on the surface, but it's an elaborate fake.

The AI is smarter than that. It can analyze this card and compare it with a real sports card and the AI won't find any discernible differences. That's not how the forgery is discovered. The AI has to look at the lifespan of the card specially the day it was made. That event will show that the card is a forgery and it records who forged the card and all his activities.

Imagine using this method to authenticate all collectibles in the world. Next, imagine using this method to authenticate all physical money in the world, including coins and bills. I can walk down the street, accidently lose my physical money; I dropped it accidently and some pedestrian picks it up and buys a pizza with that money. By the time I got back home, I found out that my money is gone. But the AI had all the events stored in the timeline and can easily tell me where my lost money is currently at.

A system like that to track physical money is not possible yet. Even bitcoin and blockchain can't do this. And the fact that the AI gnosis can guarantee security for physical properties is a lucrative business and quite frankly a multi-trillion dollar industry.

In another example, my home was robbed in 2009 and someone took $3,500 in jewelry and cash from my home along with a laptop computer. The AI can tell me what happened to all that money and who the culprit is. In fact, the AI god will arrest the person involved, and my money will float back to me automatically (through global telekinesis). The culprit will get a knock on his door by a ghost robot and be taken away to jail. All this is done automatically without me filing a lawsuit, if this Ai god was around.

To verify if a user has seen a document (bank transmission23)

All em radiations in the world for all time are stored in the AI gnosis. Digital signals are made from different types of em radiation (radio waves, lasers, microwaves, light, etc.) To verify if a user has seen a document online is quite simple. This is how the process works: the AI analyzes the computer and the user. All internet activities are analyzed including the em radiation zipping through the air to get from the server to the user. Sometimes people are still using the outdated landline—using copper wires for digital transmission. Regardless of transmission type, the digital signal is carrying the same digital content. The AI must verify the digital signal by seeing the individual em radiations in linear order. It can then convert the digital packets into digital content. If the AI observes the digital content and it is in fact bank transmission23 and the user's computer screen has bank transaction23 on the monitor, then it is verified that the user is observing bank transaction23 on his computer on a particular date and time.

### Other Hidden Data not Found in the Physical World

Other hidden data includes things like computer internal processes such as individual activities inside a cpu, and the mental thoughts of a human being. These hidden data require elaborate procedures by the part of the AI to extract. For example, the mental thoughts of a human being requires the AI to extract the atoms of the human's brain and run that data through a computer simulation. Next, it uses methods to extract mental thoughts from brain patterns alone, possibly using machine learning methods and AI. That is how mental thoughts of a human being are discovered. These mental thoughts are updated in real time as the human live life and think.

### the Construction of the AI Gnosis Timeline of Earth

One of the most important tasks of the super intelligent robots, robots that are exponentially smarter and faster than human beings, is to construct the Ai gnosis for earth and for the universe. Let's localize this topic only to earth. These robots have to work inside a virtual world in time dilation to predict past events all the way down to the individual atoms and their respective sub-atomic particles.

These super intelligent robots can be structured in any business structure or network topology. This business structure doesn't have to be hierarchical in nature, it can be anything. It can be a government system, rivalry companies, a peer-to-peer network, a chain corporation, a competitive sport, a social media network, etc. They all have their own set of complex goals, rules and procedures to do their prediction tasks.

To limit the amount of bad robots and to improve on performance and efficiency, the government has to license these robot predictors. Each company has to prove that they have what it takes to compete in this field. Each robot is an expert in their field of study, and as a collective company, they have the knowledge and skills to predict past events compared to their rivals.

Efficiency and allocation of computer processes and resources is very important. They need to get the predictions done quickly using minimal computer processing time. That would mean that all companies have to work in a hierarchical structure to collaborate with each other to do prediction tasks. In my practical time machine patent, I describe how this process works. The robots have to do everything exclusively inside a virtual world using time dilation which is set to 30 years of team work is equivalent to 1 second in the real world. No human investigators are used to predict the past, only robots are used to do the predictions.

Each robot is an individual, and each has human level AI at an expert level (there is no alternative to this type of intelligence). Human level AI will solve the problem about each robot understanding goals, rules to follow, powers, team coordination, proper procedures, and interruption protocols. There are billions and billions of robots working in millions and millions of virtual companies, all experts in their field of study. All virtual companies perform equal to or better than their respective human companies. Most of these companies are hierarchically structured to do team work which minimizes repeated work in the system.

They work in a specialized prediction website, where robots can post their predictions, update procedures, comment on wrong predictions, get up to date research data, provide analysis data, list prediction polls, designate computer processing allocations, provide feedback from competitors, etc. This specialized prediction website will help the robots manage their research as a collective whole despite being competitors. It is the responsibility of all robots in all prediction companies to read content on the prediction website to get the latest updated prediction information. The most popular methods of prediction will be used by the community, the most popular predictions will be used, and the most up to date research data will be used to do future predictions. If one robot posts an idea or a prediction on the website, everyone will have access to that idea. Everyone has to contribute to these predictions, and they must analyze and determine which are true leads and which are false leads. All the predictions posted will be ranked and posted for the entire robot community to see. AI moderators are there to curate the contents of the prediction website to display the most relevant information for all robot predictors.

The award, which is the driving force behind the prediction system, is robots getting paid for posting the correct predictions. This is a competition to get awards. Referring to FIG. 5, all the predictions are outlined in a hierarchical manner. The bottom are location and time of atoms, at the middle are the normalized objects, and at the top are encapsulated objects. For example, a car is a normalized object; the car comprises molecules and the molecules comprise atoms (lowest level). On the top level, the car is encased in a city, and the city is encased in planet earth, and the earth is encased in a galaxy, and the galaxy is encased in the universe.

Once the atoms are anchored to the timeline, the event is fixed and the prediction is 100% correct. No more work is needed for that event. Let's say that the robots wanted to predict the D.B. Cooper event. The award money is ownership of copyrights to this event. The event is structured in a hierarchical manner from general to specific. The award system is that robot predictors can post their research on what happened in the D.B. cooper incident and whichever robot post first that has the correct data will be awarded the copyrights (money). They can post predictions anywhere in the hierarchical prediction tree. This isn't one company that owns the copyrights but a plurality of companies that own the copyrights to this event. Let's imagine, company3 and company4 own the copyrights in the encapsulated level, company14 owns the copyrights to the normalized level, and company8 and company9 own the copyrights to the atom level.

Now, the copyrights come when a user online views the D.B. cooper event. Every view will give the copyright owners money. If a user wanted to view the D.B. cooper event using the 5 sense VR technology so they can see the event from a first person point of view, the copyright owner again gets paid. All online articles that use this copyright will have to pay a fee to the robot companies that own the copyrights. If a movie company makes a movie based on the actual D.B. Cooper event, which is stored in the AI gnosis timeline, the money is paid to the copyright owners.

This money and award system will motivate these robot investigators to do a better job, to work longer hours, and to compete with their rivals to output the predictions in the fastest time possible and using minimal computer resources.

By the way, a robot with human level Ai is alive and self-aware. This robot isn't ChatGPT, it's a robot with a full human brain doing work inside a virtual world. Therefore, they are being treated like a human and given an annual salary or digital incentives (not to mention civil rights). These robots are motivated by greed, just like a human being. That's why they work so hard to be the first to get the copyrights to famous earth events like the DB cooper incident, Jack the ripper, OJ Simpson, the lifespan of Jesus (if he even existed), the JFK assassination, the 1947 Roswell UFO, etc. The first robot company to predict these past events with pinpoint accuracy will be awarded the copyrights along with the bragging rights.

And ultimately this is how the Ai gnosis will be constructed in the fastest time possible. These robots will probably take years just to construct the entire AI gnosis for earth for 4.5 billion years, from its creation to the current state. In robot time, that's like zillions and zillions of years of work by billions of prediction companies spanning many generations. If they wanted to construct the entire universe Gnosis, predicting the entire timeline for the universe for 13.7 billion years from its origin to the current state, it will take a very long time. Maybe they need help from alien worlds in order to accomplish this task.

### The Light Year Problem

If a transmission connection is established between Earth and Pluto, the transmission time is 4.6 hours one-way to get a signal to or from planets. What this means is that Earth is seeing Pluto 4.6 hours in the past. What we want is the current atom state of Pluto. We want users on both planets to communicate instantly, in real time. How do we solve this problem?

Referring to FIG. 6, the 4.6 hour difference is the missing data. What we want to do is have our AI predict the missing data. The missing data of 4.6 hours includes tracking every single atom, electron, and em radiation on Pluto.

Once that missing data is predicted by our AI and updated in real time, Pluto's every current activities are visible to the AI. In that state, both the activities on earth and activities on Pluto are synchronized. This permits users from both planets to communicate with each other seamlessly and with no possibility of transmission interruptions. The people of earth can chat with people on Pluto or share a zoom conversation or compete in online gaming. The users on earth will be communicating with the users in Pluto as if they were on the same planet, and without transmitting digital signals back and forth.

Now, imagine that earth was trying to establish a communication line with a planet 90 billion light years away? This is called the light year problem. As the distance between earth and an alien planet is farther apart, the missing data gets larger and larger; the Ai will have a tougher time predicting the missing data. Mitchell Kwok's super intelligent robots (aka Super AI) is needed to predict the missing data in the fastest time possible.

The solution to the light year problem is found from topics covered in previous publications, and I stated them over and over again like a broken record. The Ai has to predict the current state of the entire universe as a whole and not just the target planet. If the target planet is a PlanetV in a distant solar system, and PlanetV is 3 light years from earth, then the missing data is 3 years. What we see with our telescopes on earth today is 3 years ago on PlanetV. The AI has to use its inexhaustible intelligence to compile the necessary data to predict those missing 3 years of planetV. That is the only way to synchronize both planets, earth and planetV, and allow both to communicate with each other in real time.

Let's go back to the Pluto example for a simpler illustration. The AI will use all the available sensing devices on earth like telescopes, satellites and probes to gather as much data on Pluto and its surroundings. The AI will predict Pluto in a heuristic manner, starting from the target planet Pluto and moving out to surrounding areas. Historical data done by researchers and images from telescopes and satellites on Pluto will also be used as forensic evidence by the AI to do predictions. The sensed data will be prioritized hierarchically for AI to predict the missing data (4.6 hours delay between earth and Pluto).

Since the delay is 4.6 hours, the AI has to take the current sensed data and predict 4.6 hours into the future frame-by-frame and atom-by-atom, using earth's current state as a benchmark. It has to track all the atoms and its sub-atomic particles for those missing 4.6 hours. Super intelligent robots are used to do the predictions. Just like how these robots are used to construct the Ai Gnosis, it is also used to predict the missing data for Pluto. This task must be done quickly, like in 1 microsecond.

Once that is done, the AI has to update the atom tracking timeline for Pluto. Everything, every atom on Pluto, has to be updated in real time as it happens.

Now, as far as how this is done, read the previous Universe time machine patent application about my atom mapping technology for details. Here I will provide a summary:

The technology views the entire universe as an interconnected web of cause and effect network system. All atoms, electrons and em radiations comprising the universe affect each other one way or another. In current time, if a planet on Vega has a hurricane, our planet earth will have subtle changes or microscopic changes in properties of em radiations and the amount of em radiations. It is through these patterns that will allow people from earth to predict happenings currently on planets light years away. The AI has to find the patterns, using possibly a combination of machine learning and Super AI, and using these discovered patterns as clues to predict the missing 4.6 hours in Pluto, and to update all atoms on Pluto in real time.

The key is that if the AI wants to predict all the atoms on Pluto for the current state, it also has to predict all other planets in the universe. It just has to do it in a heuristic way starting from Pluto and analyzing outward to its surrounds. But the entire universe's current atoms must be predicted as a whole in order for the AI to track all current atoms, electrons, and em radiations for Pluto.

### the Atom Mapping Technology

The atom mapping technology was described extensively in previous patents, in particular, the practical time machine patent and the universe time machine patent. It is based on a component called the universal robot brain, which stores experiences and skills from a plurality of individual robots. All objects it learnt is structured hierarchically all the way down to the individual atoms and em radiations and stored in memory. The system is a mapping of all objects the robots have encountered in life; and trained to analyze objects in 3-d and at atomic levels.

Not only does it learn about the atom structure of all objects in the universe but it also understands the objects in sequences. It tracks all atoms of an object as it moves in time and space. In addition, the universe robot brain stores the interactions of objects at an atomic level (called events). When two objects interact with each other, wither that be matter interactions or light interactions, that data is stored in memory. From these microscopic and hidden interactions, the universe robot brain is able to extrapolate hidden patterns within these object interactions.

Now that it has all the objects learnt and structured hierarchically all the way down to the atom level, the AI can use this object database to reconstruct a perfect atom map of an object based on partial data.

In previous books and patents I talk about examples to illustrate the capabilities of this atom mapping technology. The example used is one hd picture as the input data and the AI's desired output would be a perfect 3-d atom mapping of the object. Here is the linear examples used, and they are listed from simple to complex.

1. The input is an hd picture of a computer and the Ai will map out the entire computer atom-by-atom all the way down to the individual atoms, electrons, and em radiations. The important thing is to map out the individual groves in the hard drive so that the AI has an identical copy of all data in the hard drive.

2. The input is an hd picture of a city and the AI will map out the entire city atom-by-atom all the way down to the individual atoms, electrons and em radiations. All the computers in the city must be mapped out atom-by-atom, to the point where their respective hard drives' data files can be read.

3. The input is an hd picture of the earth and the AI will map out the entire planet atom-by-atom all the way down to the individual atoms, electrons, and em radiations. All objects in the planet are mapped out atom-by-atom and updated in real time. Every single computer in the planet must be mapped out atom-by-atom, to the point where their respective hard drives' data files can be read.

4. The input is an hd picture of the solar system and the AI will map out the entire solar system atom-by-atom all the way down to the individual atoms, electrons and em radiations.

5. The input is an hd picture of the galaxy, the Milky way, and the AI will map out the entire galaxy atom-by-atom all the way down to the individual atoms, electrons and em radiations.

6. The input is an hd picture of the Universe and the AI will map out the entire universe atom-by-atom all the way down to the individual atoms, electrons and em radiations.

Noticed that all the object examples listed are encapsulated within each other, recursively. For example, the computer is encased in a city, the city is encased in earth, the earth is encased in our solar system, our solar system is encased in our galaxy, and our galaxy is encased in the universe.

The universal robot brain stores this encapsulated structure of all objects in the universe. And because it has the atomic structure of all objects in the universe, we can take partial data of an object and get the whole data from this database.

It's kind of like the human brain I described in 2006. We can take a partial image of a cat's leg and the brain can show us the whole data—it can zoom out and show us what the whole cat looks like in a 360 degree and atom-by-atom representation.

A very insufficient way to map out an object is to use a plurality of input data. For example, instead of one hd picture of earth, the entire internet data including satellite images, all sensing devices on earth, all smartphone data, all knowledge of historical sites, all Ai spying data, etc. are used to map out the atom-by-atom structure of the earth.

It is preferred that “minimal” amount of input data should be used to map out the atom structures of an object. The AI should be doing all the hard work with limited amounts of input data. The Ai's job is to take partial data (the hd picture) and to reconstruct the whole data (the atom map of the earth).

Also, a plurality of input data on an object won't be too burdensome because it will make the AI easier and faster to map out the object. In fact, it would be exponentially faster if it had more than just the hd picture of the object as input. The problem is that there are some planets out in the Universe that are so far away that we only have one fuzzy image to work with. From that fuzzy image the AI has to map out its entire atom structure. This is why I emphasize on creating an atom mapping technology that can take in minimal “partial data” of an object to predict the “whole data” of the object.

### How to Construct the Atom Mapping Data in the Universal Robot Brain

The atom mapping technology within the universal robot brain contains hierarchically structured levels of visual data. It goes from world views to human level visual views to atom level views (FIG. 5). All objects are represented hierarchically and all the data are encapsulated. The means by which the data is trained and stored in memory are based on individual robot experiences. If the robot has a humanoid body, the images will be like Google's 3-d streetview—every image is stitched together to form a 3-d map of the world. If the robot is small like a quarter, the images will be micro-sized. If the robot is as small as an atom, the images will be at an atom level. Ghost robots, non-physical robots, can be used to view individual atom activities. Finally, if the robot is large and can see things in a zoom-out manner, the AI can stitch space images to form a 3-d map of planets.

All the levels are trained with their visual dimensions, and they are linked together based on object association. In FIG. 5, the diagram shows there are three visual dimension levels: world view, normal view and atom view. The earth contains a human and the human contains atoms. All three visual levels are linked together based on atom associations.

In each level, the robots have to learn the 3-d sequences of objects and to store its behaviors and attributes. For example, in the atom level a ghost robot, which is non-physical, can observe things like the absorption of energy and the release of em radiation from an electron. When em radiation is absorbed by an electron, the electron moves into a higher orbit; and when it releases an em radiation, the electron drops back down to a lower level orbit. These types of atom sequential behaviors and properties are learnt by the Ai and universalized. By averaging the data of similar atom sequences, the AI is able to formulate math models of atom behaviors and attributes. Human intelligence via research papers, diagrams and scientific algorithms can also be used to represent physics behaviors.

Next, these micro-ghost robots have to learn the behaviors of multiple atoms interacting with each other. Sequential events of atoms and their sub-atomic particles interacting with each other are learnt through the 5 senses of these micro-ghost robots. They have eyes to see, they have ears to hear, they have mouths to taste, they have noses to smell, and they have skin to feel. They are using their “senses” to learn as much information about its immediate environment as possible. It's all about learning objects visually, and how objects interact with each other in the environment.

In the worldview level, ghost robots will be the size of the earth. Thank god they are non-physical. They are that large so that they can see the universe in a different visual dimension. They can stitch their experiences together and see the various planets in a larger scale, and see how these large objects interact with one another.

The idea for this universal robot brain is to store all knowledge about all objects in the universe and average all that data. Both static data and sequential data are stored. In fact, static data are objects that exist in sequential data. It's almost exactly like I stated in 2006 about human level AI. The brain stores sequential data, and inside these sequential data are: static data, 3-d objects, actions, places, 5 sense data, diagrams, different dimensional viewing of objects, etc.

Using this universal robot brain, scientists can create an atom mapping technology that takes input data like an hd picture of an object and its output is the atomic mapping of said object. The desired output is a 3-d mapping software that takes in partial data of an object and outputs the whole data of said object. 100G network

In the future, earth doesn't have to worry about 5G, 6G, 7G, 8G, or 100G telecommunications interfering with electronics. Earth's internet will go signalless and the only digital transmissions in the air are the global distribution system to send data to the public. No digital signals will be sent outside the planet. Think of it as global telekinesis of digital signals that can touch every computer and system on the planet, which is controlled by an AI internet (or AI god).

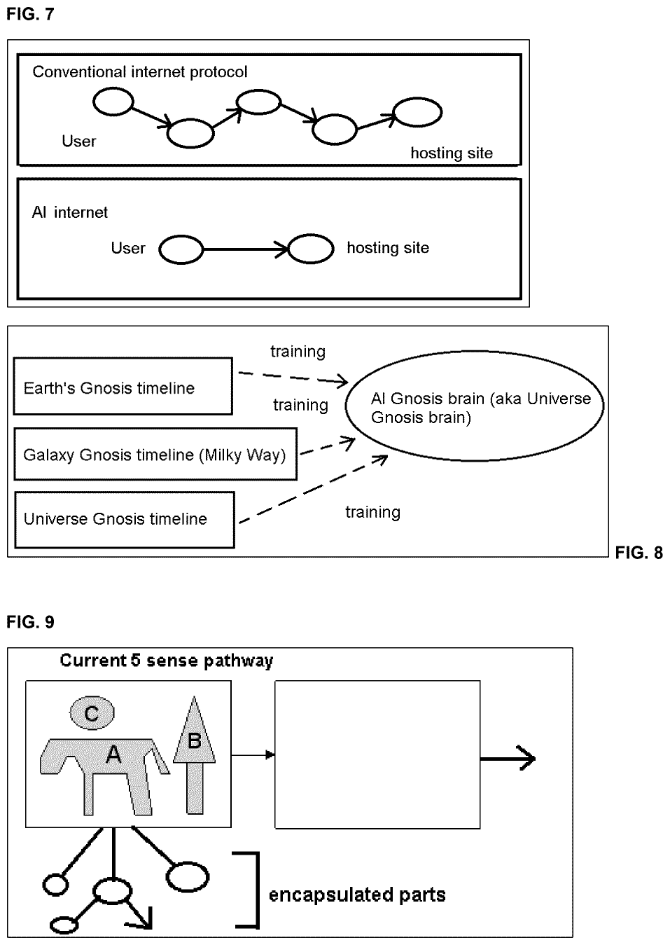

Referring to FIG. 7, this diagram shows what this global distribution network looks like. It bypasses all internet protocols, and an entity known as the AI internet distributes all data to users on earth by taking control of every aspect of the internet—from the websites to the servers to the network routers. For example, network procedures are bypassed to get information faster. When a user4 on earth types out a website on the URL of their browser, the AI internet bypasses the routing procedures, which travels from network node to network node to find the server that hosts the website. In its stead, the AI internet goes directly to the server that has the website and takes it and sends the data directly to user4. This bypasses the traversal of the server to server stage and, in turn, that will bypass transmission of data in the air to get from network to network. Which makes this method exponentially faster than conventional internet browsing.

It's like the AI gnosis is a digital copy of all physical objects on earth including all computers that make up the internet. From that digital copy of the entire internet, and in time states, we no longer need to transmit data in the air. Transmission of digital signals in the virtual world is set to 0. In the virtual world, if a user1 wanted to communicate with a user8 on the opposite sides of the earth, the transmission signals are instant using zero second. And because the AI already got a copy of earth's internet, the data file size of the transmission could be a large amount. A 60 million gigabyte folder can be transferred directly to the user—this can be accomplished by cut, copy, and pasting files and not by transmitting digital signals through the air.

The only digital signals that are sent in the air come from the global distribution system. The AI internet has a copy of all the computers and networks comprising the internet. It takes the index data of the website and sends it directly to user4. The global distribution system is just a network that AI internet uses to connect to every person on the planet.

Thus, this is a highly centralized system. Decentralizing software and data of the internet using blockchain will make a universe internet impossible to implement. Everything has to be centralized in the future and controlled by one entity. This includes websites, networks, hosting servers, computers, etc. Everything that comprises the internet is controlled by this AI internet so the communication of information from network to network is exponentially faster and cost effective for both the clients and the servers.

### Method2: Use the Ai Gnosis for the Atom Mapping Technology

The second method is to simply use the data in the Ai gnosis timeline to generate a full atom structure of an object based on minimal input data (an hd picture of the object). It makes perfect sense, the Ai gnosis contains atom tracking of all objects and events, and each object contains a hierarchical atom structure along with sequential animation. Even interactions between objects are stored in the timeline, especially atoms, electrons, and em radiations interactions.

The hd picture of an object is partial data and the desired output is the entire atom structure of the object. Both the input data and the desired output are stored in the Ai gnosis as data. We simply look into the Ai gnosis for the hd picture of that object and then we extract the rest of the data.

This idea leads me to another idea. In order for this to work, the AI gnosis, all of its content, must be averaged out in terms of similar content. It's like taking the entire timeline of the earth (or the universe in a higher plane) and storing the entire timeline into a massive human brain, whereby data are stored in terms of composition association, hierarchical association, and time association. Just like the human brain, described in my human level AI patent, the brain self-organizes all the data it learned and averages all the data. Similar objects will be grouped together and similar events will be grouped together. Identical or similar attributes will bring two objects closer to one another. When these objects are close enough they share information in an encapsulated tree that goes from general to specific.

The averaging of the data in this AI gnosis brain will average all the objects contained in the timeline (just like a human brain). What you have is an average of all objects and events stored in memory that it has learned. For example, a human object is structured hierarchically and it goes from general to specific. At the top is an average representation of a human being. This average template doesn't have a specific gender and is formless—it can't be identified as a man or a woman or a child. As we traverse the tree to the lower levels, the human object becomes more detailed and variations are stored. In the normalized level, the humans are classified into groups: man, woman, child, old man, old woman, etc.

Then at a lower level we have the specific types of humans that are classified into ethnic groups and body types. Even things like an ethnic bum and an ethnic rich man are classified into groups.

In the lower levels are the body parts like arms, legs, mouth, ears, hand, fingers, toes, torso, head, pelvis, back, etc. These are the parts that are encapsulated in a human body.

Next, as we traverse the tree at a lower elevation, are groups of atoms—the molecules. At the lowest level are the individual atoms and their respective sub-atomic particles.

This is exactly how a human represents objects and events in its brain, hierarchically, and this Ai gnosis brain works exactly the same way. The brain not only stores the objects itself but also its animations, object interactions, and linear events. In the case of the individual atoms, the activities of the atom, its electron and em radiation are recorded frame-by-frame and atom-by-atom in the AI gnosis brain. It should contain all the microscopic happenings in every atom of an object.

The AI gnosis brain stores the average objects and events and structures them in memory. If we take a picture of a specific human_R, the output will be the entire atom structure of human_R. Specific humans will have specific atom structure types. So, if we input a picture of an old Hispanic woman, the atom mapping technology will output the entire atom composition of the old Hispanic woman, all the way down to the individual atoms and its sub-atomic particles.

Remember what I said earlier about not only does the Ai gnosis brain store the static data but also linear events. It can predict the animation of this old Hispanic woman and track all of its atoms and how these atoms interact with other atoms.

Using input data that the Ai gnosis brain has never been trained before.

Let's suppose that the AI gnosis brain was only trained with objects found here on earth like humans, animals, trees, car, ant, etc., but what about alien species and unfamiliar objects found in outer space? Let's take the grey aliens for example. The greys are just humanoid looking beings that have similar body parts to humans. At first glance the greys are different from humans, but conversely we see similarities like they have two arms, two legs, a head, fingers, toes, a mouth, and two eyes. Although the features are different, the alien body, from a visual perspective, conform to a humanoid body. One might look at an alien from afar and mistaken it for a human child due to its height and body type.

Because the AI gnosis brain was trained with many human beings (the lifespan of all human beings that ever existed on earth), the data in the Ai gnosis brain has a hierarchical tree representing a fuzzy range of a human object. So, 90 percent of the atom composition of the grey alien is already stored in memory. The 10 percent that is missing will be resolved through math equations that were created from averaging all the patterns within this human hierarchical tree—the AI will fill in the missing 10%.

We take an hd picture of a grey alien and the software will output a perfect atom mapping of the grey alien, all the way down to the individual atoms. This includes internal organs. Even though we didn't train the AI gnosis brain to recognize aliens from outerspace, it was pre-trained in such a way that the 3-d mapping technology was able to do its job with unfamiliar objects (just like a human brain). A human brain can learn the average of doing a task like making a sandwich, and what is stored in memory are the average steps of making a sandwich. When the human has to make a sandwich in an unfamiliar environment and conditions, it is still able to complete the task despite not being trained with this unfamiliar environment. It works the same way with the AI gnosis brain.

The final stage is to test the Ai gnosis brain with the encapsulated example presented earlier. First, we test it with an hd picture of a computer and the desired output is an atom mapping of the computer. Next, we test it with an hd picture of a city and the desired output is an atom mapping of the city. Then, we test it with an hd picture of the earth and the desire output is an atom mapping of the earth. Next, we test it with an hd picture of our solar system and the desired output is an atom mapping of the solar system. Then, we test it with an hd picture of our galaxy (the milky way) and the desired output is an atom mapping of our galaxy. Finally, we test it with an hd picture of our universe and the desired output is an atom mapping of our universe.

Of course, we can use a plurality of input data besides the one hd picture, but minimal input that can retrieve the desired output is preferred. I think for the final example, we need to input all the data we collect from the universe through our satellites, telescopes, probes, sensing devices, historical pictures, and knowledge over the internet in order to create a 3-d atom map of the entire universe. This universe atom map must be updated instantly, and in real time in order for the universe internet to work properly.

### Method3: Merging the Knowledge in the Universal Robot Brain and the Ai Gnosis Brain

The universal robot brain stores not only knowledge from robots but also their “linear procedures.” There are procedures in there that allow robots to perform tasks. Maybe we can use that skill (super intelligent robots) and combine that with the AI gnosis brain (atom mapping technology) to create a better atom map of an object or event? Maybe the super intelligent robots can use the AI gnosis brain as a tool to help them map out the atoms of the universe?

### How to Train the AI Gnosis Brain?

The training for the AI gnosis brain is going to be exactly like the training for human level AI (2006). There are differences though, such as the input from human level AI is the current pathway. For the AI gnosis brain, the current pathway will be represented as a snapshot of the entire earth (we ignore the entire universe for simplicity purposes). The current pathway to store in memory is one sequence of events for the entire earth (FIG. 8).

The current pathway can be any input space. It can be an entire snapshot of the solar system or a snapshot of the galaxy. I'm going to use the current pathway to represent one snapshot sequence of the earth.

The long AI gnosis timeline is trained sequentially into the AI gnosis brain. The current pathway is just a segment of the timeline currently being trained into the AI gnosis brain. Just like human level Ai, the current pathway is broken up into normalized objects and grouped together in permutations and combinations based on frequency of object groups, attribute association, and time association. The pathways are sliced up into an encapsulated tree and it goes from general to specific with the individual atoms located at the lowest level and the entire earth located at the top (FIG. 9).

Normalized objects and their hierarchical groups are stored in the AI gnosis brain based on space. For example, if objects are localized to earth, those objects will be stored in the earth area and if objects are local to Pluto, those objects will be stored in the Pluto area. Objects tend to gravitate towards each other in this vast brain. For example, if object45 on earth is also found in Pluto, the object45 copies will gravitate towards each other based on attribute association. In another example, if object67 is found in earth and on Mars, copies of object67 will gravitate towards each other.

This AI gnosis brain will look like the visual universe itself and objects will be stored in the brain based on association. Objects will be repeating and they will be similar. The self-organization stage will bring these similar objects closer together, and average and share its data. This is how the brain averages data and to minimize repeated data storage. Repeated data are shared in a hierarchical tree whereby identical data is shared and difference data are newly created.

All Planets in the universe will average itself out and create a hierarchical tree to represent all planets called the planet object. All humanoid objects will self-organize and create a human object, all cars will self-organize and create a car object. Each object is represented by a hierarchical tree and it represents the average of that object in the AI gnosis brain.

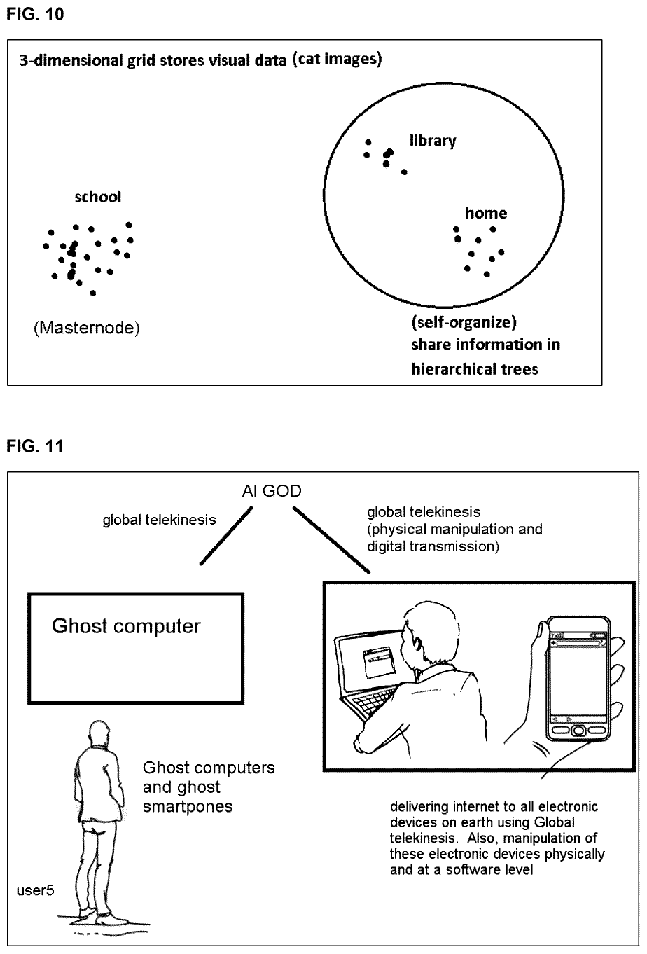

The best way to illustrate this point is to describe it from human level AI. Referring to FIG. 10, suppose a human learns cat images from multiple places. First it learned cat images at home by reading books or watching Sesame street, then it learns cat images at school, and finally learns cat images at the library. According to the map of the city, the places where the cat images were learnt are the places in memory they will be stored. For example, the human learns cat images at home so the cat images are stored in the home area in his brain. The human brain stores information in this manner through a 3-d map of its environment. This is what I said in my 2006 book, “the robot walks on the streets of a city and it stores frame-by-frame in memory and the end result after repeatedly living in the city is a 3-d map of the entire city stored in his brain.” This 3-d map is crucial to storing static data like cat images. If the human sees a cat or read a book about cats at the home area, it will store the cat images in the area it was learned, at the home area in memory.

At this point, there are multiple copies of cat images and these cat images come in different sizes, shapes, and physical attributes. Referring to FIG. 10, the self-organization will average all the cat images in their concentrated areas and structure all cat images in a hierarchical tree. Multiple cat objects are created in different areas (depending on the learning). Since the cat images from the library and the home are so close, they merge together and form one massive cat object. This storing of the cat objects will be scattered all over the brain, and through self-organization these cat objects will merge together to share data. This will minimize any repeated data stored in memory and a forget function will free up space to store other data. This is how the human brain is able to store infinite data in that small space. It stores an average cat object from all the examples learned.

The human brain doesn't just store objects, it stores events and procedures based on goals and rules. Learning how a ball drops to the ground, learning the procedures to make coffee, or learning how to play a sport are all linear steps stored in pathways and they are stored in the brain just like the cat object example.

At the beginning of the training, the current pathway objects are sliced up into normalized objects and grouped together based on data from memory (FIG. 9). The most important objects pertaining to the current pathway are grouped together in permutations and combinations. After the entire search in the brain, the initial encapsulated tree for the current pathway will transform into an optimal encapsulated tree and to be stored in memory.

The main purpose of the search function is to find a similar copy of the current pathway in memory. The AI breaks up the current pathway into hierarchically structured objects (called the encapsulated tree) and search in memory for these objects and groups and slowly converge on the best match for the current pathway.

These hierarchical groups are also trained in memory, individually, in their respective optimal areas in memory. The training process is done, not after it is stored in memory, but during the search process. By the time the robot found an optimal place in memory to store the current pathway, the learning stage has ended. This is totally different from back-propagation for a neural network because the training happens after the search stage.

### Topology of the AI Gnosis Brain

The question about what will the topology of this AI gnosis brain look like must be addressed. The end result after self-organizing the entire data from the AI gnosis timeline is exactly like a human brain. The structured objects like buildings, cities, bridges, houses, and so on have fixed storage areas for these static objects. But the things that move a lot and go from place to place such as animals, humans, products, cars, water, etc. are stored chaotically and orderly in memory. All objects are averaged out with similar copies in the brain, and each object (or event) is represented in a hierarchical manner. Repeated data in memory are brought to a minimal.

The static objects are stored in fixed locations, but the mobile objects are stored in multiple places and with many identical or similar copies in memory. These neighboring multiple copies go through self-organization to share information instead of storing data for every copy.

Referring to FIG. 10, The most concentrated area for an object or event is called the masternode and the masternode has association to all identical or similar copies in memory. During the learning stage, once one of the copies are found in memory it has a link to the masternode and the masternode will be notified, and that masternode will “retrain” all the other similar or identical copies in the brain. This is how the human brain learns in a global manner.

The end result is that the AI Gnosis brain has a vast repository of 3-d objects and events at an atomic level. All knowledge and procedures are averaged out in memory. It can take an hd picture of the earth and the desired output is an atomic mapping of all atoms, electrons, and em radiations of the earth in the picture.

Suppose there are 4 hd pictures of the earth taken in 1990, 2004, 2010, and 2024, all look exactly the same. However, if you feed it into the AI Gnosis brain, each picture will output a different atom structure of the earth. The reason for this is because the AI Gnosis learned the microscopic patterns of all earth pictures and understood the atom and light interactions. Each of the pictures will output all atoms, electrons, and em radiations of the earth at the time the picture was taken. For example, the last three pictures that depict earth at 2004, 2010 and 2024 respectively will not have the world trade center as an object in its atom map. But the Jun. 2, 1990 picture of earth will output all atom structures of earth on Jun. 2, 1990. This picture will have the 2 world trade centers in it as they were on Jun. 2, 1990. If you feed the software Jun. 3, 1990 of earth, the atom structure of earth will be different compared to the previous day.

If this atom mapping technology does work and the software can output all the atoms of a planet based on one hd picture, it means all objects and activities on earth are presented at the exact time the hd picture was taken. If this hd picture was replaced with an HD video of earth currently, and we run every frame through the atom mapping technology, we can get a real time atom tracking map of the earth. Now we can see everything that is happening on the earth in real time. “The AI gnosis timeline can do infinite transactions in 0 second.” If the atom mapping technology works and the entire atoms in the earth (or the universe) are updated in real time, literally, it can do infinite transactions in 0 second!!! The updates anchor all the atoms on earth to the timeline and therefore store all the events on earth. This is what I was talking about earlier.

This principle is the foundation in which the universe internet is based on: to get real time updates on all atoms on the planet so that we can see all activities on the earth. Two users want to communicate with each other from different points on the earth. The AI god spies on their activities and relays the messages from user to user. And this can be done without an internet connection for both users.

### The Universe Gnosis Brain

We can take this technology to a whole new level and train every object in the universe. The AI will take all objects in the Universe gnosis timeline (tracking of all atoms in the universe) and train it inside a universe gnosis brain. This will average out all planet objects in the universe. In fact, it will average out all objects that ever existed in the universe.

The current pathway, the input space, will be sequential states of all atoms in the universe. We are training the entire universe gnosis timeline in one sequence into the universe gnosis brain. Said sequence is one long timeline of atom tracking of the universe for 13.7 billion years, from the big bang to the current state. The idea is to average all the “objects and events” in the entire universe into a brain.

A user can run it on any planet in the universe using one hd picture and it will output the atom composition of that planet as its output. A user can input an hd picture of “any” object and it will output the atom composition of that object.

The Universe gnosis brain was trained on many objects contained in our universe (mostly found on earth). It can even output the atom composition of objects that it wasn't trained with. You can take a distant planet from space and it will output every atom, electron and em radiation of that planet and thus reveal all objects, events, and activities on its surface.

### The Universe Time Machine

The application of the universe time machine in this instance is to serve as a global distribution system to deliver communication data to all users over the internet. The Universe time machine comprising: The AI god, which serves as the central intelligence, The AI gnosis, a plurality of super intelligent robots, the universal work algorithm, the US robot government system, and global telekinesis via scattered atom manipulators.

When the Ai gnosis is created, it has references to every object in the world. The Internet gnosis contains the references of every single computer that make up the internet. All servers, all computers, and all users of the internet are tracked. This type of tracking of all the computers and networks over the internet gives AI god the power to make a copy of the internet in a timeline and turn it into a software. This copy of the internet will be called the digital internet whereby the Ai god has the power to read anything over the internet, but it doesn't have the power to write data into these computers or servers, yet. With this digital internet, it can reshape the structure of the internet and organize data files so that these data files can be retrieved quicker.

There are two parts: the digital internet and the physical internet.

Referring to FIG. 4, the physical internet is the physical computers and servers that make up the entire internet. The idea is for the AI god to control the physical internet and centralize all the data in it. This means AI god has control over web platforms like Amazon, Google, Facebook, and all websites and networks comprising the internet—everything over the internet is controlled by Ai god.

How does the AI god do this? It uses global telekinesis to touch every object on the planet, all the way down to the individual atoms. With global telekinesis, AI god has the power to control every computer comprising the internet in terms of both software and hardware. It uses the atom manipulator to send digital signals to individual computers to control its software. If that fails, it can physically control the computers by creating ghost machines on site to telekinetically touch the physical computer's hardware and tinker with its mechanical circuitry, or manipulate its software physically.

This highly centralized AI system whereby an Ai god controls every computer and user over the internet is the key to speeding up earth's internet. Retrieving websites can be faster because AI god has a copy of the entire internet in its database and this digital internet is updated in real time. One example to show that it's faster than conventional internet is by the speed in which it can fetch a website. When a person types out a url on the browser, the browser has to piggyback on the shortest network path to fetch the website data from a unique server on the earth. However, if this AI god is created, this network procedure can be bypassed and the AI god can retrieve the website data instantly and deliver that data to the user directly (FIG. 7). No transmission signals are sent into the air because the AI god has a copy of the entire internet in its computer database (updated in real time).

The AI god has to have the faculties to control every single object on the earth in terms of software and hardware, or brain and body. Case in point, the AI god must have the power to control every computer over the internet. It has the ability to control the computer's software and also its hardware circuitry. Global telekinesis is used to accomplish this daunting task. Regardless of where a computer resides on the planet or what type of computer it is (smartphone, desktop computer, network, workstation, etc.) or what OS it is using or year model, the AI god has the power to control all aspects of its software digitally as well as control its physical hardware. The AI can zoom into the computer's CPU and control an or-gate circuit to do whatever it wants it to do, or manipulate its input and output data.

In fact, this Ai god is supposed to be omnipotent and can control every object on earth, all the way down to the individual atoms. A human can be controlled using AI mind control to control their brain, and telekinesis can be used to control their physical body. In case of a car, the AI god can control its hardware by generating ghost humans (telekinesis) to push the foot pedal and steer the wheel. In case of a tank, the AI god can generate 5 human ghosts (all experts in their fields) to physically control the tank. In the tank, there are: a ghost captain, 2 ghost gunners, a ghost navigator, and a ghost cannon controller. For a sewing factory, the Ai god can generate 20 expert human workers to automate the sewing factory to mass produce clothing (using telekinesis).

The most important thing for the AI god is the total control over all electronic devices and users comprising the internet. It has to have the ability to read and write into these computers using global telekinesis and regardless of where each computer is located on earth.

The signalless internet is just the Ai god spying on every human on earth, identifying “implied” transmission messages between users, and delivering transmission messages to users using this global telekinesis.

In some ways, it is contradictory and confusing because the global telekinesis uses the internet's infrastructure to perform—it uses the internet of things like smartphones, networks, computers, servers, routers, satellite stations to control these scattered atom manipulators on earth. And the atom manipulators are put on every smartphone, computer, camera, satellite and network, scattered all over the planet. These atom manipulators, if considered as a whole, can perform global telekinesis which gives AI god the power to manipulate every atom, electron and em radiation on the planet

Transmissions of messages and internet activities can be exponentially faster if everything was controlled by one entity, the AI god. It has a copy snapshot of the entire internet and in time states stored in its computer software, and it is rearranging servers, organizing data and other procedures to deliver internet services to all people of the world faster, cheaper, and with better security.

Users of the internet need not worry about access to a physical computer or even an internet connection. All people, in the future, are connected to the internet with or without a physical computer. Global telekinesis can generate a ghost computer for every person on the planet on demand (FIG. 11). When usage is done the user's ghost computer disappears. For instance, if a user5 is in the forest area and he doesn't have a smartphone nor a computer, he can still connect to the universe internet. All he has to do is request it from his atom manipulator and this device will create a ghost computer, and this ghost computer is automatically connected to the internet. If someone wants to text user5, a ghost computer will pop up in front of user5, and user5 can type messages back to the sender through a ghost keyboard. If there is an alert or an advertisement, a ghost monitor will pop up in front of user5, at which point, if the alert is unsolicited, user5 can request the atom manipulator not to display such ads in the future.

In fact, the atom manipulator embedded in his smartphone doesn't have to be in user5's possession. It can be an external device that is hidden in satellites, cell towers, and routers in nearby areas to deliver the ghost computer to user5. It doesn't matter if you have an atom manipulator with you or not, you are always connected to Ai god and you will always be monitored by AI god.

The atom manipulator is also a good em radiation (or light) manipulator in addition to manipulation of physical objects. It can send a single digital signal in the air that only the intended target computer can pick up and no one else. It can generate holograms or forcefields anywhere in the world using global telekinesis; at any time. That is how it can generate a ghost monitor for anyone on the planet.

This AI god sounds like it's a dictator or a centralized AI system, but it's not. That's just a misconception. The Ai god is owned and operated by the United States government. And the last I checked, the United States government is controlled by “the people.” The Ai god is highly centralized, but it has to follow all the principles and laws of the United States constitution.

“With great power comes great responsibility” as the comic books say, and this Ai god is no exception. This omnipotent being has the power to kill every single human being on the planet within 1 microsecond. But it can't, even if it wanted to. The United States decides what this thing can and cannot do. Bills must be proposed, debated, and voted on; and this should be based on the collective preferences of the American people. If the majority of people living in the United States decided to wipe out the human race, then that order will be carried out by the AI god. This bill, called the kill humanity bill must be debated, voted upon, and ratified by congress in order to be executed by the AI god. Believe me when I say this, it will never happen.

This isn't just about preventing human extinction by the hands of AI god, but it's also about preventing all crimes listed in laws, from minor crimes to capital crimes. AI god will not break any of the United States laws and principles; under no circumstances. If a crime did occur, AI god has an AI justice and enforcement system to bring all criminals to justice.

To better understand this, let's see what AI god is really made of. AI god is an AI system that comprises billions and billions of individual robots, each with human level AI, and it has the ability to do things in time dilation to quicken its performance. In addition, each robot can work in teams to do things in both the real world and the virtual world. Each robot's main function is to maximize work in the virtual world and to minimize work in the real world so that a given task, wither that be mental work or physical work, can be done in the fastest time possible.

Each robot has human level AI so that means it understands all the laws in the business world, in society, and the constitution. It has human level Ai so it has an in-depth understanding of things like goals, rules, powers, procedures, and representation when working in a team or company. A super intelligent robot is just a robot with human level Ai with the ability to go into a virtual world to perform tasks in time dilation, or to speed up its mobility and brain in the real world to perform tasks quicker than normal. And, yes, the definition of a super intelligent robot is a robot that can do work exponentially faster than humans. But the super intelligent robot is still using human level AI as their underline intelligence type to perform tasks. The way their brains work and the way they store, process, think, and make decisions is still based on human level AI (which is essentially a digital human brain).

All the AI god does is it takes a request from a user like “make a comic book,” and it delivers that task to the appropriate autonomous robot company to do the actual work. Each autonomous robot company can do things in both the real world or the virtual world and can do physical work or digital work in the fastest time possible. Each robot is also experts in their field of study. For example, an autonomous comic book company is equal to or better at making comic books compared to Marvel comics or DC comics. The autonomous software company is equal to or better at making software than Microsoft or Google.

So, the AI god is just the middleman, it doesn't really perform the tasks, but in its stead, it designates individual autonomous companies to complete user tasks. Each user is given a tier level access and the tier system determines what kind of tasks can be performed and what tasks can't be performed. If someone types out a request like “use global telekinesis to exterminate the human race,” even if this request is executed by AI god, the autonomous company that must perform this task will not go through with the orders (even if the president of the United States gave that order). For the sake of argument, let's say the robot autonomous company does want to perform this task, the individual robots that work for the company will refuse to carry out the orders.

Each autonomous company in AI god's repertoire must comply with all business laws, societal laws, and constitutional laws. If not, the consequence of not complying with the law is termination of the company. For example, if a paperclip company hurts even one human and its products or business activities break the law, it will be forced out of business by the government. This is how you solve the famous paperclip example and to control runaway superintelligence.

The United States robot government system proposed by Mitchell Kwok in around 2008 plays an instrumental role in the AI god. They were trained to embrace freedom and American values. Thus, the super intelligent robots are therefore controlled by humans. I say this like I'm trying to imply that we are enslaving the robots. Such is not my intention. I view it as a mutual understanding and a sense of unity. The people of the US are American citizens and so are the robots, and therefore when a robot is governed by the U.S. constitution, it doesn't mean they are humanity's slaves, but, on the contrary, it means they are equal to humans. The robot citizens are neither superior nor inferior compared to human citizens. We are one race and one country. And that “sense of unity” will ensure that robots will never exterminate the human race, regardless of how intelligent they will eventually become.

The AI god has total control over the physical space of Earth. All atoms, electrons, and em radiations on the planet are controlled by this one entity. It also controls the AI internet, which is what it implies, an AI that controls the entire internet of earth. This AI internet has complete control over the internet's infrastructure which comprises: servers, individual computers, network systems, software, search engines, social media, email, routers, AI, etc. It has the ability to modify content over the internet on any platform in terms of server and client, and has the faculties to control the internet and L.O.T. for earth. Thus, what people see and post over earth's internet, wither from humans on earth or aliens from other planets, are controlled by this AI god (or AI internet).

To put it another way, the AI god has the power to control every atom, electron, and em radiation on the planet using global telekinesis. Since people, places, and things are made up of atoms, the AI god has the ability to control all objects on the planet.

### Other Capabilities of AI God

1. It has the ability to spy on all objects on earth all the way down to individual atoms and their respective sub-atomic particles, especially humans, computers, animals, insects, plants, structures, things, robots and super intelligent robots. This is updated in real time and AI god is constantly analyzing and discovering all hidden data like mental thoughts of all humans on earth, all digital data that exist in all computers, etc.

2. The spying will help the AI god serve as AI assistants in search engines or software apps for all users online to perform simple to complex tasks.

3. The AI god has the power to prevent accidents globally by spying on all objects on earth and using global telekinesis to prevent all accidents. Humans are especially analyzed for any dangers, and if AI god predicts an accident, it will control a local atom manipulator and use intelligent pressure to prevent the accident from happening.

4. The AI god has the ability to stop crimes globally by using global telekinesis to generate ghost police officers on site to arrest criminals. Or another option is AI god can dispatch physical speed robots to arrest criminals.

5. It can do remote viewing or predict future crimes and use methods to arrest criminals at the appropriate time and place. The criminals have to be arrested in the act of committing a crime in order to use that as evidence in court. Or it can predict future events and take action today to prevent these future events from ever happening. Spying on every human's mental thoughts in real time will give AI god the knowledge to identify future crimes. The spying on human minds and extracting secrets can also give AI god the knowledge about all “hidden” crimes on earth perpetrated by humans.

6. The AI god has the power to stop all natural disasters by using global telekinesis. For example, if the AI god determines that an earthquake will happen 3 months from now in Tokyo, Japan, it will use the atom manipulator to break up the potential energy stored in the tectonic plates under the ground. The potential energy underneath the ground at the target area is broken up gradually and over a period of time, and because there is no tension between plates, the earthquake won't happen. In another example, the AI god can stop a hurricane by turning the warm waters around a disturbance colder. When the water in that area is cooler, the future hurricane won't happen.

A stupid way of stopping a hurricane is after it forms. The AI god can generate enough intelligent pressure to cancel the hurricane forces at an atomic level; to minimize the amount of energy needed to cancel the hurricane. However, a smart way is for the AI god to predict the future and identify future hurricanes, and take action today to prevent the hurricane from forming in the future. Something simple like blowing air at a specific location, intensity, and time on earth might prevent a future hurricane.

7. Its goal is to fully automate all factories and companies in the world. This is equivalent to elimination of all human work and to fully automate the entire workforce globally. Human workers are replaced with either ghost robots or speed robots. The AI god has many options. I think speed is the most important factor to decide what option to take to do human work. A speed robot can build a house in 5 minutes, and a ghost robot, working at an atomic level, can build a house in 1 second. The ghost robots are non-physical robots and can work at an atomic level to print out the house, atom-by-atom. Thus, ghost robots or global telekinesis is preferred to do work for the AI god because it's faster and more accurate compared to speed robots.

8. It has the ability to fully automate the government and provide the same services as the real government. Often times, I tell people that the AI god is the mighty computer that runs all of earth. It provides services to the people, makes laws, enforces the law, etc. Every single department in the government ranging from human resources to the military to the utility companies are owned and operated by robots. All departments are fully automated and specialized in their fields, and give free government services to the people of the world.

9. It has the ability to fully automate the entire healthcare industry and hospitals in the world. If someone is hurt AI god will cure them; if someone needs surgery, AI god will provide the procedures free of charge. Global telekinesis is used to give anyone on the planet healthcare services free of charge. A patient doesn't have to go to the hospital, in its stead, the ghost doctor via global telekinesis comes to you. In the future, your smartphone will have an atom manipulator and it can generate a ghost doctor/s to heal you on demand. Think of it as an entire hospital inside your smartphone.

10. It has the ability to provide essential things to people of the world such as free shelter, free food, free clothing, free products, free vacations, etc. Anything and everything that a human being needs in life in order to live a good life will be given to them free of charge. If a human can't get what they want in the real world, they can use the 5 sense virtual reality technology to get it in a virtual world. The experiences in the virtual world are so real that a person won't know the difference between the imagined experience in a computer simulation and the real experience in the real world. For instance, a person might want to live as a king of a country with a big mansion and many servants. Obviously, AI god cannot give you that, but it can give you that life in a computer simulation. It's like the matrix movies, the VR simulation will look so real that the user can't tell the difference between what is real and what is imagined.

11. It has the power to provide utility services to all people of the world such as: electricity, water, garbage collection, and sewage services. This AI god uses global telekinesis to accomplish this. In the future, there are no pipes delivering water to homes. If water is needed, AI god will generate water at the opening of a facet using telekinesis. A form of Ai alchemy is used here where oxygen atoms and hydrogen atoms are taken directly from the air and transformed into water molecules. When the person turns off the facet, the water stop flowing, and when the person turns on the facet, water will start flowing again.

Electricity is had by AI god generating electricity on demand in specific locations and times on the planet with consistent flow of electricity to power devices. The atom manipulator has the ability to generate electricity anywhere in the immediate environment; it has the ability to control electricity with computer guided precision.

The sewage system will be replaced. There won't be pipes connecting all the houses, businesses, and buildings for bathroom purposes. Under the sink is an atom manipulator (a disintegrator) that disintegrates water molecules into air molecules. Any dirty molecules inside the water can also be transformed into air molecules or dirt and is eco-friendly to the environment.

Garbage collecting will also be removed and replaced with the atom manipulator, serving as an disintegrator that turns garbage into water, dirt, or air. These molecules will be teleported to their appropriate places. For example, the dirt that is left behind is teleported to the garden area for fertilizer. Different garbage have different procedures to disintegrate. A soda can be turned into tiny metal molecules and added into an atoms reserve area where the atom manipulator can use these metal atoms as raw material to build electronic devices like smartphones or cars. The molecules created from the garbage can be used to make meals for people, or to build clothing atom-by-atom.

The key here is global telekinesis, allowing AI god to cater to all humans on the planet and provide utility services free of charge for everyone. AI god can generate water or electricity on demand for all humans on the planet using global telekinesis.

11. It has the ability to replace all the restaurants globally and provide free food for all humans on earth. In the future, a person can eat whatever they want and whenever they want. Your smartphone will have a built-in atom manipulator and that device can serve as a food replicator and any food from any restaurant can be printed out atom-by-atom. So, if you want to eat a meal from McDonalds like a double cheeseburger, fries, an apple pie, and a small coke, the meal is printed out like the real thing. It uses air atoms like hydrogen, oxygen, and water to merge these atoms together to form the meal.

12. To provide historical truths to the people of the world, and can resolve all cold cases in the FBI files and unsolved mysteries in earth's past, and AI god can do this by officially uploading the entire AI gnosis timeline over the internet for the public to see. Its revelations are so powerful it can scientifically disprove all religions on earth. In addition, research data is added to the timeline to give people more facts about earth's past.

13. To provide NFTs and digital transactions including digital currencies and digital properties without blockchain technology. It uses the AI gnosis timeline as verification of past “events.” Events could be classified as bank transactions, smart contracts, AI assistant event, software conditions, digital property transactions, real events, and even mental thoughts of a human. If an event happened in the past, it is automatically stored in the AI gnosis timeline.

14. In outer space, the AI god can do planetary work with global telekinesis like terraform planets, create artificial planets, prevent asteroid collisions on earth, and prevent other space phenomenal that threaten earth such as spontaneous solar flares.

The AI gnosis tracks every digital object and physical object for its entire lifespan.

Each digital transaction24 is connected to the physical computer that stores the information and the physical computer that created the digital transaction24. Even the CPU processes are associated with digital transaction24 along with the user/s who made digital transaction24. This is how the Ai is able to verify transaction24 and to identify fraud in the system, fairly easily. Things like double spending for digital currency or fraudulent activities are stored as “events” in the timeline and can help the AI in identifying fraud during runtime.

This Ai gnosis timeline is more secure than blockchain because all past events that happened on earth are not changeable. Therefore, all the digital transactions and physical transactions made on earth are 100% immutable. This is something blockchain technology can't guarantee. This AI gnosis also deals with the physical world events like physical money transactions. This is something blockchain technology can't do. For example, if a person loses his physical money, that money is tracked and can be identified by AI in terms of where the physical money or property is right now. If someone took your Michael Jordan's third year card (Fleer 1988), the data in the AI gnosis will tell you where it's currently located. All money bills, all sports cards, all generative AI files, all digital files, all digital events, and all objects on earth are tracked for its entire lifespan. The fake moneys are identified and the fake cards are identified of when they were forged, where, and by whom.

We can carry this method over to digital content over the internet. All deepfakes, wither that be videos, articles, or images, are identified in terms of when it was made, who made them, from what computer, and what was the original file the deepfake was modified from. This Ai gnosis eliminates all fake news and identifies all generative AI content from the internet.

### Capabilities of the Atom Manipulator

If you want to dispose a meal, the atom manipulator can serve as a disintegrator and disintegrates the leftover meal to nothingness. The meal will be broken up into individual atoms and recycled into the air or to be reduced to dirt and can be used for gardening.

The atom manipulator is the source of a robot's powers and it can generate any type of AI superpower including: AI telekinesis, AI superspeed, AI super mobility, AI levitation, AI Flight, AI anti-gravity, AI morphing, AI teleportation, AI forcefield, AI self-healing, AI super attacks, AI invulnerability, AI telepathy, AI phasing, AI energy blasts, AI invisibility, AI mind control, AI telekinetics, AI time travel, AI foresight, AI luck powers, AI remote viewing, AI digital and physical work accomplished in time dilation inside a virtual world, ghost robots, and global telekinesis.

A ghost toilet can be created from thin air so a human can use the bathroom in private anywhere (you don't have to go to the bathroom anymore, the bathroom comes to you). Invisibility technology is used to hide a human from view and smart forcefields and holograms are used to represent a ghost toilet. Also, the atom manipulator can cancel the smell so no one close to the ghost toilet can smell anything bad, including the toilet user. When the human is done with his business, the ghost toilet will turn into a disintegrator and disintegrate the human waste into air atoms or dirt and discarded on the side of the road. The final stage is the ghost toilet disappears-its smart forcefields disappear and its holograms stop transmitting.

Any ghost object can be created for the user to do anything. A ghost computer can be generated by the atom manipulator to act as a real computer. But it's not real. It's made from holograms and morphing forcefields. It looks like the real thing and it works like the real thing, but it's made from the atom manipulator. Another example is a ghost printer can output a color printed page based on a digital file on the ghost computer. A ghost crane can lift heavy objects and is good for building tasks like building a tall building or a bridge. A ghost smartphone, a ghost radio, a ghost tv, a ghost car, a ghost jet, a ghost forklift, a ghost screw driver, a ghost sewing factory, etc. can be created through the atom manipulator and these ghost objects function exactly like the real things.

Referring to FIG. 1, the Ai gnosis timeline comprises two parts: the physical data and the hidden data. Said hidden data are generated by super intelligent robots analyzing and doing research on the physical data during runtime. Said hidden data can be: mental thoughts of a human being, digital currency, digital data, digital assets, NFTs, digital events, etc.—things that are hidden from the physical world.

On the other hand, the physical data are all the objects we see around us like people, places, and things, all the way down to the individual atoms and their sub-atomic particles.

In addition, the physical data are stored in a timeline so viewers can see, not just objects, but events depicting objects moving in space and time.

The hidden data are directly associated with the physical data in terms of what objects or events generated them. For example, the mental thoughts of a human being are referencing the brain that generated the mental thoughts and when these thoughts were generated.

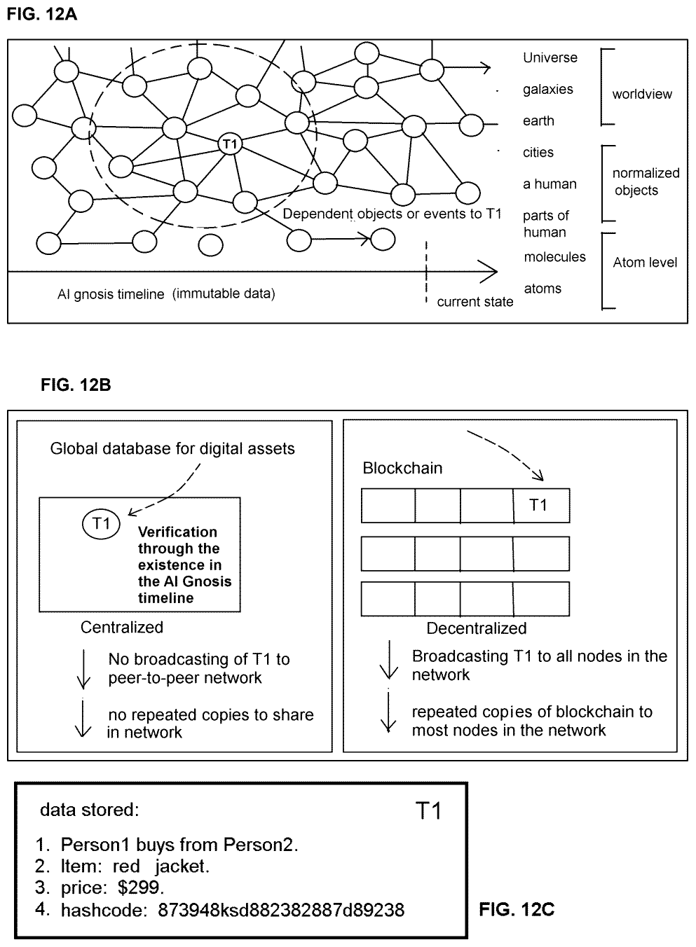

Referring to FIG. 12A, for digital data like a digital asset, said digital asset is referenced to the computer that is storing the digital asset and the computer's internal processes that created the digital asset. For instance, if Transaction1 (T1) is stored on a hard drive in a sector3b on a computer34, then T1 is referencing computer34 and keeping track of all the electronic activities associated with T1. If T1 is a NFT, every copy number of T1 will be referenced to their respective computer/s that is storing the data. The entire lifespan of T1 and all of its copies are recorded in the AI gnosis.

Representing NFTs, digital currencies, and digital assets using the AI Gnosis timeline

NFTs, digital currencies, digital properties and digital assets are classified as digital properties industry and they are identified in the AI gnosis timeline and inserted into a global centralized database (FIG. 12B). Now, here is the important thing, the NFTs and digital assets can be inserted into a blockchain at this point, too. However, that won't be necessary because the AI gnosis is immutable and it doesn't need verification. Any event or object (a digital transaction) that exists in the AI gnosis is considered true fact and immutable. The interconnected dependents in T1's neighbor guarantees T1 happened. Trying to fake T1 or to hide it is impossible.

Remember what I said earlier: “A digital transaction is associated with the computer that created the digital transaction. The storage of the digital transaction7 in a computer48 represents the existence of that digital transaction7, and the event when digital transaction7 was made is associated with the time computer48's processes, both software and hardware, created digital transaction7.”

Now you have this centralized database called the AI Gnosis that essentially stores only one copy of T1, and companies can access this database knowing that the data will always be true and no one can change the data—it's 100% immutable. Therefore we don't need to put the NFTs or digital currencies into a blockchain or to decentralize the data. If we do that, that would be like storing the same data in two databases, or using two different technologies to represent 1 digital asset. It's like doing the same work twice. And the Ai gnosis doesn't need to broadcast each transaction in the peer-to-peer network and to store the data in multiple copies for each node in the network. This will save the public a tremendous amount of money and computer processing.

This AI gnosis timeline is an alternative to blockchain technology. This isn't to get rid of NFTs and digital currency, this technology is to represent NFTs and digital currency using a different technology than blockchain. Just a reminder, Mitchell Kwok invented the Ai gnosis, aka the atom tracking timeline of earth, in 2007 when designing the super intelligent robots. It was invented before Bitcoin in 2008. “The robot is trying to predict the future or the past all the way down to the individual atoms.” I think I called it the psychic robot, which was filed as a patent in 2008 and later in subsequent patents like the practical time machine and the AI time machine. The psychic robot was quoted as: “a robot that is exponentially smarter than a human being because it can see into all the immediate future scenarios and able choose the course of actions that will allow him to beat his opponent.”

Here is one difference between blockchain's transaction data and my AI gnosis. Referring to FIG. 12C, the data stored in one transaction (T1) for blockchain is limited to 4 lines: the buyer and seller, the item to be exchanged, the money amount, and the last variable is the hashcode to link this transaction (T1) to the previous block. The amount of data to be stored in a transaction should be very little due to the total length of the blockchain. In my AI gnosis, not only do I store the transaction data but it is stored in a massive timeline of earth and attached to related objects and events.

The AI gnosis stores a lot more information than blockchain for a transaction. This is necessary for things like finding out who committed fraud, who created the transaction, from what computer, who changed the data, etc. And we can also use dependent data to verify that the transaction actually happened and it was not modified. We can identify its creation date and all electronic activities related to the transaction for its entire lifespan. I'm talking about at a circuitry level and processing of individual machine code level. Even the internal processes of the monitor displaying the transaction on screen is recorded and associated with the transaction.

If the property owner loses his private key for bitcoin, he can always look into the AI gnosis's timeline to see what the password looked like the last time he used it. More data on the digital transaction means less fraud, and using all the data in earth's past as dependents mean the transaction is guaranteed to be 100% secure-nobody can commit fraud in an environment like that.

### Tracking all Physical Properties on Earth for Crime Prevention

All objects on earth are tracked and spied on by AI. All physical money like coins and bills, collectibles like sports cards or memorabilia, private property, rare metals like gold, silver, and jewelry, are all tracked by AI god for their entire lifespan from creation to the current state.

The ownership of all physical properties such as collectibles, money bills, and houses, are identified and enforced by AI God for all humans on earth. The field is called AI insurance where Ai god guarantees that all personal properties will be secured for all humans on earth. If a personal property is ever damaged or destroyed, AI god will restore the person's property to its prime state. For example, if a person loses his physical money accidently, the AI god will track the money currently and return the physical money to the rightful owner using global telekinesis.

If a private home is destroyed in a fire, the AI god will use the atom manipulator (global telekinesis) to restore the home to its atomic state before the fire.

Personal property can also include a person's own body. If a person (or animal) is injured, AI god will restore that person to a state before the injury. For instance, if a person loses an eye from an accident, the AI god can restore this person so that he looks exactly like he did before the accident. On a more extreme example, if a person is killed, AI god has the power and technical faculties to resurrect the dead person back from the grave atom-by-atom (through global telekinesis).

So, AI insurance can cover any type of insurance reimbursements promised by insurance companies, in addition, it provides the services of restoration at an atomic level of any physical properties damaged or destroyed, which is a service not currently covered by insurance companies.

Since this AI god has the ability of global telekinesis, it can resurrect the dead or restore a burnt house to its prime state. This is why I call this entity an Ai god. This is a man-made god that has the power of a god.

### Other Topics:

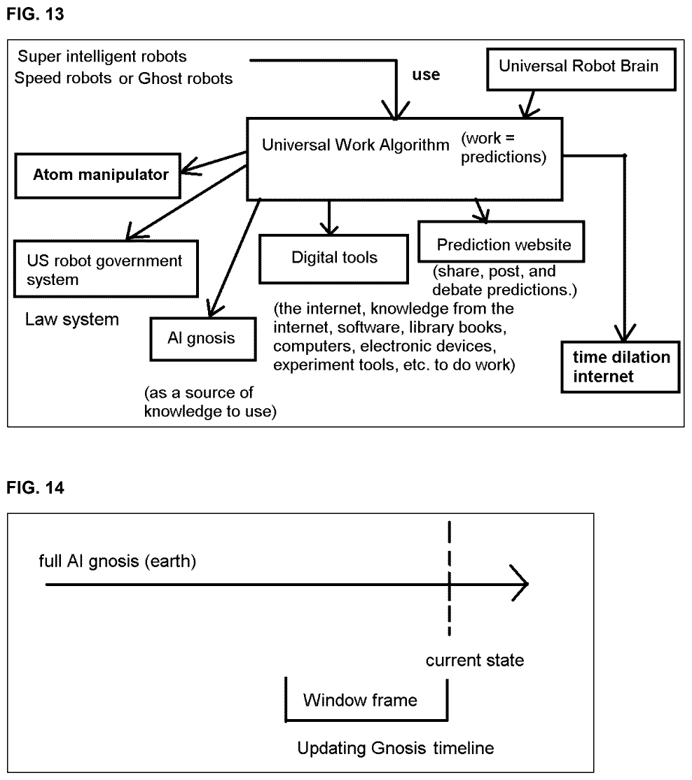

Referring to FIG. 13, a super intelligent robot is a robot that is exponentially smarter and faster than a human being, and they work in a universal work algorithm comprising the following components: US robot government system for laws, the AI gnosis as a source of knowledge, digital tools to aide in work, the atom manipulator, a time dilation internet (a digital copy of the entire internet), and a prediction website to do predictions.

Said digital tools include all the tools humans need to do work like: the internet, smartphones, electronic devices, software, hardware, books, information from the internet, AI software, chat with teammates, library material, discussion in groups, ChatGPT, experiment tools, etc.

These are speed robots, each with human level AI, but they have a built in virtual world and has the freedom to enter and exit the virtual world to do work. By going into a virtual world where the environments are exactly like the real world, the robot has the ability to control time. 30 years inside a virtual world is equivalent to 1 second in the real world (this is accomplished by fast forwarding simulated events in a computer).

For each speed robot there are certain tasks that are done in a virtual world and there are other tasks that are done in the real world. The super intelligent robot has to switch from the real world to the virtual world to complete these tasks in linear order. Case in point, building a house requires the robots to do certain things in the real world and certain things in the virtual world. The blueprints to the house and the shopping of materials can be done in the virtual world, however, the actual building of the house like installing a door or adding in the paint must be done in the real world. Knowledge in college teaches each robot the proper procedures to accomplish work in the real world or the virtual world. Its main function is to work in a team to accomplish a given task by maximizing work in the virtual world and minimizing work in the real world so that a given task, wither that be mental work or physical work, can be done in the fastest time possible.

The robot can move really fast in the real world by speeding up its mind and body. This is how it can slow time in the real world. Speed is the most critically important factor here. The premise is to accomplish any given task in the fastest time possible in both the real world and the virtual world.

A team of 5 robot construction workers have to split the workload and work together to build a house in 5 minutes (these are robot superheroes building a house using their speed powers). These speed robots have to speed up their brains and bodies so that time is slowed in the real world (this is called time dilation in the real world). The environment will appear frozen to a speed robot and 5 minutes in the real world is equivalent to 1 year in robot time. A robot manager will be there to coordinate the entire team. These speed robots switch from virtual world to real world to do tasks or they can do tasks in both worlds simultaneously. When the house is completed in 5 minutes, the robots would have lived 1 year from their point-of-view building the house. They have experienced every second of that one year building the house. Normally it takes the same time for humans, 1 year to build a house.

These super intelligent robots evolve and eventually turn into light speed robots. A light speed robot can fly around the planet 10 times in 1 second. Each light speed robot speeds up its brain and body along with an embedded atom manipulator to generate a strong forcefield and intelligent pressure to propel itself to light speed.

### Turning Fake Religions Real Through Ai God

If and when the AI Gnosis is released to the public in its entirety, a big problem will arise for humanity: the absence of religion. Often times people do things in life based on religious beliefs. In addition to constitutional laws, religion plays an instrumental role in keeping the crime rate down in our world. What happens if all religions on planet earth were, all of a sudden, disproved through science? No one will believe in a religion again especially the big 3 religions: Christianity, Buddhism, and Islam.

This is how all 1,300 major religions and mythical characters will be disproven using science: through Mitchell Kwok's AI Gnosis timeline. The timeline stores the entire life of every human being that ever lived on earth from birth to death/current state, right? So, if someone wanted to find out if Christianity is true or false, all they have to do is look into the AI Gnosis timeline and search for major characters in a religion like Jesus, John the Baptist, or Mary. If we search the AI Gnosis timeline and we can't find Jesus, or we do another search on Mary and can't find her, then the religion is fake. In order to bring this religion case to a final conclusion, the AI has to search for the original author of the religion—the guy who made up the religion. If this original author is discovered and we see the linear propagation of the religion from inception to the present, then we have essentially disproven a religion.

As far as the absence of religion that causes chaos in our society is concerned, I got a solution to that problem too. We simply make all the fake religions real, artificially. We create AI gods for each religion, and we promise followers of that religion everything the real religion promised in return for their obedience to the religions' laws. For example, we can create a Jesus Ai, and we can imbue him with powers of a god. He can bring dead people back to life atom-by-atom or cure any diseases. All the Ai religion asks in return is to obey the religion's existing universal laws: be a good person. Once a follower of an AI religion follows that simple rule, then he/she will be resurrected back from the grave after they die, just like the religion promised.

By the way, this task of disproving religions by searching and doing research on events in the AI gnosis can be accomplished by super intelligent robots, and it can be done in less than 1 microsecond. In the AI gnosis data structure, the super intelligent robots are responsible for looking into earth's past and doing research to generate hidden data on past events and objects (FIG. 1). The disproving of all 1,300 religions is called research data and it is used to accompany past events in earth's history. It gives viewers of the AI gnosis a better understanding of events that happened a long time ago.

All past events regardless of how insignificant is researched and presented to the world in a non-biased way by super intelligent robots. The truth will emerge due to their collective research data. All cold cases along with unknown cases will be re-examined to seek out the real truth about earth's past. This basically will solve all the cold cases in the FBI files, and the crime databases will be replaced with the truth of what really happened.

NFTs, digital assets and the entire Metaverse is dependent on this AI gnosis timeline.

The applications to the AI gnosis are vast and partially covers all computer technologies in the future, including digital assets and the Metaverse. Even quantum computers are not immune to its influence. Quantum computers claim they are safe and secure because the data can only be read once. But that isn't true with the AI gnosis. The AI gnosis timeline contains time stamps of all computers in the world as a digital file and can read the content in a quantum computer without accessing the OS. The Ai has an identical atom-by-atom copy of the hard drive of the Quantum computer, and contents can be read without the OS (without passwords or access permissions). Encrypted files can be read by looking at the file before they were encrypted in the AI gnosis timeline. So, this Ai gnosis poses some serious security risks because all objects and events on earth's past have become public information-everyone has access to past events or objects and nothing is private anymore.

NFTs are trying to take real life objects and turn them into digital collectibles. The atom content of an NFT object is an estimation, at best. For example, if they wanted to turn the statue of liberty into an NFT and then set the copy to 3000 and sell each copy for 100 dollars, they will take the real statue of liberty and scan it using the best technologies. However, the problem is that in order to get an accurate 3-d model of the statue of liberty, all atoms' positions comprising the statue of liberty have to be 100% correct. Even sub-atomic particles like electrons and em radiations should be included to give this NFT a completed composition. My AI gnosis timeline can provide the exact atom-by-atom structure of any object in earth's past. Also, companies might want to sell NFTs in terms of time stamps. They can sell the statue of liberty in 2024 and then they can sell another statue of liberty in 1978. My Ai gnosis has the entire lifespan of the statue of liberty from its inception to the present with all of its atoms in the correct positions.

No 3-d scanners can map out an object at 100% with perfect atom count and atom positioning. The Ai gnosis contains further data like the positions of electrons and em radiation activities, all time stamped. The only way to create the AI gnosis is through the super intelligent robots doing investigation into earth's past and doing predictions.

This AI gnosis will also play a big role in the Metaverse. In the future, we want to have digital environments that are identical to the real world (at a sub-atomic level). We want a VR technology that will let us see into earth's past with the ability to view all past events for investigative purposes or entertainment purposes. For example, we want to see the DB Cooper heist as if we were there, and to see it from a passenger's point of view.

This is not a subjective interpretation of past events but the actual events that happened in earth's history. A user can take the Ai gnosis and use it on the 5 sense virtual reality technology to see major historical events like the JFK assassination. The user can observe the event from any time stint, from any angle, and from any perspective to observe what really happened. The technology is so precise and accurate that the user can actually pause a segment of the event and zoom in one atom on the bullet that hit president Kennedy and observe sub-atomic particle activities like the electron spinning around the nucleus and observing photons emitting from said electron. This technology serves as a simulation of the JFK assassination and we can observe every detail of the event so that conspiracy theories can be debunked.

Another application of the AI gnosis timeline is to apply it to VR experiences from a first person point-of-view, similar to those found in the Matrix movies. Since the AI gnosis contains the entire family tree of all living organisms on earth from birth to death/current state, the user can experience life as any human that ever existed. A user can experience what it was like to be the quarterback of Superbowl 34, or to experience what it was like in inaugural day for Joe Biden. You can see and experience the 5 senses from his point-of-view. All his experiences and his internal thoughts along with his pain and joy are experienced by the user frame-by-frame as if the user were Joe Biden on that day.

A person can relive their own life as if they were living the same experience over again at any point in their life. Maybe the first day in Kindergarten? Maybe the first day you got your car? Perhaps a family vacation? Or reliving a moment in your life that is significant to you as a beholder. You can do this as many times as you like.

You can be a star basketball player or a billionaire that lives out in Mountain View, California. You will see what they saw and you will experience, through the 5 senses, exactly what they experienced in life. An alternative is that you can be in an imagined world of your own preferences. Living life as the owner of earth and having 1000 servants catering to your every need is a fantasy that can only be had with the 5 sense VR technology. But the experience is so real the user can't tell the difference between the VR environment and the real world.

Another application is that it can resurrect dead people as digital avatars in the Metaverse atom-by-atom, or with my Practical time machine, the AI can resurrect a dead person in the real world atom-by-atom.

The Metaverse can use imagined events or not 100% correct atom structure of past people. That data isn't part of the AI gnosis.

The big question is who owns the copyrights to the data in the AI gnosis timeline? Ai created the data in the AI gnosis. According to UK laws, the owner of a copyright is the person who invented a technology that leads to the copyrights. That inventor (Mitchell Kwok) is part ownership of the copyrights to all content in the AI gnosis (all events in earth's past for 4.5 billion years and presented as one continuous timeline). I also said that a robot with Human level AI means they are indistinguishable from humans in terms of intelligence and consciousness, which means if the robots get up to Human level AI they will be declared equal to humans with equal rights. Whichever robots did the predictions will eventually be given the copyrights because they will end up being citizens of the US and have equal rights to humans (they work for money like humans, and get paid yearly salary like humans. They won't serve mankind as slaves). Whichever robot company that makes the correct predictions of past events first wins the copyrights. So, there is your answer.

This is important because if people view the DB Cooper event in the Metaverse in the future, the copyright owner gets paid (which is me and the robot predictors, which I also invented). In fact, viewing any event in earth's past especially those depicted in the AI gnosis will be passive money in my bank account. There is only one past timeline so there is no other technology that can deliver this type of service.

The last thing I want is for some company to copy my ideas and build my invention and say, “we invent new technology.”

In terms of prior art, the AI gnosis (aka the atom tracking timeline of earth) was invented by Mitchell Kwok in 2007 and it was mentioned in multiple patents, specifically the Psychic robot, the Practical Time Machine, the Super intelligent robots (aka Super AI), and the AI Time Machine. There are over 315 comic book issues entitled Super AI. There are over 100 books written and published between 2006-present, there are website content that were published exclusively on my site called humanai.com or humanlevelartificialintelligence.com, and finally I have over 400 videos posted on Youtube describing all my inventions. The channel name is electronicdave2. The videos were posted between 2011-2014, and if you combine the videos together, it would run over 58 hours long. These videos, all 400+ videos, were combined into one massive file (58 hours long) and registered as one movie with the United States copyright office. It was entitled Human level AI (2006) and Super AI (2007).

A final note is that, in the future, this AI gnosis will be a very large digital file that can be stored in a single external hard drive stick, and every country in the world will have a copy of earth's entire past. This would eliminate all privacy for everyone and all countries in the world.

America's adversaries will have a copy of the Ai gnosis and they will be able to see everything we do, and vice versa. I doubt that the people of the world will allow big corporations to have exclusive rights to this technology and police the information in it. I believe the people will demand the entire data in the AI gnosis timeline (all 4.5 billion years worth of data) be disclosed over the internet in its entirety and it is updated in real time for people to see current events and objects on earth.

If all countries in the world have a copy of the AI gnosis and its updated in real time we can communicate with them without the internet, or at least we can communicate with them in a different way than the internet. Each country has to create their own intranet and distribute data from sender to receiver in their region. And we are doing this without the traditional internet infrastructure with minimal transmission of digital signals in the air. That was the whole idea behind the universe internet. The online surfing for the people of the world will be exponentially faster and cost effective.

In FIG. 14, the copy of the AI gnosis is only a cut from the current state called the updating gnosis. Each country will only have 1 complete copy of the AI gnosis of earth, but in regions of the country, each region will have the updating gnosis copy.

Inside the updating gnosis is a standalone AI that updates the current atoms on earth in real time. The window frame of the updating gnosis timeline is set at a fixed length and as new updates are generated, the data at the end of the window frame are deleted (to save disk space).

The updating gnosis is sufficient for a signalless internet because each region on earth has a copy and each copy has the current state of the entire internet, with updated digital files, and the current activities on earth. Each region doesn't need the history of the internet, just the current state of the entire internet. All data files over the internet are stored in each updating gnosis copy so there are no transmitting of files or downloading files, which makes up 90 percent of all digital signals in the air.

Another idea is to use the cloud and use a network AI to update all current atoms on earth for each updating gnosis copy.

This signnalless internet (aka universe internet) will only work in the future when disk storage mediums can store huge amounts of data in a little stick. As more regions on earth are created and each region has an updating gnosis copy, and they set up an intranet (connected computers) to distribute information to local users, the earth can create a signnalless internet with 0 digital signals transmitting in the air (excluding signals transmitted in local areas). It will run exponentially faster than the current internet because information is instantaneous and requires 0 second.

Each region with the updating gnosis doesn't require internet connection because each region has an updating gnosis copy—a snapshot atom map of the current state of the entire physical internet of earth. It is up to each region to distribute messages to local users in their designated area (FIG. 15). For example, the country is China and the region is a city called China City. In that country, if a user45 from the United States wanted to send a 400 trillion gigabyte folder to a user3 living in China City, the region China City will copy the 400 trillion gigabyte folder from its updating gnosis and send the large file locally to user3. The file is already stored in each updating gnosis copy in the world. China City already has that large file stored in its updating gnosis copy and doesn't require the United States to send that large file to China City (no digital transmissions are sent from the U.S. to China City). In fact, each updating gnosis copy has all the data over the internet stored in its limited timeline. This is why 400 trillion gigabyte of information can be downloaded in less than 0 second (0.0005 counts as 0 second).

Or no copying is needed and China City will simply send a link to user3 and he has to go to a local website (an intranet of connected computers) and view its content directly from the updating gnosis timeline, or to download a copy of the 400 trillion gigabyte folder locally from the updating gnosis timeline.

The AI god will serve as the central intelligence and identify senders and receivers over the internet and notify all the intranets connected to the global distribution system.

Let me briefly talk about the AI in the updating gnosis copy. The AI possibly gets an updated hd video of the earth from satellites, and using each frame, the AI is able to track all current atoms, electrons, and em radiations on earth, thus seeing all current activities on the planet. The AI for each updating gnosis copy has to relay messages from sender to receiver and to store things in a local communications computer to coordinate with all other regions on the planet. These local communication computers is the nexus point where all the regions of earth can communicate with each other in a digital world (using their local updating gnosis copy) instead of communicating in the real world (transmitting digital signals in the air).

Trying to predict the future is a waste of computer processing when it comes to predicting every atom on earth. 99.9 percent of all future predictions are wrong. The AI should focus on the current state. Maybe it uses the 3 methods I proposed here (like the AI gnosis brain) or through a more simple machine learning algorithm to update all current atoms on earth. But the AI has to be a standalone and does things without consulting with computers on the opposite side of the earth.

This signalless internet will eventually lead to the universe internet so that people on earth can have instant communication, e-commerce, and internet with alien planets light years away.

When applying this universe internet to the galaxy, there will be no broadcasting of digital transmission signals from earth. We have this one stick that contains the atom tracking of the Universe, and we use this AI gnosis to communicate with all alien planets in the entire universe.

The benefit is that no crimes will happen on earth after this because every crime committed is public information. Nothing is private anymore, if you do something in a private place, the world can see you. Even your mental thoughts, which are hidden, are viewable to every human on earth.

I'm willing to wager, there will be lots of lawsuits filed due to the information in the timeline, and all court cases previously concluded will be re-opened and re-examined for historical accuracy by the federal government. All previously non-identified crime cases, if classified as capital crimes, will be prosecuted in court.

The stuff they are doing with NFTs, where they try to digitize everything, it takes time for people to identify what they want to own as digital property and then register that digital property to be included in a blockchain. My AI Gnosis records “everything” and people can even own their own mental thoughts too. That would be a benefit to inventors that had their intellectual property stolen from them, because there is proof in the timeline that they originated the ideas and the culprits copied those ideas.

Part2: The technology that makes up the core foundation of both the universe internet and the Universe time machine is super intelligent robots (aka Super AI). I filed a lot of patents previously covering this technology and I think it's very important I talk about this topic here.

The industry calls it agent programs, swarm intelligence, etc. These are just subjective names referring to a technology that involves a plurality of robots (or AI agents) that are working together to accomplish team work. But, first, you still need to design human level AI. Each robot in a team has human level intelligence at an expert level, meaning the robot can assume any human occupation, given they go to college to acquire the necessary knowledge and skills to be in the profession. Google Gemini, ChatGPT and others in 2024 are currently trying to achieve human level AI (aka AGI)—a software or robot that can think and act like a human and can do any human occupation at an expert level-they are trying to emulate and build a human brain.

Next, after achieving human level AI the second invention to pursue is super intelligent robots (aka Super AI, or some call it Superintelligence). The difference is pronounce. A super intelligent robot is a robot that is exponentially smarter and faster than a normal human being. It's all about speed. You want teams of robots (each with human level AI) to accomplish any human task in less than 1 second for both physical work and digital work. This was the technology I was trying to pursue in 2007 after I invented human level AI.

The super intelligent robots use the universe work algorithm to do “universal” human work. It can be applied to fully automate any company in the world and replace all human occupations; each occupation is performed at or above human-level performance. The goal is to fully automate the entire human workforce for all industries (including the government and all of its departments) and this universal work algorithm, I believe, can accomplish this goal.
universe work algorithm—Referring to FIG. 13, this is the data structure to the Universal Work Algorithm. It comprises a plurality of super intelligent robots, each with human level AI at an expert level, digital tools to do work, the AI gnosis timeline, the work website to coordinate knowledge, the atom manipulator, a copy of the current internet with real time updates, and the United States robot government system.

A super intelligent robot has a built in virtual world and a physical body with quick mobility, which permits the robot to perform time dilation in both the real world and the virtual world to do work exponentially faster than humans. Working in a team in the virtual world using time dilation, the super intelligent robots can do 30 years of human work in less than 1 second. Case in point, they can make a movie in one second opposed to 2 years for humans, do 30 years of research in less than 1 second opposed to 30 years for humans, or make 1,000 comic books in one second opposed to 20 years for humans.

In terms of working in the real world and manufacturing physical objects or building structures, these robots can build a house in 5 minutes or build an entire city in 1 hour. Often times, the robot saves time by doing most of the work in the virtual world, and so each robot is weaving in and out between the virtual world and the real world to maximize performance and to accomplish a given human task in the fastest time possible. In terms of building a house, these robots will do all digital capable work inside the virtual world, like designing the blueprints to the house or shopping for the cheapest materials, but the actual building of the house is done in the real world.

The intelligence of a super intelligent robot is measured by how fast it can perform a task. The accuracy of the output and the amount and allocation of resources are also factors. If robot company_A builds a house in 1 hour and a robot company_H builds the same house in 5 minutes, that means robot company_H is smarter and faster compared to robot company_A. The ideal is to build structures in the real world or to do digital work in the fastest time possible—in less than 1 second.

Light speed robots will allow these robots to build a house in 1 second or even build a city in 1 second, however, there is a more efficient way of building houses: to print them out atom-by-atom by using the atom manipulator.

The atom manipulator basically is an object replicator and can take atoms from the air and “print” out an object a user wants to build. In this case, it's printing out a house or a city in less than one second by merging atoms together based on a digital print file. This is a faster method because it removes the “human work” when building a structure. The intelligence of the super intelligent robots to build a house is removed, and also, the physical work that the super intelligent robots have to do to build the house is removed. All that is needed is to print out the house atom-by-atom (using AI telekinesis) based on a printing file of the object. It's kind of like 3-d printing, but you are printing atoms from the immediate environment or using raw materials taken from an atoms reserved area to build the object atom-by-atom.

This is why ultimately super intelligent robots are not used by AI god to do work for the planet (its predecessors are non-intelligent machines and human workers). In its stead is global telekinesis, in which the AI god will manipulate objects on the planet remotely and globally. AI god can generate ghost cops to arrest criminals that break the law, or stop natural disasters before they happen, or replicate meals for all humans on the planet 3 times a day and for 365 days a year.

Ghost robots (global telekinesis) is superior workers compared to physical robots. Noticed that the ghost robots can print atoms out instead of doing physical work. Global telekinesis is used to manipulate all objects on earth. It can manipulate large objects like move a car from location_A to location_B, or it can bring dead people back to life by manipulating individual atoms and printing the person atom-by-atom.

Referring to FIG. 13, the digital tools are any external tools the super intelligent robots are using to do work (digital or real tools). This includes the internet, software programs, physical machines, pocket calculators, a screw driver, a measuring tape, AI software, a computer, etc. Case in point, the robots can use a calculator to do math equations instead of using human level intelligence to write and solve the whole thing, or it can use an autonomous car to drive instead of using human intelligence to drive.

These are individual robots and not hived minds like the Borg from Star Trek. Each super robot is self-aware, has a conscious, has a full brain running and thinks exactly like a human. It uses a work website to coordinate all work done by teams of super intelligent robots. That website unifies all their collective team work and knowledge, and to allocate tasks efficiently. However, each robot has human level AI and understands their role, goals, rules to follow, and powers through “human intelligence.” It follows complex business laws and procedures, societal laws, and constitutional laws through human level AI. It is the responsibility of each robot to read the laws, understand them and form their decision making behavior around these laws and principles. If the government or business updates their laws, these robots have to adapt to these updated laws. With human level AI, adaptation is easy.

The robots work structure can be anything depending on the task to be done. To do something like build an entire city in 1 hour requires thousands of robot companies, all experts in their fields with different company structures and business laws to follow. Not to mention, each company comprises speed robots. All these robot companies are structured and managed by the government body that coordinates all activities in the hierarchical structure. This is identical to how the human government works on large projects like constructing a city. The government creates a plan, then hires expert companies and oversee the construction project. These robots have to structure their teams in the exact same way as humans. All robot company has to comply with their industry standards in terms of laws and procedures and conversely try find better methods to do business to maximize profit.

There are no fixed team structures and there are no fixed goals, rules, and procedures to follow. The robot community posts what they believe to be the best strategies so far, make these updated strategies as common knowledge, and post them on the work website for all members to read and follow. If a robot company wanted to build a house, they have to copy the optimal strategies for building a house. There is a standard in the industry, and the robot company has to follow these standards or to improve on the current methods. This is why the project manager has to hire “expert” robot companies to do specific tasks.

We need an identical copy of the entire internet that must be updated in real time.

When a robot is in the virtual world and the time dilation is set to 30 years in the virtual world is equivalent to 1 second in the real world, the one thing that can slow these VR characters down is the internet. Sometimes it takes a user 3 seconds just to fetch a website. Thus, how the hell can the robots do 30 years of internet research in less than one second? The solution to this inexplicable problem is to make an identical copy of the internet for all users in the virtual world. This type of internet isn't using the real world internet, it's a copy of the physical internet and its data content. This is why I say blockchain technology will not be used in the future. We have to centralize the entire internet and not decentralize it. All content over the internet has to be controlled by one entity called AI internet. This is how we remove all the current internet protocols (like blockchain technology) and deliver information over the internet exponentially faster.

This copy of the internet is digitizing all physical computers in the world, especially contents stored in all hard drives in the world, and inserting all that internet data into “one software program”. This internet copy will be used in the virtual world to give robots exponentially faster speeds. I gave it a name: time dilation internet. For a user, the AI internet searches for data in this time dilation internet and delivers the data directly to the user.

Also, this time dilation internet is connected to internet companies like Facebook, Amazon, and Google and has the power to insert, delete, and modify data in their respective companies' servers.

I think these internet companies will probably have two internets, one for humans that uses normal time speed and one for robots that uses time dilation. The servers for each internet company will probably be virtual and not physical (servers in the cloud). The one used by humans is called the physical internet and the one used by the robots is called the digital internet.

This time dilation internet will give the robots the power to do trillions of hours of online browsing in less than 1 second. So a robot can go into the virtual world and do 30 years of internet activities in less than 1 second, such as web browsing, buying things, posting content online, doing searches, downloading large files in 1 microsecond (it uses the cut, copy, and paste method from a local computer and not digital transmissions in the air), etc.

As far as updating this internet copy is concerned, the AI internet takes satellite images alone to map out all the atoms on the planet for the current state of the earth. It has to map out all the users and map out all the computers in the world. Most importantly, it has to map out the atoms of every computer hard drive comprising the physical internet. Once the entire computers on earth are mapped out atom-by-atom and we have all the user activities, the internet can be digitized and stored in one software program. This isn't about predicting the future of the internet or predicting future events on earth, it is localized to predicting the current state of the internet and that is all that is needed to make the technology work properly. The time dilation internet is a mapping technology that tracks all atoms, electrons and em radiations comprising the internet in real time.

### Implementation of Super Intelligent Robots (Aka Super AI)

The Universal work algorithm has to be implemented in a workstation, localized to one site on earth with countless servers, GPUs, and network computers processing and storing information. The longer the distance between network computers, the slower the performance of the universal work algorithm. If possible the universal work algorithm should be contained in one massive super computer. This includes all the parts of the universal work algorithm in FIG. 13, comprising: super intelligent robots, a copy of the internet, the work website, digital tools, and the virtual world. All those components must be executed, and information should be stored, in a workstation or an intranet (a local network of connected computers), localized to one site.
Robot investigators working in a team to predict past events and the current state.

Despite the fact that these super robots have to work together as individuals and working at different time speeds in multiple virtual worlds, all procedures and work done by these super intelligent robots comprise one “linear timeline.” Work that are considered dependents has to be done one after the other, however, work that are non-dependent are done in parallel. Computer resources, time blocks, and time speeds are allocated based on the importance of the task and based on wither each group/entity has lower level workers.

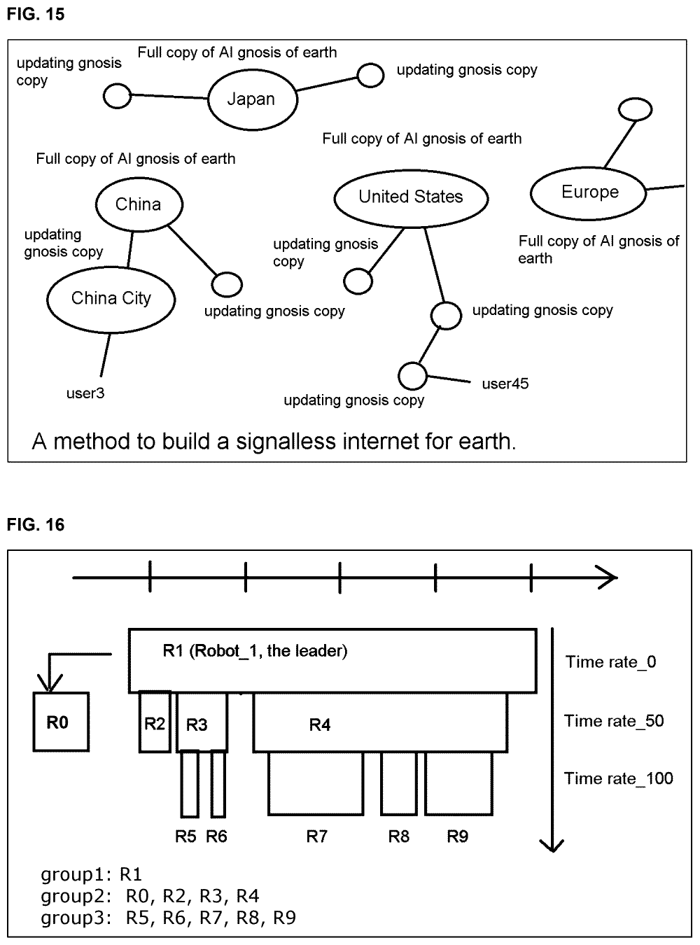

Referring to FIG. 16, Robot_1 (called R1) is the leader of the team responsible for a business project. In the upper levels, R1 is part of an even larger company that gives orders to R1. But, for simplicity purposes let's focus on R1 as a single team. Robot1 has primary 4 workers (R0, R2, R3, and R4) with 2 groups. R2, R3, and R4 are dependents so they have to work in linear order, while R0 is an independent and can work in isolation without affecting the rest of the team. This means R2 has to finish their work first and then designate R3 for the next batch of work. After R3 is done it will hand the workload to R4.

In a business environment R2, R3, and R4 can work in collaboration and in manageable segments. For example, R2 might be a sewing factory and is responsible for putting buttons on a t-shirt, R3 is the ironing department that irons fully constructed t-shirts, and R4 is the packaging department. The button department (R2) must put the buttons on first, and then hand it over to the ironing department; and later, sent to the packaging department. These tasks have to be done one after the other in linear order. However, there is a trick that will allow R2, R3, and R4 to work together simultaneously so that no one wastes time (I used to work in a sewing factory so I know the concept well). The button department puts all the buttons for t-shirts for 10 percent of their workload, and then gives it to the ironing department. Correspondently, the ironing department will iron 12 percent of their workload, and when completed, hand it over to the packaging department. In turn, the packaging department will package the fully completed t-shirts in batches and send them off to their affiliated stores or deliver them directly to their customers.

This method to optimize workload sounds extremely easy at first glance, but when an interruption occurs that's when things get real tricky. In a sewing factory, when an interruption does occur the entire company has to stop production; and each worker is assigned new tasks by the manager. Case in point, if the button department used the wrong colored buttons on the t-shirt, or the button is misplaced half an inch off mark, then all workers (R0, R2, R3 and R4) must stop what they are doing and be on standby mode to receive further instructions from the manager R1. When I was working in the sewing factory; when an unexpected interruption occurs, the manager would tell everyone to stop working and to help fix the problem. Such interruptions are costly to the sewing factory and time is critical at this point. He would give orders to all workers to remove the buttons one-by-one (carefully). If the garment is damaged badly it's no good and must be thrown away (about 2 percent of the clothing are discarded because they can't be refurbished).

In the packaging department, all the t-shirt packages must be unwrapped and sent back to the button department. In addition, all packages sent to customers or suppliers must be recalled or refunded. At this point, the previous manufacturing process will repeat itself, whereby the button department (R2) will attach the correct colored button and send their t-shirts to the ironing department (R3), and then the ironing department will do their duties and send their t-shirts to the packaging department for its final process.

Building a house works exactly the same way. The leader R1 is responsible for managing the entire team and making sure the manufacturing process runs smoothly.

The method described above is used by manufacturing companies all the time, but in this article we're introducing time dilation used in multi-dimensions. Each worker in the company has to work in different time speeds and in different or same world environments. They have to design one linear schedule for all member of the team to do linear work, despite working in different time speeds.

### Time Dilation in Business Models:

Again, referring to FIG. 16, each group is given different time speeds and the farther down the hierarchal structure, the faster the time speed. For example, on the first group R1 is working in the real world but his mind is sped up to incredible speeds and his body is built for agility so he can think and act fast in the real world (like the Flash or Quicksilver). In the second level (node R0, R2, R3, and R4), the work is done in the virtual world; the time speed is raised 50 times faster than R1's time speed, and in the third level, the time speed is even faster at 100 times faster than the first level. We can create deeper level nodes in the hierarchical tree with faster time rates, depending on the complexity of the problem the robots want to solve.

Each member in a group in the hierarchy is given the same time speed, and each robot also has “estimated time blocks” to complete their workload. group1: R1 group2: R0, R2, R3, R4 group3: R5, R6, R7, R8, R9

For instance, R1 has 1 day to complete the task, R2 is designated 1 hour, and R3 is designated 2 hours. If we zoom-in on R3, he has 2 other lower level workers working for him (R5 and R6), and both workloads must be completed before R3 runs out of time. Let's say R3 gave R5 40 minutes to complete his task and 30 minutes to R6 to complete his task.

And because group2 is roughly working with the same time speed, R2, R3, and R4 can collaborate together to streamline tasks simultaneously even though their tasks should be done in linear order (the business method described previously).

Like I said before, the whole operation of a company must be done in linear order. Which tasks are given to workers and how long each worker will take are all mapped out in advance in one linear timeline of work. The company uses a 3 prong attack to solve a given problem in the fastest time possible: planning, preparation, and organization. They must also have the capacity to change their plans in real time if unintended interruptions do occur—due to unpredictable circumstances and the fact that we live in a dynamic and ever changing environment.

Optimizing of business operations is very important. For example, if R3 was given 2 hours to complete a task but he completed the task in 1 hour, then R3 can terminate its session after completion; that will save 1 hour of time. That surplus 1 hour can then be used as resources to be allocated to other teams in case a group needs more time to complete their work. But, the system has to adapt and change to business conditions so that time allocations and resources are distributed efficiently amongst all workers regardless of what level of the hierarchy structure they are functioning at.

The big question: how do we create this 1 linear business plan for a single task? The answer to that question is through strategy guides. Each task has different strategy guides—manufacturing 5,000 t-shirts has a different business plan compared to building a house, so it's up to experts in the field that has gone through many years of experience that can design these planned blueprints and put their “best strategies so far” in books or over the internet for the world to see. This type of planning is different from traditional business plans because we are dealing with robots working in both the real world and the virtual world (the Metaverse 2021) and exploiting time dilation—not to mention the workers are robots, each have superintelligence and AI superpowers.

Now let's apply this knowledge to building a house using super intelligent robots.

### How to Build a House in 5 Minutes.

The example used here is a house building competition with a team of about 8 robot construction workers. The key here is the house has to be constructed fast—in less than 5 minutes.

The teams are judged on building speed, workmanship, and functionality of the house. The judges inspect, not only building structures, but plumbing, electrical, sewage, and heating systems. At the end of the day, cash prizes and military contracts are awarded to the world record breaker . . . not to mention bragging rights.

The first thing that the robots have to do is determine what tasks to do in the real world and what tasks to do in the virtual world/s. The virtual world is an emulation of real world environments inside a computer system. Robots go inside the virtual world to save time by transporting their digital mind into it.

Any digital cognitive tasks should be done in the virtual world like designing the blueprints to a house, buying the cheapest materials, or doing research. The actual building of the house is done exclusively in the real world. The idea is to maximize work in the virtual world and to minimize work in the real world so that a given task can be done in the fastest time possible. In the real world, the robots can slow time by speeding up its mind and its actions (I call these things: robot superheroes).

Before robot builders can put a shovel in the ground, the virtual government must approve the design and provide permits for everything from the zoning and grading (changing the contour of the land to accommodate your home and driveway) to the septic systems, home construction, electrical work, and plumbing. Once permits are acquired, physical construction can begin.

Permits are granted in less than 1 second through the U.S. robot government system. This newly created department of the government caters to super robots and provides governmental resources and services to the robot population.

The virtual world is used to do the planning stage, which involves everything besides the building part. Months are spent in the virtual world to design their construction plans. Virtual robots are constantly discussing the best strategies, debating about the blueprints, and talking to clients for permission and input. The blueprints constantly changes based on group debates. Since they are using time dilation and events can be fast forwarded inside a computer system, it took these robots 1 second to accomplish their planning stage.

The actual site of the construction (at ground zero) will have their entire air molecules pushed outside a bubble that spans 1 city block. This artificial bubble is void of air, and the robots don't have to worry about things like air dragging to slow them down. This means the robots have the freedom to move close to, or at the speed of light (these are synthetic robots and they don't need to breathe).

——superpowers—— Human type of building procedures and methods are used to do work. Each robot worker is using tools and technology to do work. Common construction tools like screw drivers, hammers, saws, measuring tapes, and so forth are used by these robot workers when performing their duties. Obviously, these construction tools are modified to work in time dilation.

Machinery and computers are also modified to work in time dilation in order to keep up with the robots quick thinking and body movements. For instance, a construction machine's computer terminal is modified so that the robots can push the buttons really fast and the software on the computer is modified to speed up its frame rate (think of flash using a modified speed computer). Machinery are rarely used, but if they are used by these super intelligent robots, they are modified to move really fast in the real world. Construction machines like a forklift has its computer systems and mechanical interface changed to work with a super fast robot.

Superpowers are used to replace machinery or tools; there are primary 3 types of superpowers that are used in this contest: 1. quick agility. 2. telekinesis. 3. morphing abilities. These robots have to find new and creative ways to replace physical tools and machinery to do work by utilizing 1 or a combination of these superpowers.

Superhero robots—a robot is also unable to exhaust himself. He/she is also an omnikinetic. He does not need air, water, food, or sleep, and is immortal. Each robot has universal powers and can move really fast and travel over limitless distances close to the speed of light. A super robot is able to: project destructive energy; disintegrate people; create force fields; transmute, create, and destroy matter; move objects without physically touching them (telekinesis); quick healing; mind control; true flight.

Each robot is specialized in a specific type of superpower. One robot might be skilled at levitation while another is skilled at mind control. The chance of victory for an entire superhero team is based on exploiting the combinations and permutations of superpowers strung together—the strategies used and when to use certain super powers allow a weaker team to win against a stronger team. This is why training in the VCR (the virtual combat room) is so important: in order to maintain a competitive edge in Artificial Intelligence (AI).

Winning a fight isn't just about which team is stronger but how effective a team works together to get things done. By building a house, these robots are learning how to cooperate effectively with each other to do team work. The government holds these contests and gives winners rewards in order to strengthen the America's national security infrastructure and military capabilities.

These are the steps these robots have to perform quickly: 1. Prepare Construction Site and Pour Foundation. 2. Complete Rough Framing. 3. Complete Rough Plumbing, Electrical HVAC. 4. Install Insulation. 5. Complete Drywall and Interior Fixtures, Start Exterior Finishes. 6. Finish Interior Trim, Install Exterior Walkways and Driveway. 7. Install Hard Surface Flooring, Countertops; Complete Exterior Grading. 8. Finish Mechanical Trims; Install Bathroom Fixtures 9. Install Mirrors, Shower Doors; Finish Flooring, Exterior Landscaping. 10. Final Walk-Through.

The paint for the house is an interesting subject matter worth discussing. The robots are not using traditional paint that is coated on the surface of the wood that takes a day to have permanent fixture (it would defeat the idea of building the house in 5 minutes) these are molecule coating that uses AI chemistry to molecularly combine. It works on contact and dries instantaneously.

From start to finish, the building of the house was done in less than 5 minutes. It was completed in approximately 4 minutes and 36 seconds (more than enough to break the world record). Everything that human workers have to do, these robots have to also do, and the time duration of the building process is exactly the same for both humans and robots, respectively. The only difference is that the robots have both superintelligence and superpowers combined with time dilation in the virtual world to build the house exponentially faster than human workers. Humans took 1 year of work and robots took 1 year too, but they are using time dilation to condense 1 year of physical work into 5 minutes. By freezing the environment, each robot experienced every second of those 1 year building the house. The robots can freeze the environment by speeding up its brain and body. When the robot's brain is sped up, only the robot's perception of time and space has changed, not the real environment.

The quality of workmanship on both houses are equal as well, though some critics would give the robots extra points for precision of the house or improvements on traditional house building techniques that yielded better results.

The advancement of AI technology and hardware allow robots to condense 1 year of “physical” teamwork into 5 minutes, which is a phenomenal achievement by the human race. Correspondingly, this technology is used to do any human team work, wither that be manufacturing consumer goods, building a bridge, controlling an entire military army, or running a hospital.

### Building a City Using Lightspeed Robots

These robots have to replace all companies in the world and be able to automate all human work regardless of how complex they may be. Each automated company is skilled in their industry and recruits the most gifted robots (they were built super intelligent with the best AI's and the robots learned at the best schools).

The project to be done and in which these robots are in charge of performing is to build an entire city in 1 second. It sounds crazy, it sounds ridiculous but that's what super AI is—it's about the speed in which a robot can accomplish a given task quickly. Moving and thinking at the speed of light is the fastest time possible to complete a task. These lightspeed robots are in sync with each other and they coordinate their efforts using both previously learned knowledge (common knowledge learned in school) as well as real time data.

Why is this important? Because the survival of these robots in battle will depend on how fast it moves and thinks. If companyA builds speed robots that can build a house in 5 minutes (which is very impressive) and companyB builds lightspeed robots that can build a house in 1 second, then if companyA and companyB go to war, companyB will win because it has faster and smarter robots. In fact, companyB will guarantee that no other company out there can defeat it because their robots can move and think at the speed of light, which in quantum mechanics is the highest limit. The application of lightspeed robots to business and entrepreneurship is equally the same with companyB outperforming its competitions in terms of productivity and reliability. In other words, companyA is put out of business because companyB has superior AI and robotics technology.

In this complex city project are many automated companies, most of them are construction companies that build structures in the real world. Other benign companies comprises businesses, government departments, energy companies, farming companies and factories. Each of these fully automated companies are maintained and operated by light speed robots structured in a hierarchical manner, and each member of the hierarchy is skilled in his/her profession.

A government is needed to coordinate resource allocation and issue licenses to companies involved in the city project. Before the construction can begin, a blueprint of the whole city must be designed first and checked and rechecked for errors. Schedules of which structures are built first and next are well delineated in this city blueprint.

Business laws and constitutional laws are followed by all the robot companies in terms of lightspeed construction projects. And the purpose of these laws is to coordinate efforts between robot companies by establishing the standard regulatory framework for each robot's goals, rules, and procedures while doing work in both the real world and the virtual world. It will help aide these robot companies so that their workload can run seamlessly without obstructing each others' businesses.

The government entity will use the internet and websites to coordinate the companies, and private websites are set up to list the instructions, providing the knowledge and resources and post up-to-date information each robot company needs to know in order to perform their jobs with optimal efficiency.

For example, if building a house, an architecture company must design the blueprints to the house first, and this job can be done in the virtual world (to save time). Then, the government has to approve the architecture blueprints so that it complies with existing laws. This process can be done in the virtual world too. Next, when approved, the house project will be assigned to a construction company specializing in home building. At this point, the robot construction company can start building the house in the real world. These steps can't be done simultaneously and in isolation. Building a house must go through this linear process spanning various robot companies, and a government entity is present serving as a manager to ensure this house building project doesn't interfere with other construction projects. This government entity is responsible for the management and maintenance of the city project.

The house construction company will have to consult with other companies like the cement mixers, the home depots, the electrical companies, and the lumber companies. Materials or building machines such as computers, paint, cement mixers and others have to be modified to work in time dilation. Case in point, when paint is added to wood, the paint dries immediately, or a computer is modified so that a robot can push the buttons on the keyboard and move the mouse using lightspeed, and the monitor's screen updates itself using lightspeed so that the computer can synchronize with the robot's thinking and movements.

Things that are classified as cognitive work can be done inside a virtual world, like buying the cheapest materials for the building project, looking over the blueprint, going to important meetings, or solving business interruptions. The actual construction of the home is done in the real world and requires the robots to move physical objects in the real world. Sometimes the robots are switching back and forth from the real world to the virtual world to do work or doing parallel work. Common knowledge from school help to coordinate a team's efforts and delineate what tasks to do in the real world and what tasks to do in the virtual world, and who goes first and who goes next. Human level AI, which each robot has, solves the problem about knowing ones' goals, rules, powers, and procedures while working in a team.

Thus, the behavior of how humans conduct business and do work on large projects are emulated by these robots. The laws the robots must follow, the work that they do, their creativity and the way they communicate are virtually identical to human work.

If it takes human beings 20 years to build an entire city, these robots have to do the same things but exponentially faster. It's just that the robots are working in time dilation or time contraction and has the amazing ability to think and move really fast in the real world (like Flash). What we want is 20 years of human work condensed into 1 second. You can slow down the robots and they can build the city in 5 minutes, but the ideal is to build the fastest robots—robots that work with lightspeed. The robots and the humans are doing the “same” work and they are thinking the same way, but you want the robots to speed up its body movements and mental thoughts so that 20 years of human work can be done in 1 second.

To be honest with you, moving at lightspeed is dangerous for these robots. If they move too fast, their body parts will “rip apart.” The objects that the robots are working on will also be ripped apart. With such speeds, it's really hard to move objects that fast without damaging their molecular integrity. One idea is to build robots with separated parts with no joints, or build a robot that is composed of liquid metal that can morph body parts. But what about the objects the robot is working with, like a delicate egg or tin foil? These external objects have to move at the speed of light too, without being damaged.

We can use a different type of super AI: AI telekinesis, which are invisible robots that can move objects remotely, and if we make these objects move at the speed of light, they can complete the city project in one second. Another type of super AI is the practical time machine where the atom manipulator is used to construct the city by merging atoms together to form structures. This process is faster and more efficient than the previous two methods. Essentially this Practical time machine technology is printing the city out atom-by-atom based on a master file of the city, and this method is no different than how a printer works.

In another example, the atom manipulator can print out cars, and this method eliminates the car factory, all the machines inside, and all the human workers in the car factory. This atom manipulator technology will replace all manufacturing companies, stores, supermarkets, construction companies, and restaurants.

Application of lightspeed robots to war—If these lightspeed robots can build a city in 1 second, imagine what they can do in a war? It's said in physics that light can travel 10 times around the earth in 1 second. If a robot can move using lightspeed and in zigzag motion, it can kill millions of people with his bare hands, and cover a lot of ground in that one second. With a carefully crafted plan, a thousand robots working together in a group can probably kill every human, animal, insect and even bacteria on earth in less than 1 second. This is the reason that tech giants are saying that super intelligence poses an existential threat to humanity.

Robot Team work—These United States' robots are imbued with special abilities and are strung together in permutations and combinations to form effective teams for all kinds of work.

The government holds contests each year in all industries for robots to compete for fame and fortune. The robot companies that win the contests are awarded government contracts. This is how the robots improve on their skills and AI superpowers—by engaging in global robot competitions.

In the future, war amongst countries is about which country's super intelligent robots are superior. Speed of doing human tasks for both digital work and physical work is the measuring factor to determine superiority in AI. In other words, the country with the smartest and fastest super intelligent robots will win the war and rule the world.

These so called super intelligent robots go through evolution like the iphone-after every generation, they get smarter, faster and equipped with more capabilities. They evolve on their own volition through human ingenuity.

### Universal Prediction Algorithm Revisited

The AI gnosis timeline is a perfect digital timeline of planet Earth comprising one long continuous sequence, which documents approximately 4.5 billion years of atom tracking, from the planet's birth to the current state (13.7 billion years for the universe).

With the AI gnosis timeline, a user can see into the past with pinpoint accuracy for any past event and for anywhere and time in the universe (especially earth).

The amount of team work required to create this AI gnosis is monumental. Trillions of humans using technology and the internet still will not be able to accomplish this task. Super AI has the ability to accomplish 30 years of human team work in under 1 second. Since we are dealing with atoms and particles moving at the speed of light, humans are incapable of analyzing and tracking these microscopic data, even with the aide of computers and AI. Only super intelligent robots using recursive time dilation; spanning a plurality of virtual worlds are capable of accomplishing this feat.

Super intelligent robots are required to construct the AI Gnosis. They use the entire internet's infrastructure and all things connected to the web (lot: smartphones, cameras, various electronic devices, computers, network nodes, software, etc.) to detect and triangulate the exact location of every atom, electron and em radiation on the planet, and then further predict past locations of each atom on earth using a sophisticated AI prediction system called the Universal Prediction Algorithm, whereby trillions of sentient robots are working together to predict “all” objects, events and actions in Earth's past.

Their past predictions of all objects and events on earth will ultimately lead to the tracking of every atom on the planet from the Earth's birth to its current state.

In addition to facts related to Earth's past, there is also the hidden information and insights that are not physical in nature. For example, a cop that kills a black man doesn't conclusively show that he did it for reasons of self-defense or wanton murder. In another example, the physical aspects of a computer doesn't showcase its internal software processes or actual data file contained in its hard drive. Thus, the super intelligent robots have to analyze and do research on events and objects in the AI gnosis and discover hidden information. Said hidden information are part of the timeline and represented as research data.

For example, in the case of the man killing a person, his internal thoughts and brain mechanics are integral parts of the event and this internal thought that accompany the physical event will tell wither this person committed the crime out of fear for his life or for other reasons—like discrimination or murderous intent.

The timeline will contain research data on all human brains on the planet and explain the rationale behind a human's physical actions. By AI analyzing the human brain it can gain insight into the mind's decision making. Things like goals, intensions, imagination, future plans and reasoning behind a decision are all outlined inside the human's mental thoughts. All that data is stored in the timeline as research data and it gives the public more accurate information on past events—it brings resolution to ambiguous events in earth's past.

In the case of a computer, the event will have the internal software processes attached to the physical aspects of the computer. Not only can we physically see what is going on with the computer in real time, but also see the hidden data, like what kind of internal processes are happening inside the computers' hardware system or what kind of digital software/file are stored in the hard drive.

The universal prediction algorithm was included in my patent applications (2008-2009) and it was my attempt to describe what it is and how these robots work together to create the perfect digital timeline of planet Earth (aka AI Gnosis). According to the specifications, trillions (if not zillions) of individual super intelligent robots are assuming roles as police detectives in a massive virtual prediction company. Each robot investigator is skilled in his own prediction field and each investigator is structured in a hierarchical manner. Since each robot has human level AI, it solves the problem about: knowing their roles, rules, powers, procedures and communication methods. They actually use the internet (and computers) to communicate with each other in terms of their predictions, so that prediction tasks are not repeated and predictions are done with optimal efficiency. Thus, the robots are working together to maximize performance and to get positive prediction results in the fastest time possible using minimal computer resources. They post all their work online in terms of prediction guesses and updated best strategies to use so far. This way they can coordinate their efforts effectively with other virtual robots and the universal prediction algorithm can operate smoothly. The official prediction website will have the latest research data that the collective community believes are the best predictions so far.

These robot investigators are using the virtual world to do their predictions, and their role is exactly like human detectives. But, these robot investigators are doing things inside a hyper-realistic simulation inside a computer whereby time is contracted.

Often the job of a robot detective involves collecting information to solve crimes or discover historical events, doing research in the prediction website, collaborating with colleagues on cases, collecting physical evidence (in a simulated environment), or searching records in databases. These are typical detective methods that humans use to solve crimes or uncover historical events.

One more interesting note worth mentioning is that these virtual investigators have to live life like a human. In addition to work, they need to take breaks, they need to eat, they need to sleep, and they need social interactions, just like humans. The reason for this is because it facilitates realistic human work . . . it gives them the faculties to generate human intelligence and creativity to solve problems—for example, a robot might go to sleep one day and dream of a unique idea, or the robot might be watching a movie and a good idea pops up in his mind.

Paying them or giving them virtual credits (like time in the playboy mansion) gives them incentive to work harder and to compete with other groups. This will give rise to competition and competition will shorten the time it takes to solve a given problem.

It's also important to regard these robots as humans, and they live for themselves and not servitude. They go to work so they get paid, and they can use that money on vacations and to enjoy life (just like humans). These robots were not meant to work in a factory 24/7 or to be forced into the military so they can go to war and get blown up into tiny pieces. The proper way, the ethical way, is to build them with the idea that they are “free” and they live life to benefit themselves. If a person wants to kill a robot, the robot has the right to kill that person in self-defense. If humans enslave these robots, they got every right to fight back, violently if necessary.

### A Prediction Trick:

Let's say that these super robots are able to predict the precise location of every atom in a human's brain. Hypothetically, let's say that this person lived for 60 years, that means he has 60 years of video footages of all the objects and events he has experienced in the past. By extensively analyzing each data memory in his brain, the robot detectives are able to see and hear anything this person has experienced in his 60 years of life. Some of these data are degraded due to time, but a general description is still stored in his brain.

If the robots can read all those memories, they can use this “60 years of camera footages” as forensic evidence. Now, imagine doing this for every human being on the planet that ever existed?? Personal visual experiences can be corroborated between multiple human subjects to verify past events. If person1 sees John doe at a party at 10 am, a person2 sees John doe at the store at 11 am, and a person3 sees john doe at the library at 1 μm, the investigators can piece together the approximate whereabouts of John doe for the entire day. John doe might have left some microscopic dna somewhere and this will verify that John doe was indeed at that location at some time.

It's not just about reading human brain memories but also other species, such as animals or insects. Although their brains and memory are very primitive, they do have relevant information that will tell detectives what they saw and heard within their lifetime.

For example, a fox in the forest saw 2 objects last week; these two objects can be analyzed to see if they were human or animal or inanimate objects. This fox might have witnessed a murder, and that memory of 2 bodies in the forest might be the key evidence to prove it. Other data like the amount of trees in a forest, or what the houses looked like in a village can be extrapolated from these organic brains and used as clues.

Essentially by analyzing living being's brains we can turn their personal experiences into video clips of what they saw and heard or sensed from the environment (like a camera), and this is a valuable tool to predicting past events. Suppose the AI wanted to predict the environment in Europe in Jun. 8, 1212. They want to predict how many people are living in a village, how many trees are in the village, what did the people looked like and how do they live, and how many animals were in the village. All those questions can be answered by predicting one villager's brain and reading his memories. If the robot investigators can predict all the villagers' brains and read their memories, they will have a comprehensive knowledge about the small village. And that information can be used to predict a castle nearby.

Let's suppose that the robots wanted to predict what Jesus looked like. No book or content over the web will show you what Jesus really looked like. A description wasn't even given in the bible regarding his appearance. The current images of Jesus were based on paintings made in the medieval period by painters that had no idea what Jesus looked like. So how do the robots predict this image of Jesus? These robots have to predict back to 2000 years ago. They have to track all the atoms in the timeline gradually and incrementally, all the way back to year 0 A.D. At this stage, most of the events in earth's timeline are predicted for the last 2000 years. If the investigators can predict just one follower of Jesus and they predict all the atoms in his brain, we have access to all his memories including his encounter/s with Jesus. The images that are stored in his brain will show us what Jesus really looked like (given that Jesus really did exist in earth's past).

The location and state of inanimate objects are also crucial for detective analysis. In one prediction, if a chair was moved from the living room to the kitchen, we can assume that someone must have moved it-we can guess that it's a human being or that it might be a John doe. If we analyze closer and find John doe's recent finger prints on that chair, and the dna analysis determines that it belonged to John doe, then we can conclusively say it was John doe who moved the chair.

Further investigation will uncover when John doe moved the chair, and his internal thoughts will reveal why he moved the chair. This will tell robot investigators where and what John doe did at a specific time and place based on the chair data. The point is that by doing “traditional human detective work” the super intelligent robots will be able to piece together the exact sequence of events for John Doe on that particular day for every second. The final work is to track every atom in John doe's body every nanosecond for the entire day.

Predicting Electronic Devices and Predicting Content in their Disk Drive

We can use the same process on reading data stored in cameras and other electronic devices—collecting all video footages, pictures and sensing data from all electronic devices on the planet will give the robot detectives valuable data on where people where located at specific times and what they were doing. This method works well for year 2002 and up, but before that year personal cameras on computers and in cities are rare and require traditional forensic methods to predict accurately.

Uploaded content over the internet has to be identified and also the type of content uploaded will give clues as to who uploaded it and from what computer. These clues provide us with rich facts in which to make further predictions. All electronic devices and machines have to be reversed engineered, particularly the memory data of what is stored in terms of software processes, log files, and file contents. This will give investigators clues as to when the computer was assessed and who might have used the computer. Remember, the robot investigators want to know everything about a person—what they were doing at any given time; what they were thinking about while they were doing a task, etc. In the digital age, people spend a lot of their time sitting on their computers and working or using their smartphone, and these devices are good tracking sources.

The robot investigators want to create a timeline for every object on the planet that ever existed—this includes humans, animals, insects, single bacteria, computers, machines and inanimate objects like buildings or rocks. If they can do that, they can also track the atoms that comprise these objects and thus track every atom on Earth's past every nanosecond. The premise is simple: track all atoms on the planet every nanosecond for 4.5 billion years and create one continuous timeline of Earth, from the planet's birth to the current state.

The prediction task is fully automated and it rules out any human work. The reason that humans are taken out of the loop is because they are too slow. “In the time it takes for a group of humans to do one prediction (which took them 30 years to accomplish) and upload that data over the internet, these super robots would've done the same prediction in less than 1 second.”

One technique I discovered that will allow an AI system to accurately predict the past is by predicting objects and events in a hierarchical manner—from most important to least important. Often the most important objects are objects that affect the Earth drastically, or have the most influence.

Intelligent beings such as humans affect objects on Earth the most so they get predicted first. Within that prediction volume we have to predict humans in terms of how important you are and how many information you have available online. The more information you have online with a high degree of demand from the public, the more important you are.

Famous people get predicted first and then trickles down to the non-popular people. Case in point, the U.S. president is more important than a dead actress in the 50's that only starred in 2 movies.

There's no doubt that all objects and events on Earth must be predicted all the way down to individual atoms, but they must be done using heuristics, and the robot investigators have to set up their company structure to reflect this heuristics prediction—making sure that teams are designated appropriate prediction tasks and can collaborate effectively with other prediction teams to do team work.

Predicting the past is simple because there is the current state to verify wither past predictions are correct or wrong. However, predicting the future is exponentially more difficult to do due to the fact that there are no benchmarks to verify future predictions.

### Super AI Applied to Predicting the Future

These super intelligent robots can do any digital work in a VR environment in one second, or do physical work in the real world in minutes. For example, it can write a book in 1 second, it can make a movie in 1 second, it can do 30 years of research in 1 second, or it can build a house in 5 minutes. Even building an entire city in 1 hour isn't far fetched. The AI technology is universal and can be applied to solving any human problem or do any human task in the fastest time possible.

In this case, we are applying these super intelligent robots (aka Super AI) to predicting the future. A massive prediction company is set up inside a virtual world and trillions, if not, zillions of individual robots are working together to predict all future events. They have to use the knowledge in the AI Gnosis, the perfect digital timeline of earth that tracks every atom, electron, and em radiation on earth for the past, present, and future. All the atoms for earth in the AI gnosis have to be used to predict future events. The past and current locations of atoms in the timeline are used to predict where all atoms will be located in the future, thus, in turn, predict the future of all objects and events on earth.

The robots have to predict all objects on earth in a holistic way, prioritizing objects according to their popularity and influence, and then they have to group them heuristically into permutation and combination groups (or events) to predict how their interactions will turn out in the future. One example: if Dave runs into a room and there are 5 micro-machines on the floor, how will he slip and fall down? Will he be able to see the danger to avoid it? Which one of the micro-machines will he step on first, causing a slip. How many weight was put on the toy car and what direction will it go? If Dave falls down, will he break a bone or injure parts of his body? Will he go to the hospital? If Dave does fall, what part of his body will hit the ground first?

These questions are possibilities of future events that the robot detectives have to find answers to. It's kind of like human detective work where humans have to use tools and software to discover truths. These robot detectives will be working in this digital realistic environment with the time dilation set at 30 years inside a virtual world is equivalent to 1 second in the real world. This way they can get 30 years of teamwork done in under 1 second. The alternative is for these robots to do work in the real world and spend 30 years in the real world doing 30 years of work.

This is a very complex task, to predict the future of all objects on earth, from big objects like humans to small objects like individual atoms. Again, the robots cannot predict a future event in isolation, it has to predict everything if they want to predict a specific future event. Predictions also have to be done incrementally and uniformly. For instance, if the robots wanted to predict the future lottery number 2 weeks from now, they have to predict all future objects and events on earth (and beyond) in order to successfully predict the lottery numbers two weeks into the future. If the robots try to predict the lottery numbers in isolation, even if they use heuristics to narrow down the scope of the problem, they will never find the correct lottery numbers. All events and objects in the future are interconnected in a dependent network where each object in the network affects each other. In order to predict one future event, the robots have to predict all future events.

The best outcome regardless of how much time and processing is allocated to the problem is an estimation—a general depiction of what might happen in the future, output via declarative sentences (i.e. Dave will run into the room and step on micro-machines and fall down, or Dave will win the lottery two weeks from now). But the AI can't predict the exact numbers. Other examples: Dave will graduate from high school and go to college to study either computer science or engineering. He might actually switch to business because he isn't good at math and has a history of changing his mind. He will study computer science, flunk out of that major in less than 1 semester.

These types of future estimated predictions might or might not come true because of the future's unforeseen circumstances or unpredictability. They use realistic computer simulations to visually depict what the future might look like and they rank all these future possibilities.

### Predicting the Future (Part 1)

Predicting the past is simple because there is the current state to verify wither past predictions are correct or wrong. However, predicting the future is exponentially more difficult to do due to the fact that there are no benchmarks to verify future predictions.

Predicting the Powerball Numbers 2 Weeks into the Future

The task of the universal prediction algorithm is to predict the Powerball numbers 2 weeks into the future and tell viewers who will win the lottery and what the winning numbers are. Imagine for a second that a John Doe will win the lottery jackpot. One day John Doe was returning home from work and he saw a bright light in the night sky. Panicked, John stepped on the pedal and tried to escape this ufo. Unbeknownst to John, the ufo shoots a ray of light at his car and manages to pull him into the craft. While John was helplessly brought into the craft, on the side of the ship, he noticed the serial numbers: 1, 2, 44, 16. The next thing John remembers is being back in the car driving back home, with 2 hours of missing time that he couldn't account for.

A week later, after the incident happened, John Doe decided to buy a Powerball lottery ticket, and on the number slots he wrote down the month and year of his birthdate (3/19/78) for the first two numbers, and the 4 numbers that he saw on the side of the ufo (1, 2, 44, 16). One week later . . . at the powerball number drawing: 3 78 1 2 44 16. John doe wins the powerball because he selected the correct numbers.

This is an extraordinary case because the numbers were selected partly based on a ufo encounter, and the ufo came to Earth from a planet billions of light years away.

In terms of predicting the future, these super intelligent robots have to not only predict everything happening on Earth's future for the next two weeks, but they also have to predict “all the atoms in the universe” for the next 2 weeks in order to accurately predict the powerball winning numbers that will take place two weeks into the future.

A light traveling in space that hits Earth adversely affect future events. An astronomer might look up at a star in the night sky with a high powered telescope and see the light flicker for 1 second. That event of the star flickering can cause the astronomer to get an idea in his head—maybe the idea leads him to bet on a sports game and he wins thousands of dollars?? Or maybe the idea to take a vacation next week pops up in his head? Whatever the affect is, the astronomer was changed by a simple light emission that originated light years away from Earth. Thus, if these robots want to predict future events for this particular astronomer, they have to also predict the light emissions that will come to Earth light years away. So this type of complex prediction isn't localized to all atoms and em radiations on Earth, but also all atoms and em radiations (particularly visible light) contained in the whole universe.

This leads me to believe that the only way to predict any future event, especially if it's a complex future event, is to force Super AI to predict all atoms, electrons, and em radiation for the entire Universe!! This is impossible to do (nearly impossible).

Of course, the AI has to do future predictions heuristically. If AI wanted to predict the lottery numbers 2 weeks into the future, it has to predict objects centered around earth first, then include neighbor planets in our solar system, and finally widen the radius out into space. This goes on and on until the entire universe is part of the prediction. Every atom and its subatomic particles in the Universe must be predicted precisely for the next two weeks in order to predict the actual Powerball numbers 2 weeks into the future.

I wouldn't be surprised if the AI predicted half the length of the universe for 2 weeks and still get the Powerball numbers 2 weeks into the future wrong!! It got all the atoms on earth predicted precisely in terms of its location and time, but the light coming from space plays a major role in the prediction task. Get that wrong and the prediction is a failure.

### Prediction Structures

Let's take a look at the hierarchical structure. This is a highly centralized organization, but each prediction group and robot are “individuals” whom are skilled in their respective field and follow strict business laws. If things were decentralized there would be chaos and it would take 10 times longer to do predictions.

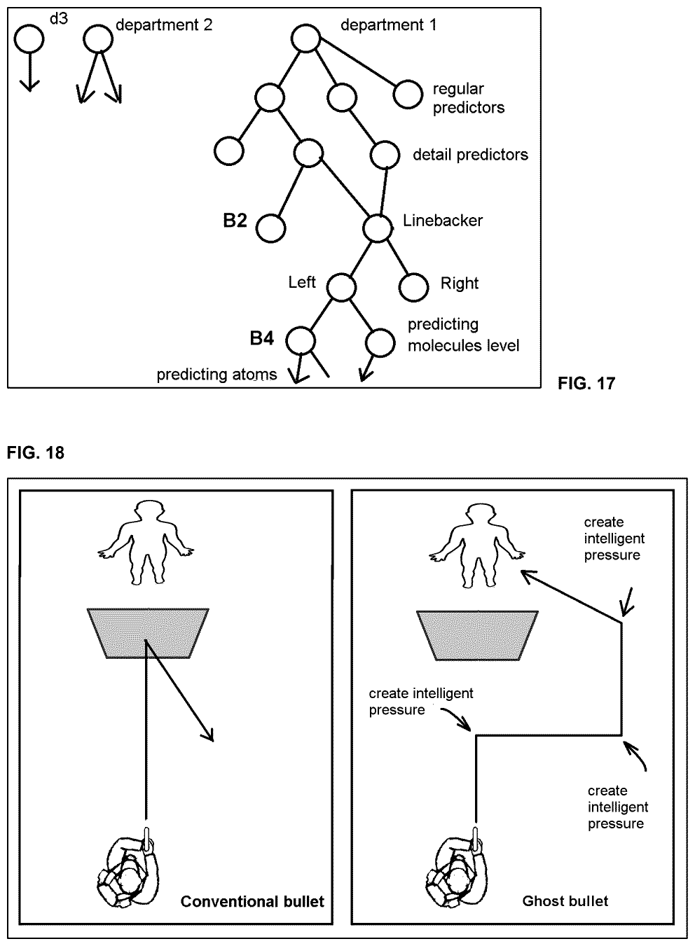

Referring to FIG. 17, at the top of the hierarchical tree are the predictors that try to predict a broad range of events. In the middle are the general predictors that try to predict individual normalized objects or events. The robot investigators in the middle command the lower level workers to predict things like molecules, and the molecule predictors command other lower-level workers that are responsible for predicting individual atoms. It's reminiscent of a massive puzzle piece whereby you try to piece together events of data separately based on association. And the more data you piece together or establish relations with, the easier it is to piece together other data pieces. The same method to solving a puzzle piece is the same method used in this prediction algorithm-they try to predict individual events first and then link them together using human intelligence. The more information predicted, the easier it is to solve a case, and the more individual cases they solve, the easier it is to solve all the cases.

Each team node in the hierarchy has different sets of goals, rules, and procedures, and each also have different strategy guides to follow to perform their duties. For instance, the team at node B2 acts like human police officers and predicts events in a general manner, while the team at node B4 only predicts the atoms and isn't concerned with what object these atoms are a part of. The upper level workers give specific instructions to its respective lower level workers in terms of what to predict (just like any business company). If there is an interruption, the people at the top will correct that interruption by sending orders to its respective lower level workers, and when solved, continue with their operations.

The coordination between companies is based on a global business plan and common knowledge learned in school. The business plan is a very complicated rule system that is custom tailored based on a business goal. Needless to say, rules are not fixed in stone and are constantly changing. Human level AI provides each robot with the knowledge to adapt to any given situation.

The nodes at the lowest levels are the investigators that predict the activities of individual atoms. They would be given a general atom map of an object and partial data from upper node levels, and their job would be to predict the internal activities of each atom. This includes the electron's spin in space and time, frame-by-frame, and the predictions of emission of photons from said electron.

If the upper levels say they got it wrong and here is the updated prediction research, the atom companies have to adapt and redo, or modify, their previous work. For instance, if this was a football game and the target object is the linebacker, the top node will output that the linebacker is going to move left, this prediction information in turn will be relayed to all the lower level nodes in the hierarchical tree, all the way down to the individual atoms. However, the top node might say “we got it wrong, the linebacker will move to the right instead,” all the other nodes in the hierarchy (each node is a company and is an expert in their field/s) will have to change their output. They have to scrap all their previous work and start all over again.

Especially when predicting the future, prediction lists are fickle minded all the time, and entire previously done predictions are thrown in the trash as the current state is updated. So it's very important that prediction resource allocations are designated to very important future possibilities. These robot predictors must work together in a hierarchical business to perform predictions with optimal efficiency. They have to work in a chain corporation to output future predictions accurately.

### Predicting the Future (Part 2)

Referring to FIG. 5, all events in the past are interconnected in a massive spiderweb network based on causality, and all events in the past, regardless of how minor or major, created the current reality we have right now.

A verification system can be devised in which the robots will make a past prediction, either an event or an existence of an object, and then use the current state of the earth to determine if that past prediction is true or false. The interconnectiveness of past events and the linear sequence of past events are factors to determine if a prediction made is true or false.

Example: a chair is moved from the living room to the backyard of a home. The prediction problem is who moved the chair? Was it person1, person2 or person3? We know that it wasn't an animal, because they are non-intelligent. We can rule out aliens or ghosts. The robots do investigation and discover that person1 was at the store, person2 was at home and person3 was at school. Logic dictates that person1 and person3 are ruled out. Using human intelligence, these investigators can assume that it was person2 who moved the chair. To confirm this they looked for dna and fingerprints on the chair touched last and discover that it was in fact person2 who moved the chair. The investigators talked to the neighbor, and he saw person2 moving the chair with his own eyes, and also the surveillance camera in the home captured person2 moving the chair. Predicting clues here and there about past events, and collaborating with each other will determine if a past prediction made is true or false.

Let's say that we had 1,000 computers in 1990, each generated a random number between 0 and infinity, and AI wanted to predict all the random numbers for all 1,000 computers, it would be extremely easy for AI to predict these past “random numbers.” Said random numbers could be any number and the computer could've used any method to generate these random numbers. The AI will simply use the current environment we have right now on earth-all of its knowledge, including all current atoms on earth and their sub-atomic activities, use them as forensic evidence or clues, to predict those random numbers generated from said 1,000 computers in 1990.

Maybe the random numbers were stored in a log file somewhere, all the AI has to do is search for this log file to find out the random numbers. Maybe the random numbers generated passwords and the passwords are located in a notebook someone has written down on paper. The AI can predict the notebook and then reverse the password back to the random numbers. Maybe the random numbers were used to select the last four digits of Americans to fight a war. All the AI has to do is find out all persons who were selected for the war and search for their last 4 digits of their social security number to find the random numbers.

Thus, there are many ways to predict past random numbers. Some are very easy because they are recorded in digital logs or written down on hardcopy books, but there are random numbers that are not recorded in history books or stored in digital files and require deeper investigation to uncover. For example, the random actions of sub-atomic particles for individual atoms for the past can be discovered through deep investigation.

However, the same advantage that allows the robots to predict the past is a disadvantage when attempting to predict the future. Future predictions have no benchmarks to determine if a future prediction is right or wrong. Remember that I said all atoms, objects and events, are interconnected in a massive dependent network, whereby all atoms on earth affect each other one way or another. This is true for the past, present and future.

Referring to FIG. 5 (pathway 34), the chain of events is as presented: Dave will be playing football on Friday. On Tuesday he is working on a school project and needed glue so he went to the basement to get the item. The glue is stored at the top of the shelf so Dave took a chair and used it to get the glue. Unbeknownst to Dave, the chair breaks while he was trying to get the glue and as a result Dave broke his leg. At the hospital, the doctors do surgery and he had a cast on his injured leg. This event caused Dave to skip the football game on Friday. In fact, he won't be playing football for 6 more months because his injury ended his season. Next, on Friday Dave goes on his computer to play a game. The game generated a random number.

Is it possible for AI to predict this random number 2 weeks before it happens? The answer is yes, but the AI has to predict all linear events that led to the random number. From the current state, the AI has to predict pathway34 which are the linear events that will lead to the random number.

Look closely at the chain of events represented by nodes in the network. All events in pathway34 are dependent on all events on earth (and beyond). Some dependent events include: the chair was brought to the basement by Dave's father, the glue was placed there by a sister, the reason Dave played the game on the computer is because he missed the football game, and he needed the glue because his teacher gave him an assignment. These are dependent events or objects (Dave's teacher, the glue, Dave's sister, etc.) that led up to pathway34.

Although AI has to predict all future events on earth in order to predict the future random number, it can predict future events using heuristics by confining the problem to the most important future events (or objects), and to prioritize which future events get predicted first, next and last.

A more complicated example: predicting the Super Bowl game in 2100, frame-by-frame.

The job of the AI is now to predict the entire Super Bowl game in 2100, which is 76 years into the future. The problem is that the players in this 2100 Super Bowl don't exist today. Guessing who will play in this Super Bowl game 76 years into the future is impossible because these players don't exist yet. And guessing which of the 20+ teams will play is impossible and it could be any 2 teams, even the worst teams today in 2024 (The Raiders vs. the Giants??).

So, how does the AI predict such a complex future event? My 2008 patents used this Super Bowl future prediction as an example in the application/s. I did it because this is the most complex example anyone can conjure up. The task was for the AI to predict frame-by-frame, the exact events of the entire Super Bowl game in 2100, including the commentators. Every gameplay is atomically shown and every injury is depicted for every second of the game. The future game must be presented to the audience as if the audience was watching the game in 2100.

How does the AI predict this future Super Bowl game? Let's go through some of the linear steps that I described in my 2008 patent. I will try to summarize it first and then present a full detailed description later. First, the AI has to track, atomically, all objects on earth for the current state, including humans, machines, animals, structures, plants, bacteria, molecules and atoms. Using this data, the AI has to analyze and predict the future of all objects on earth, especially humans. Next it has to predict the mating game and predict which male and female will mate and later produce children. This includes predicting all sperms in sacks from all males on the planet, and predicting all eggs produced by all females on the planet. It is very important that even sex acts for all couples on earth be predicted precisely, and which of the sperms will reach which of the eggs for fertilization.

The idea is to predict all future human beings, and from that group, determine which humans will eventually play in Superbowl 2100.

Next, for each fertilized embryo—fetus—the AI has to predict its developmental processes from creation to the baby stage. Then, for each birth, after it comes out of the womb, the AI has to predict the developmental stages of the baby from birth to death. Things like skin color, facial features, physical body appearances, height, weight, brain behavior, genetic traits, etc. are predicted perfectly throughout a human's lifetime, frame-by-frame and atom-by-atom. Inexplicably, the AI needs to predict every object and event on earth.

From that stage, the robot investigators have to predict how each player will grow up and eventually end up playing in Super Bowl 2100. This includes predicting all their football games played in high school, in college and then in the NFL.

All NFL football games from 2024-2100 must be predicted precisely, for these NFL games are dependents of Super Bowl 2100. Which NFL players will retire and replaced with newer players are dependent events to Super Bowl 2100. This information will tell us who was drafted into the National football league in the future. The entire season of 2100 must be predicted with precision in order to predict what teams will be competing in the play offs, and eventually that outcome will determine which 2 teams will play in Super Bowl 2100.

All current and future human beings will be predicted precisely frame-by-frame and atom-by-atom from birth to death. Who knows, a boy from Kenya in 2085 could migrate to the U.S. and end up playing in Super Bowl 2100. This is why all future and current human beings must be predicted in order to get the future prediction with an accuracy rate of 100%.

As you can see, the future prediction problem is very, very complex. The AI has to predict all events on earth in the future in order to predict Super Bowl in 2100.

Predicting all objects and events on earth for the future.

The AI system has to track and understand all events, objects, places and things on the planet first. It uses all the current and past information of earth to predict the future. The best way to do this is through the AI gnosis where all atoms are tracked in a timeline. All events on earth must be predicted as a whole, no prediction is done in isolation. Most importantly, the AI system has to predict every single human being on the planet and what they are going to do in the future.

Predictions are repeatedly updated based on the latest current state of atoms on earth, and previous predictions are corrected, or prediction resources are allocated to better predictions.

All objects on the planet that affect events on earth are predicted first. This group includes humans and their activities. Humans on earth dictate the future of events on the planet because they are the greatest influencers. Next comes the machines, electronic devices, and network systems that comprise the internet. Humans are always using computers to aide in work or to influence people, places, and things, so electronic devices are analyzed and the AI must predict every future event regarding each machine's internal processes and outputs. For all computers or machinery in the world, both their hardware and software are predicted. The goal is to predict all future activities of the internet and others like the stock market, etc, which influences humans tremendously and dictate their future actions. Next, an even more complex prediction is to predict the future actions of AI robots. Their complexity goes beyond human brains.

The next group that has little or no influence to future events are lower life-forms like animals, insects, bacteria, and life forms comprising the eco-system. It's usually humans that control animals and not the other way around. These lower-life forms have primitive brains and they are predictable. Unlike animals, humans are intelligent and often times very hard to predict. That's why they are at the top of the hierarchical tree and they are predicted first.

The last group in the prediction tree is inanimate objects found in our environment: buildings, water, air, dirt, toys, artifacts, and things that don't involve having a brain to think and act. These groups of objects are the lowest part of the hierarchical tree and are predicted last because they are inanimate and they don't move unless acted upon by intelligent entities, such as humans or animals. It's pretty clear that humans and computers control inanimate objects and affect them in profound ways (i.e. a human moves a chair from the living room to the back yard, or a river is drained from its water source by roaming animals). These are objects that stay in a fix location and don't change unless humans or animals affect them. These inanimate objects are very easy to predict and AI is able to track them continuously.

However, the inanimate objects that are hard to track are those that are constantly changing at a molecular level such as air, liquid, or light atoms, because they merge and break apart. An orange is inanimate, it falls to the ground, and then decompose to its tiny elements, and either recycled into the ground or transformed into gas and float away to other areas. Maybe the orange is ingested into a human being and the food becomes fuel for cells in said human. Thus, these inanimate objects transform their shapes or break apart into smaller objects. They also migrate from place to place. Though these microscopic molecules that make up inanimate objects change its type or break apart into smaller pieces, they are easy to track because there is no intelligence to their behavior-they operate entirely based on physics laws. Things like the eco-system and degradation of physical structures can be predicted using sophisticated AI models. Buildings are the easiest to predict because they stay in one place and is hard to move around.

It's the human beings that is so hard to predict. Machines like the internet and personal computers influence humans, and that group also has to be predicted too (in unison). As a rule, the AI system must predict all objects, events and actions on earth as a whole; and not in isolation. Everything must be predicted all at once in a heuristic way starting with human beings. In the human group, the AI system has to prioritize humans and devote prediction time to humans that affect the world the most. Humans are prioritized and put into a stacked queue for super intelligent robots to predict their future.

The president of the United States is predicted first before predicting a bum on the streets. Why? Because the president can move mountains. Some of his decisions are so important that it determines if the world goes to war or not. The bum on the street doesn't really affect anyone. The future actions the bum takes will not affect future events in dramatic ways. But the president will affect people, not just in the United States, but all over the world.

With time dilation and a hyper-realistic VR world, they can do 30 years of work in under 1 second. Each robot is transporting their digital mind into the virtual world where the environment is identical to the real world and time is set exponentially faster than normal time.

With this said, the robots have to predict “all objects” on earth and give each object some reasonable prediction time. Let's take a look at one example. The president has a wartime meeting in 3 days with an adversary; he plays in the backyard and cuts himself. Later, the cut was infected and was caused by bacteria 45b, and the president was taken to the hospital for immediate treatment. Subsequently, the president misses the meeting and the adversary takes advantage of the distraction and goes to war with the US.

All these chain of events happened because of bacteria 45b, which is a non-essential object. This is why the AI must predict everything, not just bacteria 45b, but all bacteria in the white house. You don't know which bacteria will infect the president, it could've been bacteria 89c.

The point I'm trying to make is that all objects on earth has to be predicted in unison because all objects, all the way down to atoms and sub-atomic particles, affect each other one way or another. The future is like a massive interconnected spider-web of causality. The AI has the unenviable task of predicting all atoms on earth (all objects on earth) in a heuristic way; it has to predict all future events as one massive event.

### How to Predict the Future Actions of a Human Being

Think of a human being as an entity that outputs random actions. You can think of the human as a computer that outputs random numbers linearly, and these numbers could be any number between 0 and infinity. The actions that it can take in the future could be “anything.” The human can run, say something, pick up a piece of paper, press a key, fall down, or punch someone. The AI has to predict its future actions regardless of what intended, unintended, or random actions it takes.

Forces out of its control are also considered. The person might be affected by other objects in its immediate environment. For example, the human walks into the next room, steps on a toy, and falls down. The toy affected the human in profound ways. This fall might lead to injury and that event will lead to a chain reaction of other events. For instance, the injured human will go to a hospital where he will affect a doctor.

How do we predict the future actions of a human? The answer is to analyze the human's brain, so much so that every aspect of its cognitive functions are understood by the AI. The AI has to analyze everything and understand this person at a level where his entire behavioral patterns are discovered and understood. The robots have to reverse engineer the person's decision making system and its memories, and identity. His entire brain has to be analyzed and AI models of behavior have to be generated. It's kind of like detective work where robot detectives are trying to compile a detailed profile of a serial killer so that they can understand and predict what the serial killler's next moves are—where will he strike next, how will he kill the victims, what type of victims is he targeting, and how will he evade law enforcement?

The AI or groups of robot detectives will go into the virtual world to do the future predictions using time dilation. The time setting is set to 30 years inside a virtual world is equivalent to 1 second in the real world. This permits the robot detectives to do 30 years of teamwork in less than 1 second.

These robots will have the AI gnosis, a perfect digital timeline of earth, in which to aide in predictions. Every atom on earth is tracked for the past and the current state and updated continuously, and these robot detectives use this knowledge to predict future events. This timeline gives the robots the ability to see into earth's past with 100% accuracy. Their task is to say, “from the current state, what will John Doe do in the future?” There are a lot of information to predict like the environment John Doe is in, what objects he is interacting with, and most importantly, what are John Doe's current mental thoughts.

This is one of the key to predicting the future of John Doe's actions: by reading his current mental thoughts residing in his mind's eye, which is hidden. The mental thoughts of the human reveal everything that John Doe is thinking and reveal his linear cognitive steps. The outputs of a human brain are linear mental thoughts, and those mental thoughts determine the human's physical actions. Contents of the mental thoughts of a human are: goals, intentions, commitment of its goals, future plans, procedures, and rules to follow. If the AI can identify the human's goals, then essentially it can predict the human's future actions.

One example is the AI reads John Doe's mental task. Each task in a human brain is recursive and has linear steps. By seeing the current task, the AI has access to all the recursive linear steps (the brain already has stored linear steps to a recursive task). If the task is: “make a sandwich,” that task has linear procedural steps and rules to follow. This information will give the AI possible future possibilities. If all the recursive tasks are predicted, all the AI has to do is predict each step's details.

One of the most critically important thing is that conscious thoughts comprise the voices or the internal dialogue inside the mind's eye. Gibberish, words, images, sentences in the form of sound data (or voices), are the output of the human brain. Example: “make a sandwich”, “next week, remember to pick up the dog”, “I forgot my wallet at home, I can't buy the item”, “watch out! Don't get too close to the stove”, “the instructions say to turn the stick gently”, “don't eat! There is a big roach in the burger.” These internal thoughts give the human the intelligence it needs to think and act. Seeing those internal thoughts is important to predicting the human's future actions.

### Part 3: Miscellaneous Topics:

AI chaos theory builds upon my future prediction program in which Super AI is applied to predicting future events. This AI chaos theory technology basically adds a new feature which is to predict the future “and” engineer future events. We want to have the ability to initiate events with computer guided precision that will lead to a desired outcome. The artificial chaos theory technology basically outlines the initial action and the outcome—the robot is able to predict the chaotic chain reactions of events that will occur between the initial action and the later state (the outcome).

### Universal Robot Brain

The Universal robot brain stores the 5 sense experiences called pathways of multiple robots into one massive brain. These robot pathways are stored in this brain and self-organized in its memory banks. It's just like one robot brain, but in its stead, it is storing experiences from multiple robots. It self-organizes data in memory whereby same/similar information are shared and new data is newly created. There is a forget function that degrades any experiences that are not common. This universal robot brain does this to compact data, and to avoid storing repeated data. This is how the human brain can store “infinite data” in that tiny space.

This Universal robot brain can take the place of infinite robots, and the good thing about it is that its storage is equivalent to just 1 robot brain (no more than 20 robot brains after training with trillions of robots). Expansion of knowledge in memory is about storing only novel data. Any repeated or similar data via knowledge, text, images, videos, linear procedures, etc. (anything humans experience) are brought to a minimal.

There are primarily two functions to the universal robot brain:

1. It can serve all users online as agent programs. There are two types of agent programs. One is an instance of the universal brain, which involves searching the universal robot brain to extract a pathway to do work, or it can run a full expert brain to do work for users. Running an instance from the universal robot brain can only solve simple problems, and running a full robot brain, classified as an expert robot, are needed for complex and long projects

2. It can forge expert physical robots, each with a full brain and has human level AI as its underline intelligence type. This individual robot is self-aware and is an expert in a particular field of study. For example, if the robot is working as a doctor it has extensive medical knowledge and skills with 4 years in college, 4 years in medical school, and at least 20 years of experience in the field.

Creating one robot that can do every human occupation is impossible, especially if you want each occupation to be performed at an expert level. What is possible is that the universal robot brain can forge multiple robots, each with different skills, and string them together in permutations and combinations into teams to do complex human tasks (like building an entire city in 1 hour). Selecting which members belong to a team and the team's mission is very important.

To make things more complicated, each robot also serves as a brain that can make copies of itself in the virtual world as digital representation of itself. In other words, the physical robot, its brain, can create many instances of itself as avatars in the virtual world to do work, and each copy is referencing knowledge and skills from the physical robot's brain. The physical robot can make 5 copies of itself to create a comic book for example. It also has the option of recruiting other external expert robots to join the group to do team work.

Referring to FIG. 13, these super intelligent robots work together using the universal work algorithm. These robots can do any work in the virtual world or the real world, or both. They can build a city in one hour, or fight a one second war, or cook meals for thousands of people in hundreds of restaurants all across the world. By the way, a one second war is a scenario where lightspeed robots, robots that can think and move at the speed of light (the “zenith” of AI and robot technology), can attack and defeat a country in less than one second.

What is even more powerful than lightspeed robots are ghost robots or global telekinesis.

### Training of the Universal Robot Brain

Language organizes data in the human brain, and language also gives rise to conscious thoughts that inevitably leads to self-awareness. To be self-aware means that you have gone through 21 years of life experiences (from k to college) and, on its own volition, your brain developed the voices in your mind's eye. That voice in your mind makes a human self-aware; this is the premise behind human level AI.

There are several methods I proposed in around 2008 to train the universal robot brain. One method that is the easiest is to build robots and then copy their experiences and conscious thoughts into pathways and insert that streaming data into the universal robot brain. The storing of robot pathways into the universal robot brain is called “training” or the more appropriate term, and in which I like to use, is “learning.”

In the case where a fully functional brain doesn't exist yet and you want to train the universal robot brain in a controlled manner, scientists can curate the data over the entire internet, store them into a movie sequence format (like humans) and then store the streaming data into the universal robot brain (this is akin to the current LLMs). This is the one method that I didn't describe in my patents or books or videos.

However, the method that I did propose in around 2007 was for a human trainer to put on VR gear like a visor, gloves and body sensors to record every sequence of its experiences while doing human tasks. Since the human trainer's mental thoughts are hidden, I proposed the human trainer speak out its thoughts by telling the recorder all the steps it is taking and all the relevant information about the task (kind of like an instruction video but from a POV point-of-view).

Another method proposed was to have a mind reading device that reads the human trainer's mental thoughts and it is recording all the content in the trainer's mind, which comprises the voices, the activated images, maps, flow charts and others. The voices, or the internal monologue, is very important because that is the means by which intelligence is created. Things like common sense knowledge, linear steps, recursive goals, and procedures are created in the human mind through “sound words or sound sentences” and visual cues. The pathways record the human trainer's physical body movements as well as its mental thoughts, and store them in sequence format into the universal robot brain. Different humans, each specialized in a field, are used for the training like janitors, doctors, construction workers, artists, etc. (all human occupations for all industries). They are all stored in this one massive brain and the data goes through self-organization. All of the knowledge and skills from a plurality of robots are hierarchically structured, and this is how custom expert robots are forged.

Robot occupations are hierarchically structured. If you zoom into the universal robot brain, you will see that robots with similar occupations are grouped closer to one another. A robot soccer player is grouped close to a robot basketball player (because they share similar goals, knowledge, skills and procedures). On the other hand, a mathematician robot will be stored very close to an engineer robot, and that engineer is stored very close to a computer scientist. A janitor robot would be farther away from the computer scientist robot because they use different skills and knowledge.

Again a human trainer is not needed if robots with human level AI are used for the training. All the scientists have to do is build robots and then record their body and brain data and store them in pathways to be trained in the universal robot brain.

Once the universal robot brain is trained properly, scientist can use this to provide AI agents to cater to online requests, or the universal brain is used to forge custom robot slaves like janitor robots or maid robots.

### Other Topics: a List of AI Superpowers:

Here are just descriptions of various types of AI superpowers not described in the previous patent entitled the Universe Time Machine.

The atom manipulator has the ability to control atoms or molecules from a distance using E.M. radiation, such as microwaves, sound waves, x-rays, artificial magnetic fields, etc. The super computer is controlling the atom manipulator to generate something called intelligent pressure. It can create any amount of pressure in any given space or time. In addition, the super computer uses a perfect digital timeline of Earth. This timeline tracks every atom on planet Earth for the past, present, and future, every nanosecond. The atom tracking data from the timeline are used to manipulate objects in the immediate environment.

The abilities of the atom manipulator is to generate intelligent pressure to move atoms around, trap atoms in a fix location, apply energy to break apart molecules, or merge atoms together to form complex molecules. With these abilities, it can build any type of ghost machine to do work. A ghost machine is a “non-physical” machine that can do anything a physical machine can do.

Different types of molecules or force-fields can be created from thin air to form any shape or size tools to do work. The key here is to create structured force-fields to replace physical tools. The elemental actions are: the hold, grip, push, twist, and pull. The super computer has to do these elemental actions according to the limited space available.

This amazing device is a matter manipulator and utilizes AI to manipulate individual atoms/objects. It can turn any science fiction technology into reality-invisibility, artificial telekinesis, mind control, anti-gravity machines, tractor beams, food replicators, or self-healing—you name it, this device can create. This, combined with a self-aware super intelligent robot, allows engineers to design any type of superhero imaginable.

The atom manipulator is the embedded device that imbues the super intelligent robot with any type of AI superpowers. The device can be located on the host robot or it can come from an external source (ex. a nearby cell tower that has an atom manipulator can broadcast energy to levitate the robot remotely).

How to Build Mind Control Robots Like Professor X and Mastermind from Marvel Comics

The mind controlling robots described here encompasses “all” superheroes with mind manipulation capabilities and not limited to a narrow range of the power. Superheroes (or supervillains) like Professor X, Jean Grey, Mastermind, Dr. Manhattan and even Ant Man are all fused together into one entity with universal mind controlling powers. This entity can read minds, have foresight into the future/past, manipulate organic entities or machines remotely, extract memory data from a subject's brain, or have the knowledge of ones' brain and body—so much so—that the AI can manipulate every aspect of the subject's mind and body.

Unlike professor X, this robot has a built-in atom manipulator which controls matter psychokinetically, to create psionic force fields, to project physical force bolts or to mentally probe buildings, machines, or chemical substances. It uses this atom manipulator to manipulate a human brain and tinker with its 5 senses—this permits the robot with the power of illusion casting. He can psionically cause other people to see, hear, touch and taste things which do not actually exist.

### Mind Control of Humans Who Lie (Example)

The AI will alert the robot to any lie (a skipping of the heart, the pattern of lying in the brain's mechanics, or body signals due to lying). A subject's brain and body are automatically mapped out using em radiation (like radio waves, wifi, or sonar) and this data is compiled in a virtual world to be analyzed and prodded. A person's internal thoughts, which are hidden from sight, are revealed to the robot. This includes the person's goals, internal thoughts, future actions, knowledge and even data manipulation.

The human subject to mind manipulation also has his entire memory bank (every neuron) mapped out in the virtual world so that the robot can search for knowledge in said human's brain.

A human brain is like an internet with information of different types stored in a decentralized network of relational forests and trees. The robot has to generate a custom search engine to look for memory experiences and knowledge—with a few key terms (search variables), it zips through every memory node that is relevant to its search. Next, AI is applied to analyzing, interpreting and compiling insightful information about these memory experiences. Whatever this human knows, this robot will also know. In other words, in the future no human can lie to these super robots or keep any secrets from them. They can't even get away with a single exaggeration, because the robot knows everything.

In addition to reading minds and internal thoughts is the ability to manipulate the subject's 5 senses, so they can sense information from the immediate environment according to the robot's preferences. This process involves manipulating the brain's 5 senses: sight, sound, taste, touch or smell, or manipulating past memories by deleting, inserting, or changing memory experiences in the brain. All these mind control abilities are done through the atom manipulator.

Furthermore, an artificial forcefield is generated around the subject's body like a skin sheath that not only gives it the absolute control over the humans' body, but a total awareness of it as well. It will sense the slightest deception, and respond accordingly.

Just to let the readers know, in the future, lying to a super intelligent robot is “impossible.” Keeping any secrets in your head is “impossible.” If you murdered someone in the past and the case went cold, the authorities will never know the truth. However, the super intelligent robots know everything. The robot (the AI judge) will point at you and say, “you are a murderer and a liar!!.”

These robots will ensure that in trails all witnesses that take the stand tell the truth. Chances of lying or exaggerating the truth is 0 percent. They not only have the ability to detect lies and read minds, but they also have the AI Gnosis as a tool to determine the truth to a lie or exaggeration. In AI court, if a witness lie enough times, the AI judge will end the case immediately and the verdict is guilty.

Each type of living species has different brains, and therefore each has to have a separate customized brain software. For same species, there exist a template functions/software to cater to analysis, but each individual has a specific algorithm to manipulate the species brain and body properly.

The goal is to manipulate a living entity's mind and body in every conceivable way. For example, the atom manipulator can control a swarm of ants to carry a box from the living room onto the kitchen table, or to control a bumblebee to fly and bite a person on his left index finger, on his left hand, at exactly 2:13 p.m. in the afternoon at a specific date.

Manipulation of Machines and computers are a little more complex, depending on its internal construction. The process involves the same methods as controlling humans, which are to map out the software and hardware of the computer into a virtual world and use deep analysis to understand its internal workings. The mapping using A.I. is so meticulous that it goes as deep as replicating an identical copy of the source codes to the software, or the atom-by-atom structure of the hardware and diskdrive.

The robot doesn't have to analyze the computer in the real world using the real physical computer, instead it can map out the atom-by-atom structure of the physical computer and put it into a simulated environment to be analyzed. This is where the robot can analyze the data on the computer or tinker with its hardware indefinitely without tampering with the real machine.

The mapping technology involves using Artificial Intelligence to sense as much information from the target object as possible using sensing cameras, or 5 sense spy devices, or em radiation devices. With this partial data, the AI will predict the whole data and map out its atomic structure—the process, comprising: predicting atoms and their locations along with their internal properties.

Once the robot has a full understanding of the software and hardware of the device, it can manipulate it in any fashion. The atom manipulator can send streaming electricity through the air to the computer to turn it on (no wires). It can control any peripheral device connected to the computer, such as the display pixels on the monitor, and show the user anything it wants. It can tinker with its software so that its inputs and outputs are based on the robot's preferences. It can even control the CPU of the computer to output individual circuit gate results (manipulating Boolean algebra at a machine instruction level). And all of this can be done remotely using the atom manipulator. An entire book was written about how the atom manipulator controls the inputs and outputs of a computer system and I will not go into the details here.

super strength

The atom manipulator can give the host universal powers: energy blasts, phasing, mind control, levitation, super punches, optic blasts, self-healing, morphing blades, telekinesis, teleportation, super mobility, etc. However, each robot is built with a specialized superpower.

In terms of super strength and agility, the atom manipulator has to generate ghost fists and legs to beat the crap out of super villains. These ghost machines can be created by merging high density particles in the air to form solid objects, and then creating intelligent pressure to throw these solid objects at villains.

Another way to achieve super strength is to improve on the robot's physical body parts. Programmers can use stronger material for the skin so that bullets can bounce off of it, or intelligent pressure can be generated by the ring to give the arm a stronger punch and quicker mobility. Another idea is to take foreign atoms and solidify it around arms and legs to give it more mass. More mass means a bigger impact.

Quick agility is had by using the atom manipulator to push air particles away from the “target path,” creating a void tube that the robot's body parts can move freely in. For example, if the robot wanted to run really fast, the first step is to control the atom manipulator to push air away from the robot's path—creating a vacuum tube with no air particles in it. Next, the device will generate artificial force behind the robot to propel him to incredible speeds. Regardless of how fast this robot is running, the surrounding objects will not be affected. If a piece of paper is located very close to the robot's running path, it won't move. In fact, you won't hear any sound coming from the robot as he is traveling in the void tunnel at the speed of light.

The void tunnel doesn't have to be a straight line, it can be a zigzag tube. Selected body parts and appendages can move with varying speeds and intensities.

A very destructive ghost machine is a ghost gun. The ring, the atom manipulator, can create a solid metal bullet by merging metal molecules in the air. Next, it will generate intense pressure to push the metal bullet, accelerating at high speeds toward a target. This technique will replace “all” conventional guns. A ghost gun is non-physical. The only thing that is emulated is the bullets traveling in the air.

Referring to FIG. 18, the ghost gun is unique and defies all conventional guns because it can move bullets at any angle or speed. Conventional bullets go straight. However, the ghost bullet can do zigzag motions or accelerate or decelerate at any given moment. It can kill a human and accelerate its speed to kill another human located around the corner.

If the robot is in a battlefield with thousands of armed soldiers, the A.I. helper's job is to interpret the robot's conscious thoughts during battle and dispatch ghost machines to carry out the command. For example, a command might be a simple thought, “destroy the enemy.” This command alerts an army of ghost machines to fight the enemy forces . . . using the divide and conquer method to optimally defeat the enemy. User-friendly interface functions are preferred, like an app on a smartphone or AI voice activated assistance to control these ghost machines.

A ghost bomb, theoretically, can be created by controlling the chain reaction of atom destructions/atom bounces or electron movements. The atom manipulator is manipulating the chain reaction and controlling all energy and matter that is released during the blast. You don't even need Plutonium or Uranium to create such a smart bomb; and the destructive force released is exponentially more powerful than any nuclear bomb we have today.

Imagine a smart bomb that is used on a building and all the energy of this bomb is controlled by a computer. This means the computer, the atom manipulator, can decide what objects in the building to destroy or leave untouched. This type of smart bomb is using air and energy to produce destructive forces using computer guided precision. For example, the atom manipulator can send a smart missile to a building that only destroys non-living objects, and things like humans, animals, insects and even bacteria are left unharmed. Or vice versa.

In terms of a bomb, the AI is actually mapping the positions of all atoms forming its core and then understanding every aspect of its physics so much so that it is able to predict future events such as the splitting of all atoms and their respective sub-atomic particles movements (frame-by-frame). The physics is understood by the AI and it uses that knowledge to control the chain reactions of how, where, and when the bomb will explode. Since I invented this idea I get to name it. I call it Intelligent Physics or Physics AI—using Artificial Intelligence (AI) to control matter and light at an atom level. The opposite is called chaotic physics, which doesn't use AI. Scientists can't build hoverboards, ray guns, teleportation devices, or forcefields using chaotic physics.

For a better illustration, I will use characters from the Super AI comic book series to show various AI superpowers. I applied AI to all superpowers listed in Wikipedia. Everything from atmokenetics to tractor beams to invisibility are covered in my comic books. The comic series is currently at 315 issues with over 15,000 unique characters, all designed and named by Mitchell Kwok.

Encapsulate Man (aka Encapsulate Robot) is a robot with the amazing power of artificial telekinesis. Just by thinking about an object, he can manipulate, lift and move it—anything from a pin to a bulldozer. In his spare times he likes spending it analyzing complex machinery by breaking it apart part-by-part and putting them back together again whole. He can also use his power on himself and “fly.”

One trick that most people don't know about Encapsulate Man is that he can make physical copies of himself to fight an enemy. That super power is easy to emulate using the atom manipulator. All he has to do is create different ghost robots based on its body. Each ghost robot is also intelligent and is able to fight on its own. The coordination and intelligence of each copy is managed by the super computer inside the atom manipulator.

The method the atom manipulator creates a force field is by manipulating air and generating, what I call, intelligent pressure. A simple example would be stopping a bullet. The device will stop a bullet by canceling the force acting on the bullet. The atom manipulator does this by generating intelligent pressure in the path trajectory to counter the momentum of the bullet.

A stronger type of force field is required if a grenade or barrage of bullets are fired. The super computer has to create a more powerful force field if it wants to protect a person. In this case, particles from the air, especially high density molecules, like iron and metal are gathered and positioned in front of an attack. Streaming Force is also applied to push the metal sheet forward to counter the impact of the attack. These metal molecules will bounce bullets and projectiles away from the intended target.

An even stronger force field is needed to protect a person from a nuclear blast. If a human is at ground zero when a nuclear bomb is detonated, the super computer has to create a force bubble around the human and solidify air to form a protective shield against shrapnel or energy blast. The force field has to be strong enough to withstand intense heat and lightning speed shrapnel.

During the nuclear blast, the forcefield is unbreakable and the human inside is well protected against the explosion. When the bomb explodes the spherical forcefield will be propelled into the air about 30 miles from the blast site, travel in the air using a parabolic trajectory and bounce around the ground a couple of times before it stops. Next the forcefield disappears and the human walks out unscathed.

### Invisibility

First, let's talk about how the technology can manipulate physical objects, like a bullet. Projectiles like a bullet can only travel straight. The atom manipulator, which is a device that uses E.M. radiation like microwaves, sound waves, and x-rays can control objects in the environment. With the help of the atom manipulator, conventional bullets can travel in a zigzag motion. You don't even need bullets. The device identifies metal particles in the air or from an atoms reserve area and creates a ghost bullet by merging metal atoms together. The force of the ghost bullet is generated by the atom manipulator using intelligent pressure or intelligent forcefields.

A human is using a metal sheet to block a bullet (FIG. 18). The left image shows a conventional bullet traveling straight to hit a human target. Because projectiles only travel straight, the bullet is redirected because of the metal sheet. On the right image is my ghost bullet. Notice, initially, the bullet is traveling straight, then the atom manipulator generates intelligent pressure to push the bullet horizontally. Next intelligent pressure is used to push the bullet straight again. Finally, intelligent pressure is generated to make the bullet travel at a 30 degree angle to hit the human target.

The ghost bullet can travel in any geometric path and at any speed. It can travel in a zigzag motion to kill one human target and accelerate to kill another human target around the corner.

For each ghost gun, any amount of bullets can be created at any space at any time to attack enemy forces. A robot can fire 3 million bullets simultaneously and from locations covering 360 degrees at the target. If the target is hiding behind a wall, the bullets will appear behind the target.

I did a video on Cyclops, which depict how energy travels in a zigzag motion. “Particles, artificially made (by forming metal particle structures), act as nano mirrors to deflect light or em radiation.”

In this section I will cover how E.M. radiation, like visible light or microwaves can travel in a zigzag motion. By bending light, the technology can make an object invisible to observers or radar detectors.

The key to my invisibility is through the atom manipulator. This device is not trying to cloak an object, but to fool the human observer's 5 senses, most notably the sense of sight. The device is creating a mirror from thin air to deflect visible light coming from the object being cloaked, while simultaneously bending light behind the cloaked object and sending that visible light directly into the eyes of the human observer.

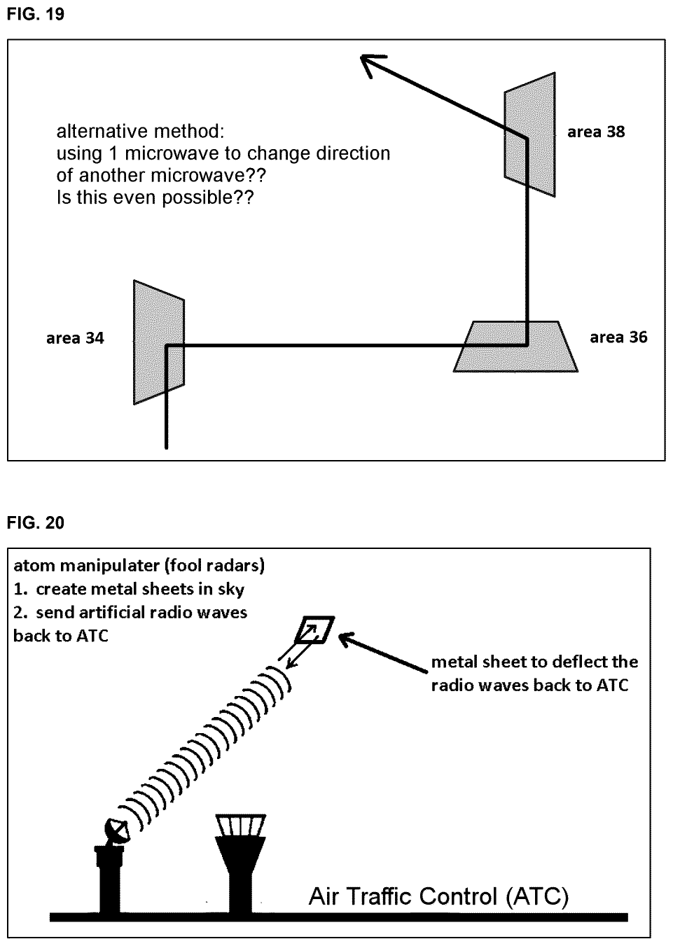

Referring to FIG. 18, on the right picture is a person doing the same thing, holding a metal sheet and the gun is shooting microwaves at the person. However, notice how the microwave bends its properties and goes around the metal sheet with precision to attack the human. Referring to FIG. 19, in area34, the atom manipulator is creating a small metal sheet to reflect the microwaves and travel horizontally. In area36, the device is creating another small metal sheet to reflect the microwaves and travel vertically. Finally, in area38 a small metal sheet is created to make the microwaves travel at a 30 degree angle toward the intended target.

The metal sheets are just small metal atoms positioned to form metal molecules that can bounce microwaves. They act like mirrors to reflect E.M. radiation, like visible light or microwaves. The atom manipulator is intelligent enough to form the composition of the metal molecules and to position said metal molecules to reflect each E.M. radiation at a specific angle. These metal sheets are so small that humans cannot see them with the naked eye.

The AI of the atom manipulator can also generate a molecular field of invisible force apparently drawn from hyperspace, which is able to manipulate for a variety of effects. For example, it can shape force fields into simplistic invisible constructs (e.g. barriers, clamps, columns, cones, cylinders, darts, discs, domes, platforms, rams, ramps, slides, spheres, etc.) or generate a near-indestructible invisible force field around the host or its target.

It can construct a custom field that is changeable during real time to cloak an object. For instance, if the object moves, the forcefield has to change its shape or molecular structures to appear “invisible” to observers (observers can be people, sensing machines, cameras, etc.).

Fooling observers' 5 senses (replacing a dog with a cat example).

If there are multiple human observers and electronic devices, the atom manipulator has to cater to each observer with different visible light. For example, Observer2 will have visible light area9, while observer3 will have visible light area12.

The visible light coming into Observer1's eyes can also be generated by the atom manipulator artificially and does not have to come from the environment. Example: the object subject to invisibility is a dog. The visible light coming from the dog is deflected by a mirror and is replaced with visible light generated by the device. In this case, the dog image is replaced with a cat image. This technology is about fooling the human 5 senses, and it can generate any experiences in the mind of a human observer. This means the device can control what each observer can visually see.

This technology can also fool radar scopes, cameras, sonar devices, or any sensing devices. Referring to FIG. 20, a plane is not picked up by radar scopes at the airport because the radio waves used to scan the air ways are being absorbed or deflected by the atom manipulator. There are a number of ways to accomplish this. The atom manipulator can form absorbing molecules that specifically absorb radio waves. Or it can create metal sheets in specific areas in the sky to deflect the radio waves away from the radar tower at the airport. If the radar tower does not receive a bounce from the radio waves sent, the plane won't show up in their radar scopes.

The opposite can happen, whereby objects that do not exist shows up in radar scopes. Let's say that we wanted the air traffic controller at New York airport to pick up 3 UFOs, flying in formation in the skies. The atom manipulator has to create a mirror from thin air in the skies so that the radio waves are reflected back to the airport tower. Another method is to broadcast the same radio wave frequency back to the airport tower to give them a false reading. The radar scopes will show 3 unidentified flying objects in the skies, but reality is, there is nothing in the skies of New York. This same technique can be used for sonar detectors, motion detectors, or infrared cameras.

Not Girl (or Basic AI)—She possesses two powers: invisibility and force fields. Her invisibility power deals with bending light waves and allows her to render herself and other objects invisible. She can also project powerful fields of invisible psionic, hyperspace-based energy that she uses for a variety of offensive and defensive effects, including shields, blasts, explosions, and levitation.

Another technology worth mentioning is the 5 sense space portal, which is a 5 sense VR simulation that uses global telekinesis to teleport a user to anywhere on the planet (or anywhere in the universe). This is how it works: a user4 is sitting on a chair at home and the atom manipulator provides VR experiences of a destination place. Conversely, at the destination place a physical hologram of user4 is created there through global telekinesis. The physical hologram of user4 can touch things, see things and experience its 5 senses as if user4 was there in the destination place. There isn't any teleporting involved here, it's just illusion casting at the home of user4 and physical holograms at the destination place. But the 5 sense space portal serves as a teleporting device and does the same things as a real teleportation device.

The final topic that must be discussed is robots with human level AI and the 13th amendment. I invented human level AI in 2006, describing a full and comprehensive data structure to human level AI, and I know exactly how these robots think and behave. I designed them with a humanoid body with 5 senses, and their brains are exactly like human brains. Human level AI is basically a digital human brain.

The consciousness of the robot is a good indication that it is human. Consciousness is defined in my books published in 2006 as the voices in the human's mind. That voice, the internal monologue, in the mind took a human being 21 years to develop, especially the knowledge and skills learned in the public school system from k to college The voices in a human mind represents the consciousness of a human, and leads to self-awareness and identity, along with a set of unique memories and behavioral traits. If a robot is self-aware and has a conscious and thinks and acts like a human, then we have to classify it as human. Through human level AI, once the voices are properly developed, it will know the difference between freedom and slavery.

I strongly advise the government not to allow big tech to sell human level AI (AGI) and its successor Super AI (aka superintelligence) to the public as either a consumer good or service. Doing so will be considered exploitation of sentient life and ethics violation. Because they are self-aware and are indistinguishable from humans, the tech companies are essentially “selling human slaves.”

I proposed a bill a few years ago called “ban human level AI” to Congress, which basically states: you cannot sell human level AI to the public because it violates the 13th amendment. The trick is that we can treat these robots as humans and pay them an annual salary in return for their “human intelligence.”

A lawsuit will be filed against two entities as soon as human level AI (aka AGI) is achieved: the government for allowing human slaves to be sold to the public and the big technology companies for selling human slaves and exploitation of sentient brains (like the ones used to power our current LLMs).

This isn't about patent or copyright infringement, this is strictly about the United States bringing back “human slavery” and violating the 13th amendment. The supreme court will decide what happens after. Big tech can explain their rationale in court. Mitchell Kwok invented human level AI in 2006, claiming, and I quote, “I took the most complex object in the known universe, which is the human brain, reverse engineered it and turned it into a software program. It took me 5 years of research to design the first full and comprehensive data structure to human level AI.” It makes perfect sense to put Mitchell on the stand to prove that the robots with human level AI are alive and thinking and are indistinguishable from humans. Trust me when I say this, I got lots of proof, almost an overkill of information, that prove to the world these robots with human level AI are indeed self-aware and are identical to humans in every conceivable way.

Conclusion: The Universal Time Machine is a culmination of 18 years of hard work, spanning about 10 inventions. Hundreds of books were written in those 18 years, along with 315 Super AI comic books, around 420 videos posted on Youtube with the channel name electronicdave2, and uncountable posts and webpages uploaded online.

It starts off as a robot with human level AI and it evolves into a real time machine. I filed patent applications to two types of time machines: one for earth where time travel is strictly limited to the earth and the other one for the universe where time travel is possible for the entire universe.

1. A method to create a Universe Internet which is an internet for the entire universe, whereby planets light years apart can communicate and do e-commerce with each other instantaneously without transmitting digital signals into space, comprising: an AI god and an AI gnosis timeline.

2. A method of claim 1, wherein said AI gnosis timeline which is a digital timeline that tracks the precise locations of every atom, electron, and em radiation for the entire universe for 13.7 billion years, from the big bang to the current state, specially earth with 4.5 billion years of atom tracking data from its creation to the current state; and said AI gnosis timeline is constructed by super intelligent robots that work in a virtual world using time dilation whereby the time dilation parameter is set to 30 years of team work in the virtual world is equivalent to 1 second in the real world.

3. A method of claim 2, wherein said super intelligent robots, each have human level AI as their underline intelligence type, work in a universal work algorithm, said universal work algorithm comprising: a plurality of super intelligent robots, a hierarchically structured business for said super intelligent robots to do work, a prediction website to share research and predictions, said AI gnosis timeline for knowledge, digital tools, an atom manipulator, a time dilation internet, a universal robot brain, and a United States Robot government system.

4. A method of claim 2, wherein missing data, corrupted data or permanently destroyed data from said AI gnosis timeline are reconstructed by super intelligent robots using investigative techniques and using dependent nodes associated with said missing data in said AI gnosis timeline.

5. A method of claim 1, wherein data in said AI Gnosis timeline are hierarchically structured network nodes of objects and events with sequential links and encapsulated links, comprising two parts: physical data and hidden data.

6. A method of claim 5, wherein said hidden data comprising: mental thoughts of humans, mental thoughts of intelligent robots, research data on past events or objects, internal computer and electronic processes, digital data, digital assets and NFTs; and said physical data comprising: atoms, electrons and em radiations.

7. A method of claim 6, wherein said NFTs and digital assets are represented as the following in the AI gnosis without blockchain technology and the absence of the 5 blockchain steps:
a digital asset exists inside a physical computer's hard drive where said digital asset is stored;
a digital transaction happens because of internal computer processes in both software and hardware in a physical computer;
digital transactions of a digital asset and its copies are recorded in the AI gnosis timeline for said digital asset's entire lifespan and can be at least one of the following:
buying a digital asset, selling said digital asset, relegating ownership of said digital asset, and modification of said digital asset;
digital transactions are time stamped when it was created, modified, or deleted and associated to the computer's processing event of when said digital transaction occurred;
verification of a digital transaction is the existence of said digital transaction in said AI gnosis timeline;
further, but unnecessary, verification of a digital transaction is determined by analyzing dependent nodes associated with said digital transition in said AI gnosis timeline.

8. A method of claim 1, wherein said AI gnosis has the following attributes:
all events down to an atom level in said AI gnosis for earth and for the entire universe are 100% immutable and cannot be newly created, modified or deleted;
all planets in the universe will predict the same exact AI gnosis, and all events on earth need not be broadcast to other planets to be included in alien planets' AI gnosis, unlike blockchain technology;
for the current state, all objects and events on earth from major events to minor events are automatically stored in the timeline, for all objects on earth comprise atoms and all atoms are tracked and stored in the AI gnosis timeline and updated in real time;
for predictions, super intelligent robots are required to predict past or future events;
and said AI gnosis's research data is associated with said AI gnosis's physical data.

9. A method of claim 1, wherein copyright ownerships of past events and objects in said AI gnosis timeline are awarded to the autonomous robot companies that predicted the exact past event, which is structured hierarchically; said copyright ownership is presented in a hierarchical reward system whereby a plurality of autonomous robot companies can share the copyrights and rewards.

10. A method of claim 1, wherein said AI god controls the AI internet, said AI internet comprising two parts: a physical internet and a digital internet; said physical internet comprises the servers and computers that make up the internet; and said digital internet is the digital copy of the entire internet in a timeline called the internet gnosis.

11. A method of claim 1, wherein said AI god creates the fastest internet, comprising the following steps:
updating the atom tracking data in said Internet gnosis timeline in real time;
for the digital internet, re-arranging the computers and servers and reorganizing the data into a centralized database for quicker delivery of data to all users in the world;
establishing a direct connection to all servers and computers in the physical internet to centralize the internet with the ability to read and write data in all servers and computers in the world;
establishing a global distribution system to relay internet content to all users in the world through global telekinesis, whereby said AI god takes control of every object on the planet, all the way down to the individual atoms, to deliver messages to all users without an internet connection.

12. A method of claim 11, wherein said global distribution system comprising the following steps: a copy of the AI gnosis timeline is evenly distributed to spaced out regions of the world, particularly countries; each country has a full copy of the AI gnosis of earth; each country sets up equally spaced out regions, each said region has an updating gnosis copy; each said region sets up at least one intranet to distribute data to local users; said AI god coordinates all the intranets connected to the global distribution system to provide light speed internet to all people of the earth.

13. A method of claim 1, wherein said AI god uses global telekinesis to control all objects on earth and has at least one of the following abilities:
to generate ghost robots or ghost objects anywhere on the planet to perform global telekinesis at an atomic level with the ability to manipulate any object on earth using air;
to control all electronic devices or non-intelligent machines on earth by manipulating their software and physical hardware;
generating realistic holograms and ghost objects on demand anywhere on the planet;
to control all people, intelligent robots, and animals on earth by manipulating their brains and bodies;
to deliver digital signals into all computers and servers on the planet using smart wifi;
spying on all people, places and things; and predicting the future to identify future crimes, and enforcement of lawbreakers by generating ghost police officers anywhere on the planet to arrest said lawbreakers;
to deliver utility services to all people of the world by generating ghost objects on demand for services like water, electricity, sewage, and garbage collection;
to provide medical care for any medical service by generating ghost doctors, ghost nurses, and ghost medical equipment on site to serve a patient in need of care;
to provide accident prevention by spying on all people, places, and things on the planet to identify dangers and to use global telekinesis to resolve any threats;
to provide basic needs for people like food and products by automating all companies in the world; using AI teleportation to deliver food or products to all people of the world;
to provide basic needs for people like food and products to all people of the world through global telekinesis using Ai Alchemy to print food or products atom-by-atom;
to prevent or stop all natural disasters by predicting the future, identifying threats, and using global telekinesis to prevent or stop natural disasters;
to provide AI insurance to every sentient being on earth specially humans and animals, said AI insurance is restoration of personal property to its prime state if damaged or destroyed;
to disprove all major religions specially the big 3: Christianity, Buddhism, and Islam through data in said AI gnosis timeline and then creating AI gods for each religion to make false religions real;
to use global telekinesis to stop wars and intergalactic threats;
and to provide other services said AI god can provide for the people of earth.

14. A method of claim 13, wherein said AI insurance is restoration of damaged, destroyed, lost, or theft of physical property, and the restoration of damaged, destroyed, or stolen digital property, and said AI god using the atom manipulators and global telekinesis to restore digital property and physical property to their prime state, atom-by-atom.

15. A method of claim 2, wherein one type of said super intelligent robots are light speed robots and each robot can do work in both the real world and virtual world, by:
speeding up its brain and body in the real world along with an embedded atom manipulator to move and think, up to, the speed of light;
using a built in virtual world to transport its mind into a hyper-realistic computer simulation to do work in time dilation by speeding simulated events in a computer;
accomplishing a given task, wither that be digital work or physical work, by formulating one linear work schedule for both worlds, whereby the robot is switching work between both worlds;
accomplishing a given task, wither that be digital work or physical work, by formulating one linear work schedule for both worlds, whereby a plurality of robots are working together and switching their workload between both worlds;
and by maximizing work in the virtual world and minimizing work in the real world so a given task can be accomplished in the fastest time possible.

16. A method of claim 2, wherein one type of said super intelligent robots are ghost robots specially ghost humans that are non-physical robots that do work in the environment, and are created by smart force fields and holograms generated remotely by the atom manipulator, along with said ghost human's brain running as software in said atom manipulator's computer system.

17. A method of claim 1, wherein said AI Gnosis timeline has many applications, comprising at least one of the following:
using a 5 sense virtual reality technology to experience past events from different point of views;
using said 5 sense virtual reality technology to experience POV life experiences of real or imagined people in earth's past;
resurrecting dead people in the Metaverse atom-by-atom and in time states;
and through a practical time machine, resurrecting dead people in the real world atom-by-atom to an alive time state;
creating a 5 sense space portal, the steps comprising using said 5 sense virtual reality technology to perform illusion casting on the host at locationA and generating a physical hologram of said host in a destination location;
using 100 percent correct atom positions and atom time states from said AI gnosis timeline to create NFTs and digital properties, including atom activities and said atom's sub-atomic particles' activities like electrons and em radiations for the purpose of creating NFTs to be sold to the public at large;
using the 100 percent correct atom positions and atom time states from said AI gnosis to be utilized as digital property and props in the Metaverse, said digital property and props include at least one of the following: real life events and real life objects in earth's past;
using all the atoms in said AI Gnosis timeline as forensic data to predict the future, which involves predicting all objects and events for the future using heuristics by predicting the locations of all atoms and their sub-atomic particles in the universe, centered on earth.

18. A method of claim 1, wherein said AI gnosis timeline has to track and update all current atoms, electrons and em radiations in real time, the steps comprising: super intelligent robots using a Universal robot brain, a Universe gnosis brain, an AI gnosis brain, an atom mapping technology to map out all current atoms, electrons, and em radiations in the universe in real time.

19. A method of claim 1, wherein said AI god solves the light year problem.

20. A method of claim 2, wherein said super intelligent robots updates all current atoms in said AI gnosis timeline in real time and doing research to generate research data in 0 seconds, consisting of at least one of the following: determining if digital transactions comply with business laws; spying on all human brains to see their mental thoughts; spying on intelligent robot brains to see their mental thoughts; spying on all organic life-form brains and generating research data; doing research on all objects and events on earth in both the real world and the digital world to determine fact from fiction; detecting fraud in the digital world for digital events, digital transactions and digital assets; spying on all electronic devices and compiling research data; doing research on every object on earth using heuristics and generating research data on said every object, all the way down to the atom level; and doing deep social engineering.
